(19) United States
(12) Patent Application Publication
(10) Pub. No.: US 2025/0236774 A1
(43) Pub. Date: Jul. 24, 2025

(54) HEAT TRANSFER SYSTEMS, COMPOSITIONS AND METHODS

(71) Applicant: HONEYWELL INTERNATIONAL INC., Charlotte, NC (US)

(72) Inventors: Martin Bluhm, Charlotte, NC (US); Christophe Roger, Charlotte, NC (US); Ankit Sethi, Charlotte, NC (US); Ryan Hulse, Charlotte, NC (US)

(73) Assignee: HONEYWELL INTERNATIONAL INC., Charlotte, NC (US)

(21) Appl. No.: 18/801,757

(22) Filed: Aug. 13, 2024

Related U.S. Application Data
(60) Provisional application No. 63/533,540, filed on Aug. 18, 2023.

(51) Int. Cl. C09K 5/04

(52) U.S. Cl. CPC C09K 5/041

(57) ABSTRACT

The present invention relates to heat transfer systems and methods involving zinc-containing surfaces in contact with a working fluid comprising refrigerant, lubricant and a protective agent comprising a compound according to Formula I:

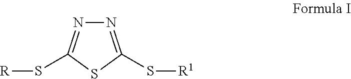

where R and R¹ are each independently selected from the group consisting of hydrogen, alkyl, hydroxyalkyl and alkylthio, provided that at least one of R and R¹ is alkylthio.

### CROSS REFERENCE TO RELATED APPLICATION

This application is related to and claims the priority benefit of U.S. Provisional Application No. 63/533,540, filed Aug. 18, 2023, which is incorporated by reference herein in its entirety.

### FIELD OF THE INVENTION

The present invention relates to heat transfer compositions, heat transfer methods and heat transfer systems, including but not limited to air conditioning and refrigeration applications.

### BACKGROUND

Mechanical refrigeration systems, and related heat transfer devices and methods, such as heat pumps and air conditioners, are well known in the art for industrial, commercial and domestic uses. Typically, such systems utilize a heat transfer cycle that utilizes a compressor that operates on a working fluid that includes a refrigerant. In a typically cooling operation of such systems, a relatively high pressure, high temperature refrigerant exits a compressor, is directed to a condenser where the refrigerant vapor is condensed to a refrigerant liquid, which in turn is converted to a relatively low temperature, low pressure refrigerant liquid by passing through an expansion device. This relatively low temperature, low pressure refrigerant is then directed to an evaporator where it is exposed to a fluid or body to be cooled. In the evaporator, the relatively low temperature, low pressure refrigerant changes phase from liquid to vapor by absorbing heat from (i.e., cooling) the body or fluid to be cooled. The low pressure refrigerant vapor that exits from the evaporator is directed to the suction side of the compressor so that the heat transfer cycle can be repeated.

An important requirement for the vast majority of such systems, devices, and methods as described above is that the working fluid include, in addition to the refrigerant, a lubricant for the compressor. At least a portion of this lubricant circulates with the refrigerant as it traverses the heat transfer cycle. As a result, all of the components mentioned above, as well as other equipment that will typically be present (including piping, valving, etc., as well as numerous other items of equipment that may be present for a particular application) are thus exposed to the circulating working fluid at various temperatures and pressures. Applicants have come to appreciate, however, that the exposure of certain materials of construction to such circulating fluids can have a detrimental impact on the longevity and/or robustness of the system and/or of the working fluid. In particular, applicants have come to appreciate that the presence of zinc-containing components that are exposed to working fluids in such heat transfer systems can cause detrimental impact on the longevity and/or robustness of the system and/or of the working fluid.

Accordingly, one object of the present invention is to provide heat transfer compositions, heat transfer methods and heat transfer systems that: (i) provide protection against corrosion of zinc-containing components or parts present in heat transfer systems which are exposed to refrigerant and/or lubricant during operation; and/or (2) provide protection against deterioration of refrigerants and/or lubricants that are exposed to such zinc-containing components or parts during operation.

### SUMMARY

The present invention provides improved heat transfer systems of the type having at least a circulating working fluid and one or more system components which are exposed to said working fluid during operation, the improvement comprising:
(a) said one or more system components having a metal surface comprising zinc;
(b) said working fluid comprising refrigerant and at least one protective agent comprising a compound according to Formula I:

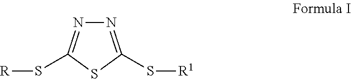

where R and R¹ are each independently selected from the group consisting of hydrogen, alkyl, hydroxyalkyl and alkylthio, provided that at least one of R and R¹ is alkylthio.
   Systems according to this paragraph are sometimes referred to herein for convenience as Heat Transfer System 1.

The present invention provides improved heat transfer systems of the type having at least a circulating working fluid and one or more system components which are exposed to said working fluid during operation, the improvement comprising:
(a) said one or more system components comprising a metal surface comprising zinc;
(b) said working fluid comprising refrigerant and at least one protective agent for said zinc and/or said refrigerant, wherein said protective agent comprises a compound according to Formula I:

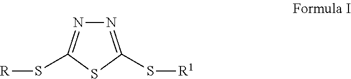

where at least one of R and R1 is a C1-C20 alkylthio.
   Systems according to this paragraph are sometimes referred to herein for convenience as Heat Transfer System 2A.

The present invention provides improved heat transfer systems of the type having at least a circulating working fluid and one or more system components which are exposed to said working fluid during operation, the improvement comprising:
(a) said one or more system components comprising a metal surface comprising zinc;
(b) said working fluid comprising refrigerant and at least one protective agent for said zinc and/or said refrigerant, wherein said protective agent comprises a compound according to Formula I:

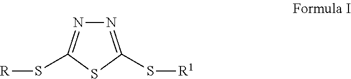

where each of R and R1 is a C8 alkylthio.
   Systems according to this paragraph are sometimes referred to herein for convenience as Heat Transfer System 2B.

The present invention also provides methods of providing heat transfer comprising:
(a) providing a heat transfer system comprising one or more components having at least one surface formed from a metal comprising zinc;
(b) providing a working fluid in said system, wherein: (i) said working fluid is in contact with said at least one surface; and (ii) said working fluid comprises refrigerant and a protective agent comprising a compound according to Formula I:

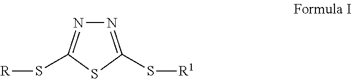

where R and R¹ are each independently selected from the group consisting of hydrogen, alkyl, hydroxyalkyl and alkylthio, provided that at least one of R and R¹ is alkylthio.
   Methods according to this paragraph are sometimes referred to herein for convenience as Heat Transfer Method 1.

The present invention also provides methods of providing heat transfer comprising:
(a) providing a heat transfer system comprising one or more components having at least one surface formed from a metal which contains zinc;
(b) providing a working fluid in said system, wherein: (i) said working fluid is in contact with said at least one surface; and (ii) said working fluid comprises refrigerant and a protective agent comprising a compound according to Formula I:

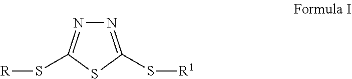

where at least one of R and R1 is a C1-C20 alkylthio.
   Methods according to this paragraph are sometimes referred to herein for convenience as Heat Transfer Method 2A.

The present invention also provides methods of providing heat transfer comprising:
(a) providing a heat transfer system comprising one or more components having at least one surface formed from a metal which contains zinc;
(b) providing a working fluid in said system, wherein: (i) said working fluid is in contact with said at least one surface; and (ii) said working fluid comprises refrigerant and a protective agent comprising a compound according to Formula I:

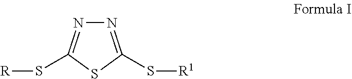

where each of R and R1 is a C8 alkylthio.
   Methods according to this paragraph are sometimes referred to herein for convenience as Heat Transfer Method 2B.

The present invention also provides methods of providing heat transfer comprising:
(a) providing a heat transfer system comprising one or more components having at least one surface formed from a metal which contains zinc;
(b) providing a working fluid in said system, wherein: (i) said working fluid is in contact with said at least one surface; and (ii) said working fluid comprises refrigerant and a protective agent comprising a compound according to Formula Il:

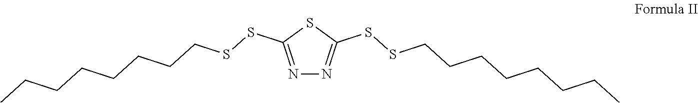 [SMILES: CCCCCCCCSSc1nnc(SSCCCCCCCC)s1]

Methods according to this paragraph are sometimes referred to herein for convenience as Heat Transfer Method 2C.

The present invention also provides heat transfer compositions comprising:
(a) at least one refrigerant selected from HFCs, HCFCs, HFOs, HCFOs, fluoroiodocarbons and combinations of two or more of these;
(b) at least one lubricant selected from POEs and PVEs; and
(c) a protective agent comprising a compound according to Formula I:

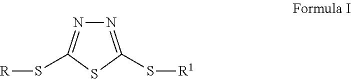

where R and R¹ are each independently selected from the group consisting of hydrogen, alkyl, hydroxyalkyl and alkylthio, provided that at least one of R and R¹ is alkylthio.
   Methods according to this paragraph are sometimes referred to herein for convenience as Heat Transfer Composition 1A.

The present invention also provides heat transfer compositions comprising:
(a) at least one refrigerant selected from the group consisting of HFO-1234ze(E), HFO-1234ze(Z), CF31, HFO-1234yf, HFO-1336mzz(E), HFO-1336mzz(Z), HFC-227ea, HFO-1224yd, HFO-1132(E), HCFO-1233zd(E), HFC-152a; HFC-32, and combinations of any two or more of these;
(b) at least one lubricant selected from POEs and PVEs; and
(c) a protective agent comprising a compound according to Formula I:

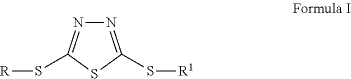

where R and R¹ are each independently selected from the group consisting of hydrogen, alkyl, hydroxyalkyl and alkylthio, provided that at least one of R and R¹ is alkylthio.
   Methods according to this paragraph are sometimes referred to herein for convenience as Heat Transfer Composition 1B.

The present invention also provides heat transfer compositions comprising:
(a) at least one refrigerant selected from HFCs, HCFCs, HFOs, HCFOs, fluoroiodocarbons and combinations of two or more of these;
(b) at least one lubricant selected from POEs and PVEs; and
(c) a protective agent comprising a compound according to Formula I:

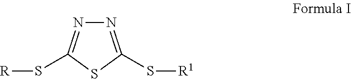

where at least one of R and R1 is a C1-C20 alkylthio.
   Compositions according to this paragraph are sometimes referred to herein for convenience as Heat Transfer Composition 2A.

The present invention also provides heat transfer compositions comprising:
(a) at least one refrigerant selected from HFCs, HCFCs, HFOs, HCFOs, fluoroiodocarbons and combinations of two or more of these;
(b) at least one lubricant selected from POEs and PVEs; and
(c) a protective agent comprising a compound according to Formula I:

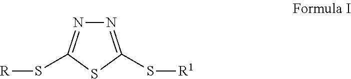

where at least one of R and R1 is a C1-C20 alkylthio; and
(d) a stabilizer comprising one or more of alkylated naphthalene, acid depleting moiety, a phosphate, and preferably combinations of two or more of these.
   Compositions according to this paragraph are sometimes referred to herein for convenience as Heat Transfer Composition 2B.

The present invention also provides heat transfer compositions comprising:
(a) at least one refrigerant selected from HFCs, HCFCs, HFOs, HCFOs, fluoroiodocarbons and combinations of two or more of these;
(b) at least one lubricant selected from POEs and PVEs; and
(c) a protective agent comprising a compound according to Formula I:

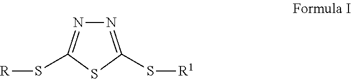

where at least one of R and R1 is a C8 alkylthio;
   Compositions according to this paragraph are sometimes referred to herein for convenience as Heat Transfer Composition 2C.

The present invention also provides heat transfer compositions comprising:
(a) at least one refrigerant selected from HFCs, HCFCs, HFOs, HCFOs, fluoroiodocarbons and combinations of two or more of these;
(b) at least one lubricant selected from POEs and PVEs; and
(c) a protective agent comprising a compound according to Formula I:

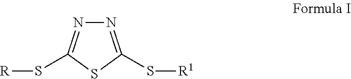

where each of R and R1 is a C5-C10 alkylthio.
   Compositions according to this paragraph are sometimes referred to herein for convenience as Heat Transfer Composition 2D.

The present invention also provides heat transfer compositions comprising:
(a) at least one refrigerant selected from HFCs, HCFCs, HFOs, HCFOs, fluoroiodocarbons and combinations of two or more of these;
(b) at least one lubricant selected from POEs and PVEs; and
(c) a protective agent comprising a compound according to Formula I:

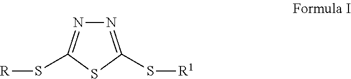

where each of R and R1 is a C8 alkylthio.
   Compositions according to this paragraph are sometimes referred to herein for convenience as Heat Transfer Composition 2E.

The present invention also provides heat transfer compositions comprising:
(a) at least one refrigerant selected from HFCs, HCFCs, HFOs, HCFOs, fluoroiodocarbons and combinations of two or more of these;
(b) at least one lubricant selected from POEs and PVEs; and
(c) a protective agent comprising a compound according to Formula Il:

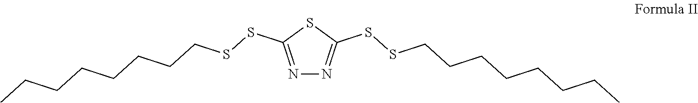 [SMILES: CCCCCCCCSSc1nnc(SSCCCCCCCC)s1]

Compositions according to this paragraph are sometimes referred to herein for convenience as Heat Transfer Composition 2F.

### DETAILED DESCRIPTION

### Definitions

As used herein with respect to percentages based on a list of identified compounds, the term “relative percentage” means the percentage of the identified compound based on the total weight of the listed compounds.

As used herein with respect to weight percentages, the term “about” with respect to an amount of an identified component means the amount of the identified component can vary by an amount of +/−2% by weight. Unless otherwise indicated or understood from the context, reference to an amount by “percent” or “%” references to percentage by weight.

For the purposes of this invention, the term “about” in relation to temperatures in degrees centigrade (° C.) means that the stated temperature can vary by an amount of +/−5° C.

In preferred embodiments, temperature specified as being about is preferably +/−2° C., more preferably +/−1° C., and even more preferably +/−0.5° C. of the identified temperature.

The term “capacity” is the amount of cooling provided, in BTUs/hr., by the refrigerant in the refrigeration system. This is experimentally determined by multiplying the change in enthalpy in BTU/lb., of the refrigerant as it passes through the evaporator by the mass flow rate of the refrigerant. The enthalpy can be determined from the measurement of the pressure and temperature of the refrigerant. The capacity of the refrigeration system relates to the ability to maintain an area to be cooled at a specific temperature. The capacity of a refrigerant represents the amount of cooling or heating that it provides and provides some measure of the capability of a compressor to pump quantities of heat for a given volumetric flow rate of refrigerant. In other words, given a specific compressor, a refrigerant with a higher capacity will deliver more cooling or heating power.

The phrase “coefficient of performance” (hereinafter “COP”) is a universally accepted measure of refrigerant performance, especially useful in representing the relative thermodynamic efficiency of a refrigerant in a specific heating or cooling cycle involving evaporation or condensation of the refrigerant. In refrigeration engineering, this term expresses the ratio of useful refrigeration or cooling capacity to the energy applied by the compressor in compressing the vapor and therefore expresses the capability of a given compressor to pump quantities of heat for a given volumetric flow rate of a heat transfer fluid, such as a refrigerant. In other words, given a specific compressor, a refrigerant with a higher COP will deliver more cooling or heating power. One means for estimating COP of a refrigerant at specific operating conditions is from the thermodynamic properties of the refrigerant using standard refrigeration cycle analysis techniques (see for example, R. C. Downing, FLUOROCARBON REFRIGERANTS HANDBOOK, Chapter 3, Prentice-Hall, 1988 which is incorporated herein by reference in its entirety).

The phrase “discharge temperature” refers to the temperature of the refrigerant at the outlet of the compressor. The advantage of a low discharge temperature is that it permits the use of existing equipment without activation of the thermal protection aspects of the system which are preferably designed to protect compressor components and avoids the use of costly controls such as liquid injection to reduce discharge temperature.

The phrase “Global Warming Potential” (hereinafter “GWP”) was developed to allow comparisons of the global warming impact of different gases. Specifically, it is a measure of how much energy the emission of one ton of a gas will absorb over a given period of time, relative to the emission of one ton of carbon dioxide. The larger the GWP, the more that a given gas warms the Earth compared to C02 over that time period. The time period usually used for GWP is 100 years. GWP provides a common measure, which allows analysts to add up emission estimates of different gases. See www.epa.qov.

The phrase “Life Cycle Climate Performance” (hereinafter “LCCP”) is a method by which air conditioning and refrigeration systems can be evaluated for their global warming impact over the course of their lifetime. LCCP includes the direct impacts of refrigerant emissions and the indirect impacts of energy consumption used to operate the system, energy to manufacture the system, and transport and safely dispose of the system. The direct impacts of refrigerant emissions are obtained from the refrigerant's GWP value. For the indirect emissions, the measured refrigerant properties are used to obtain the system performance and energy consumption. LCCP is determined by using Equations 1 and 2 as follows. Equation 1 is Direct Emissions=Refrigerant Charge (kg)×(Annual Loss Rate×Lifetime+End-of-Life Loss)×GWP. Equation 2 is Indirect Emissions=Annual Power Consumption×Lifetime×C02 per kW-hr of electrical production. The Direct Emissions as determined by Equation 1 and the Indirect Emissions as determined by Equation 2 are added together to provide the LCCP. TMY2 and TMY3 data produced by the National Renewable Laboratory and available in BinMaker® Pro Version 4 Software is used for the analysis. The GWP values reported in the Intergovernmental Panel on Climate Change (IPCC)'s Assessment Report 4 (AR4) 2007 are used for the calculations. LCCP is expressed as carbon dioxide mass (kg-CO2eq) over the lifetime of the air conditioning or refrigeration systems.

The term “mass flow rate” is the mass of refrigerant passing through a conduit per unit of time.

The term “Occupational Exposure Limit (OEL)” is determined in accordance with ASHRAE Standard 34-2016 Designation and Safety Classification of Refrigerants.

As the term is used herein, “replacement for” with respect to a particular heat transfer composition or refrigerant of the present invention as a “replacement for” a particular prior refrigerant means the use of the indicated composition of the present invention in a heat transfer system that heretofore had been commonly used with that prior refrigerant. By way of example, when a refrigerant or heat transfer composition of the present invention is used in a heat transfer system that has heretofore been designed for and/or commonly used with R410A, such as residential air conditioning and commercial air conditioning (including roof top systems, variable refrigerant flow (VRF) systems and chiller systems) then the present refrigerant is a replacement for R410A is such systems.

The phrase “thermodynamic glide” applies to zeotropic refrigerant mixtures that have varying temperatures during phase change processes in the evaporator or condenser at constant pressure.

The phrase “thermodynamic glide” applies to zeotropic refrigerant mixtures that have varying temperatures during phase change processes in the evaporator or condenser at constant pressure.

As the term is used herein, “TAN value” refers to the total acid number as determined in accordance with ASHRAE Standard 97—“Sealed Glass Tube Method to Test the Chemical Stability of Materials for Use within Refrigerant Systems” to simulate long-term stability of the heat transfer compositions by accelerated aging.
1234ze means 1,1,1,3-tetrafluoropropene, without limitation as to isomeric form.
Trans1234ze, 1234ze(E), and R-1234ze(E) each means trans1,3,3,3-tetrafluoropropene.
Cis1234ze and 1234ze(Z) each means cis1,3,3,3-tetrafluoropropene.
1234yf means 2,3,3,3-tetrafluoropropene.
1233zd means 1-chloro-3,3,3-trifluoropropene, without limitation as to isomeric form.
Trans1233zd and 1233zd(E) each means trans1-chloro-3,3,3-trifluoropropene.
1224yd means cis1-chloro-2,3,3,3-tetrafluoropropane, without limitation as to isomeric form.
The terms “1132(E),” “R-1132(E)” and “HFO-1132(E)” each mean trans-1,2-difluoroethene.
The terms “R-32” and “HFC-32” as used herein each mean difluoromethane.
The term “R-125” and “HFC-125” means pentafluoroethane.
The term “R-134a” and “HFC-134a” each means 1,1,1,2-tetrafluoroethane.
The terms “R-143a” and “HFC-143a” each means 1,1,1-trifluoroethane.
The terms “R-227ea” and “HFC-227ea” each mean 1,1,1,2,3,3,3-heptafluoropropane.

As used herein, the term “R448A” means the refrigerant designated by ASHRAE as 448A and which consists of about 26% of R-32, about 26% of R-125, about 20% HFO-1234yf, about 21% of R-134a, about 7% of HFO-1234ze(E) and about 20% HFO-1234yf.

As used herein, the term “R448B” means the refrigerant designated by ASHRAE as 448B and which consists of about 21% of R-32, about 21% of R-125, about 20% HFO-1234yf, about 31% of R-134a and about 7% of HFO-1234ze(E).

As used herein, the term “R449A” means the refrigerant designated by ASHRAE as 449A and which consists of about 24.3% of R-32, about 24.7% of R-125, about 25.7% of HFO-1234yf and about 25.7% of R-134a.

As used herein, the term “R449B” means the refrigerant designated by ASHRAE as 449B and which consists of about 25.2% of R-32, about 24.3% of R-125, about 23.2% of HFO-1234yf and about 27.3% of R-134a.

As used herein, the term “R449C” means the refrigerant designated by ASHRAE as 449C and which consists of about 20% of R-32, about 20% of R-125, about 31% of HFO-1234yf and about 29% of R-134a.

As used herein, the term “R450A” means the refrigerant designated by ASHRAE as 450A and which consists of 42% of R-134a and 58% of R-1234yf.

As used herein, the term “R452A” means the refrigerant designated by ASHRAE as 452A and which consists of about 11% of R-32, about 59% of R-125 and about 30% of R-1234yf.

As used herein, the term “R452B” means the refrigerant designated by ASHRAE as 452B and which consists of about 67% of R-32, about 7% of R-125 and about 26% of R-1234yf.

As used herein, the term “R454A” means the refrigerant designated by ASHRAE as 454A and which consists of 35% of R-32 and 65% of HFC-1234yf.

As used herein, the term “R454B” means the refrigerant designated by ASHRAE as 454B and which consists of 68.9% of R-32 and 31.1% of HFC-1234yf.

As used herein, the term “R454C” means the refrigerant designated by ASHRAE as 454C and which consists of 21.5%+2/−2% of R-32 and 78.5-+2/−2% of HFC-1234yf.

As used herein, the term “R455A” means the refrigerant designated by ASHRAE as 455A and which consists of 21.5%+2/−1% of R-32, 75.5 of HFC-1234yf+2/−2% and 3%+2/−1% of CO2.

As used herein, the term “R456A” means the refrigerant designated by ASHRAE as 456A and which consists of about 6% of R-32, about 45% of R-134a and about 49% of R-1234ze(E).

As used herein, the term “R457A” means the refrigerant designated by ASHRAE as 457A and which consists of about 18% of R-32, about 12% of R-152a and about 70% of R-1234yf.

As used herein, the term “R457B” means the refrigerant designated by ASHRAE as 457B and which consists of about 35% of R-32, about 10% of R-152a and about 55% of R-1234yf.

As used herein, the term “R457C” means the refrigerant designated by ASHRAE as 457C and which consists of about 7.5% of R-32, about 14.5% of R-152a and about 78% of R-1234yf.

As used herein, the term “R466A” means the refrigerant designated by ASHRAE as 466A and which consists of about 49% of R-32, about 11.5% of R-125 and about 39.5% of CF31.

As used herein, the term “HDR139” means the refrigerant which consists of about 38% of R-32 and 62% of CF31.

As used herein, the term “HDR147” means the refrigerant which consists of about 41% of R-32, about 3.5% of R-125 and about 55.5% of CF31.

As used herein, the term “HDR171” means the refrigerant which consists of about 20% of R-32, about 40% of 1234yf and about 40% of 1132(E).

As used herein, the term “HDR173” means the refrigerant which consists of about 21.5% of R-32, about 40.5% of 1234yf and about 38% of 1132(E).

As used herein, the term “R471A” means the refrigerant designated by ASHRAE as 471A and which consists of 78.7%+0.4/−1.5% of HFC-1234ze(E), 17%+1.5/−0.4% of HFC-1336mzz(E) and 4.3%+1.5/−0.4% of HFC-227ea.

As used herein, the term “R474A” means the refrigerant designated by ASHRAE as 474A and which consists of about 23% of R-1132(E) and about 77% of R-1234yf.

As used herein, the term “R474B” means the refrigerant designated by ASHRAE as 474B and which consists of about 31.5% of R-1132(E) and about 68.5% of R-1234yf.

As used herein, the term “R476A” means the refrigerant designated by ASHRAE as 476A and which consists of 78.7%+/−0.5/−2% of HFC-1234ze(E), 12%+2/−0.5% of HFC-1336mzz(E) and 10%+2/−0.51% of HFC-134a.

As used herein, the term “R479A” means the refrigerant designated by ASHRAE as 479A and which consists of about 28% of R-1132(E), about 50.5% of R-1234yf and about 21.5% of HFC-32.

As used herein, the term “R482A” means the refrigerant designated by ASHRAE as 482A and which consists of about 10% of HFC-134a, about 83.5% of HFC-1234ze(E), and about 6.5% of HFO-1224yd(Z).

As used herein, the term “R-513A” means the refrigerant designated by ASHRAE as 513A and which consists of about 56% of HFC-1234yf and about 44% of HFC-134a.

As used herein, the term “R-513B” means the refrigerant designated by ASHRAE as 513B and which consists of about 58.5% of HFC-1234yf and about 41.5% of HFC-134a.

As used herein, the term “R-514A” means the refrigerant designated by ASHRAE as 514A and which consists of about 74.7% of HFO-1336mzz(Z) and about 25.3% of HFO-1130(E).

As used herein, the term “R-515A” means the refrigerant designated by ASHRAE as 515A and which consists of about 88% of HFC-1234ze(E) and about 12% of HFC-134a.

As used herein, the term “R-5151B” means the refrigerant designated by ASHRAE as 515B and which consists of about 91.1% of HFO-1234ze(E) and about 8.9% of HFC-134a.

As used herein, the term “R-516A” means the refrigerant designated by ASHRAE as 516A and which consists of about 77.5% of HFC-1234yf, about 8.5% of HFC-134a, and about 14% HFC-152a.

As used herein, the term “Protective Agent 1” means a compound according to Formula I:

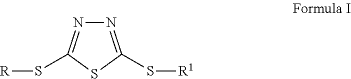

where at least one of R and R1 is a C1-C20 alkylthio.

As used herein, the term “Protective Agent 2” means a compound according to Formula I:

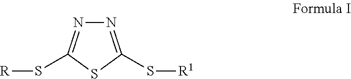

where each R and R1 is independently a C1-C20 alkylthio.

As used herein, the term “Protective Agent 3” means a compound according to Formula I:

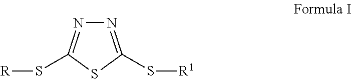

where each R and R1 is independently a C5-C20 alkylthio.

As used herein, the term “Protective Agent 4” means a compound according to Formula I:

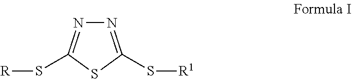

where each R and R1 is independently a C5-C10 alkylthio.

As used herein, the term “Protective Agent 5A” means a compound according to Formula II:

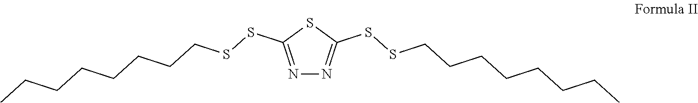 [SMILES: CCCCCCCCSSc1nnc(SSCCCCCCCC)s1]

As used herein, the term “Protective Agent 5B” means a composition comprising dioctyl disulfide and the compound according to Formula Il:

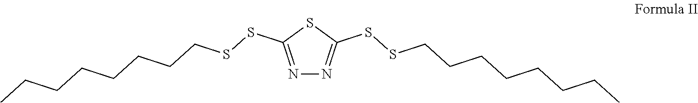 [SMILES: CCCCCCCCSSc1nnc(SSCCCCCCCC)s1]

As used herein, reference to a defined group, such as “Heat Transfer Compositions 1-2,” refers to each composition within that group, including wherein a definition number includes a suffix. Thus, reference to Heat Transfer Compositions 1-2 includes reference to each of Heat Transfer Composition 1A, Heat Transfer Composition 1B, Heat Transfer Composition 2A, Heat Transfer Composition 2B, Heat Transfer Composition 2C and Heat Transfer Composition 2D.

### BRIEF DESCRIPTION OF THE DRAWINGS

FIG. 1CA is a black and white photograph of the results of Comparative Example C1A.

FIG. 1CB is a black and white photograph of the results of Comparative Example C1B.

FIG. 1CC is a black and white photograph of the results of Comparative Example C1C.

FIG. 2A is a black and white photograph of the results of Example 1A.

FIG. 2B is a black and white photograph of the results of Example 1B.

FIG. 2C is a chart showing the results of Example 1.

FIG. 3A is a black and white photograph of the results of Example Ex2A.

FIG. 3B1 is a black and white photograph of the results of Example 2B1.

FIG. 3B2 is a black and white photograph of the results of Example 2B2.

FIG. 3C is a chart showing the results of Example 2.

FIG. 4A1 is a black and white photograph of the results of Example 3A.

FIG. 4A2 is a black and white photograph of the results of Example 3A21.

FIG. 4B1 is a black and white photograph of the results of Example 3B1.

FIG. 4B2 is a black and white photograph of the results of Example 3B2.

FIG. 4C is a chart showing the results of Example 3.

FIG. 5CA is a black and white photograph of the results of Comparative Example C2A.

FIG. 5CB is a black and white photograph of the results of Comparative Example C2B.

FIG. 5CC is a black and white photograph of the results of Comparative Example C2C.

FIG. 6A is a black and white photograph of the results of Example 4A.

FIG. 6B is a black and white photograph of the results of Example 4B.

FIG. 6C is a black and white photograph of the results of Example 4C.

FIG. 6D is a black and white photograph of the results of Example 4D.

FIG. 6E is a black and white photograph of the results of Example 4E.

FIG. 6F is a chart showing the results of Example 4.

### HEAT TRANSFER COMPOSITIONS

Applicants have found that the heat transfer compositions of the present invention, including each of Heat Transfer Compositions 1-2 as described herein, are capable of providing exceptionally advantageous properties and in particular providing stability in use.

A particular advantage of the heat transfer compositions of the present invention is that they provide excellent chemical stability in use, particularly in use in heat transfer systems that include zinc-containing components that are exposed to the heat transfer composition in use. This desirable advantage can be achieved by heat transfer compositions of the present invention.

Particular heat transfer compositions of the present invention include those identified in the following Table 1, wherein the first column of the table includes “HTC” as an abbreviation for a defined Heat Transfer Composition. In Table 1 below: “NR” means that the component or an particular amount is “not required” according to the specified HTC definition and as such its presence in any amount or in no amount is permitted; “Yes” means the component is required but that any type or amount is permitted; “Comp” means that the specified composition comprises the items identified in the table; “CEO” means that the specified composition consists essentially of the items identified in the table; and “CO” means that composition consists of the items identified in the table.

TABLE 1

| | | | | | Protective | | | |
|---|---|---|---|---|---|---|---|---|
| HTC | | | | Protective | Agent | Other | | |
| No. | | Refrigerant | Lubricant | Agent No. | Amount, wt % | Components | | |
| 3A | Comp | 1234ze(E) | YES | 1 | NR | NR | NR | NR |
| 3B | CEO | 1234ze(E) | YES | 1 | NR | NR | NR | NR |
| 3C | CO | 1234ze(E) | YES | 1 | NR | NR | NR | NR |
| 3D | Comp | 1234ze(E) | YES | 1 | 0.01-0.1 | NR | NR | NR |
| 3E | CEO | 1234ze(E) | YES | 1 | 0.01-0.1 | NR | NR | NR |
| 3F | Comp | 1234ze(E) | YES | 1 | 0.01-0.05 | NR | NR | NR |
| 3G | CEO | 1234ze(E) | YES | 1 | 0.01-0.05 | NR | NR | NR |
| 3H | CO | 1234ze(E) | YES | 1 | 0.01-0.05 | NR | NR | NR |
| 3I | Comp | 1234ze(E) | POE | 1 | 0.01-0.05 | NR | NR | NR |
| 3J | CEO | 1234ze(E) | POE | 1 | 0.01-0.05 | NR | NR | NR |
| 3K | CO | 1234ze(E) | POE | 1 | 0.01-0.05 | NR | NR | NR |
| 3L | Comp | 1234ze(E) | PVE | 1 | 0.01-0.05 | NR | NR | NR |
| 3M | CEO | 1234ze(E) | PVE | 1 | 0.01-0.05 | NR | NR | NR |
| 3N | CO | 1234ze(E) | PVE | 1 | 0.01-0.05 | NR | NR | NR |
| 3O | Comp | 1234ze(E) | POE | 5A | 0.01-0.1 | NR | NR | NR |
| 3P | CEO | 1234ze(E) | POE | 5A | 0.01-0.1 | NR | NR | NR |
| 3Q | CO | 1234ze(E) | POE | 5A | 0.01-0.1 | NR | NR | NR |
| 3R | Comp | 1234ze(E) | POE | 5A | 0.01-0.05 | NR | NR | NR |
| 3S | CEO | 1234ze(E) | POE | 5A | 0.01-0.05 | NR | NR | NR |
| 3T | CO | 1234ze(E) | POE | 5A | 0.01-0.05 | NR | NR | NR |
| 3U | Comp | 1234ze(E) | PVE | 5A | 0.01-0.1 | NR | NR | NR |
| 3V | CEO | 1234ze(E) | PVE | 5A | 0.01-0.1 | NR | NR | NR |
| 3W | CC | 1234ze(E) | PVE | 5A | 0.01-0.1 | NR | NR | NR |
| 3X | Comp | 1234ze(E) | PVE | 5A | 0.01-0.05 | NR | NR | NR |
| 3Y | CEO | 1234ze(E) | PVE | 5A | 0.01-0.05 | NR | NR | NR |
| 3Z | CO | 1234ze(E) | PVE | 5A | 0.01-0.05 | NR | NR | NR |
| 4A | Comp | 1234yf | YES | 1 | NR | NR | NR | NR |
| 4B | CEO | 1234yf | YES | 1 | NR | NR | NR | NR |
| 4C | CO | 1234yf | YES | 1 | NR | NR | NR | NR |
| 4D | Comp | 1234yf | YES | 1 | 0.01-0.1 | NR | NR | NR |
| 4E | CEO | 1234yf | YES | 1 | 0.01-0.1 | NR | NR | NR |
| 4F | Comp | 1234yf | YES | 1 | 0.01-0.05 | NR | NR | NR |
| 4G | CEO | 1234yf | YES | 1 | 0.01-0.05 | NR | NR | NR |
| 4H | CO | 1234yf | YES | 1 | 0.01-0.05 | NR | NR | NR |
| 4I | Comp | 1234yf | POE | 1 | 0.01-0.05 | NR | NR | NR |
| 4J | CEO | 1234yf | POE | 1 | 0.01-0.05 | NR | NR | NR |
| 4K | CO | 1234yf | POE | 1 | 0.01-0.05 | NR | NR | NR |
| 4L | Comp | 1234yf | PVE | 1 | 0.01-0.05 | NR | NR | NR |
| 4M | CEO | 1234yf | PVE | 1 | 0.01-0.05 | NR | NR | NR |
| 4N | CO | 1234yf | PVE | 1 | 0.01-0.05 | NR | NR | NR |
| 4O | Comp | 1234yf | POE | 5A | 0.01-0.1 | NR | NR | NR |
| 4P | CEO | 1234yf | POE | 5A | 0.01-0.1 | NR | NR | NR |
| 4Q | CO | 1234yf | POE | 5A | 0.01-0.1 | NR | NR | NR |
| 4R | Comp | 1234yf | PVE | 5A | 0.01-0.1 | NR | NR | NR |
| 4S | CEO | 1234yf | PVE | 5A | 0.01-0.1 | NR | NR | NR |
| 4T | CO | 1234yf | PVE | 5A | 0.01-0.1 | NR | NR | NR |
| 5A | Comp | 1233zd(E) | YES | 1 | NR | NR | NR | NR |
| 5B | CEO | 1233zd(E) | YES | 1 | NR | NR | NR | NR |
| 5C | CO | 1233zd(E) | YES | 1 | NR | NR | NR | NR |
| 5D | Comp | 1233zd(E) | YES | 1 | 0.01-0.1 | NR | NR | NR |
| 5E | CEO | 1233zd(E) | YES | 1 | 0.01-0.1 | NR | NR | NR |
| 5F | Comp | 1233zd(E) | YES | 1 | 0.01-0.05 | NR | NR | NR |
| 5G | CEO | 1233zd(E) | YES | 1 | 0.01-0.05 | NR | NR | NR |
| 5H | CO | 1233zd(E) | YES | 1 | 0.01-0.05 | NR | NR | NR |
| 5I | Comp | 1233zd(E) | POE | 1 | 0.01-0.05 | NR | NR | NR |
| 5J | CEO | 1233zd(E) | POE | 1 | 0.01-0.05 | NR | NR | NR |
| 5K | CO | 1233zd(E) | POE | 1 | 0.01-0.05 | NR | NR | NR |
| 5L | Comp | 1233zd(E) | PVE | 1 | 0.01-0.05 | NR | NR | NR |
| 5M | CEO | 1233zd(E) | PVE | 1 | 0.01-0.05 | NR | NR | NR |
| 5N | CO | 1233zd(E) | PVE | 1 | 0.01-0.05 | NR | NR | NR |
| 5O | Comp | 1233zd(E) | POE | 5A | 0.01-0.1 | NR | NR | NR |
| 5P | CEO | 1233zd(E) | POE | 5A | 0.01-0.1 | NR | NR | NR |
| 5Q | CO | 1233zd(E) | POE | 5A | 0.01-0.1 | NR | NR | NR |
| 5R | Comp | 1233zd(E) | PVE | 5A | 0.01-0.1 | NR | NR | NR |
| 5S | CEO | 1233zd(E) | PVE | 5A | 0.01-0.1 | NR | NR | NR |
| 5T | CO | 1233zd(E) | PVE | 5A | 0.01-0.1 | NR | NR | NR |
| 6A | Comp | 1224yd(Z) | YES | 1 | NR | NR | NR | NR |
| 6B | CEO | 1224yd(Z) | YES | 1 | NR | NR | NR | NR |
| 6C | CO | 1224yd(Z) | YES | 1 | NR | NR | NR | NR |
| 6D | Comp | 1224yd(Z) | YES | 1 | 0.01-0.1 | NR | NR | NR |
| 6E | CEO | 1224yd(Z) | YES | 1 | 0.01-0.1 | NR | NR | NR |
| 6F | Comp | 1224yd(Z) | YES | 1 | 0.01-0.05 | NR | NR | NR |
| 6G | CEO | 1224yd(Z) | YES | 1 | 0.01-0.05 | NR | NR | NR |
| 6H | CO | 1224yd(Z) | YES | 1 | 0.01-0.05 | NR | NR | NR |
| 6I | Comp | 1224yd(Z) | POE | 1 | 0.01-0.05 | NR | NR | NR |
| 6J | CEO | 1224yd(Z) | POE | 1 | 0.01-0.05 | NR | NR | NR |
| 6K | CO | 1224yd(Z) | POE | 1 | 0.01-0.05 | NR | NR | NR |
| 6L | Comp | 1224yd(Z) | PVE | 1 | 0.01-0.05 | NR | NR | NR |
| 6M | CEO | 1224yd(Z) | PVE | 1 | 0.01-0.05 | NR | NR | NR |
| 6N | CO | 1224yd(Z) | PVE | 1 | 0.01-0.05 | NR | NR | NR |
| 6O | Comp | 1224yd(Z) | POE | 5A | 0.01-0.1 | NR | NR | NR |
| 6P | CEO | 1224yd(Z) | POE | 5A | 0.01-0.1 | NR | NR | NR |
| 6Q | CO | 1224yd(Z) | POE | 5A | 0.01-0.1 | NR | NR | NR |
| 6R | Comp | 1224yd(Z) | PVE | 5A | 0.01-0.1 | NR | NR | NR |
| 6S | CEO | 1224yd(Z) | PVE | 5A | 0.01-0.1 | NR | NR | NR |
| 6T | CC | 1224yd(Z) | PVE | 5A | 0.01-0.1 | NR | NR | NR |
| 7A | Comp | 1336mzz(E) | YES | 1 | NR | NR | NR | NR |
| 7B | CEO | 1336mzz(E) | YES | 1 | NR | NR | NR | NR |
| 7C | CC | 1336mzz(E) | YES | 1 | NR | NR | NR | NR |
| 7D | Comp | 1336mzz(E) | YES | 1 | 0.01-0.1 | NR | NR | NR |
| 7E | CEO | 1336mzz(E) | YES | 1 | 0.01-0.1 | NR | NR | NR |
| 7F | Comp | 1336mzz(E) | YES | 1 | 0.01-0.05 | NR | NR | NR |
| 7G | CEO | 1336mzz(E) | YES | 1 | 0.01-0.05 | NR | NR | NR |
| 7H | CO | 1336mzz(E) | YES | 1 | 0.01-0.05 | NR | NR | NR |
| 7I | Comp | 1336mzz(E) | POE | 1 | 0.01-0.05 | NR | NR | NR |
| 7J | CEO | 1336mzz(E) | POE | 1 | 0.01-0.05 | NR | NR | NR |
| 7K | CO | 1336mzz(E) | POE | 1 | 0.01-0.05 | NR | NR | NR |
| 7L | Comp | 1336mzz(E) | PVE | 1 | 0.01-0.05 | NR | NR | NR |
| 7M | CEO | 1336mzz(E) | PVE | 1 | 0.01-0.05 | NR | NR | NR |
| 7N | CO | 1336mzz(E) | PVE | 1 | 0.01-0.05 | NR | NR | NR |
| 7O | Comp | 1336mzz(E) | POE | 5A | 0.01-0.1 | NR | NR | NR |
| 7P | CEO | 1336mzz(E) | POE | 5A | 0.01-0.1 | NR | NR | NR |
| 7Q | CO | 1336mzz(E) | POE | 5A | 0.01-0.1 | NR | NR | NR |
| 7R | Comp | 1336mzz(E) | PVE | 5A | 0.01-0.1 | NR | NR | NR |
| 7S | CEO | 1336mzz(E) | PVE | 5A | 0.01-0.1 | NR | NR | NR |
| 7T | CO | 1336mzz(E) | PVE | 5A | 0.01-0.1 | NR | NR | NR |
| 8A | Comp | 1132(E) | YES | 1 | NR | NR | NR | NR |
| 8B | CEO | 1132(E) | YES | 1 | NR | NR | NR | NR |
| 8C | CO | 1132(E) | YES | 1 | NR | NR | NR | NR |
| 8D | Comp | 1132(E) | YES | 1 | 0.01-0.1 | NR | NR | NR |
| 8E | CEO | 1132(E) | YES | 1 | 0.01-0.1 | NR | NR | NR |
| 8F | Comp | 1132(E) | YES | 1 | 0.01-0.05 | NR | NR | NR |
| 8G | CEO | 1132(E) | YES | 1 | 0.01-0.05 | NR | NR | NR |
| 8H | CO | 1132(E) | YES | 1 | 0.01-0.05 | NR | NR | NR |
| 8I | Comp | 1132(E) | POE | 1 | 0.01-0.05 | NR | NR | NR |
| 8J | CEO | 1132(E) | POE | 1 | 0.01-0.05 | NR | NR | NR |
| 8K | CO | 1132(E) | POE | 1 | 0.01-0.05 | NR | NR | NR |
| 8L | Comp | 1132(E) | PVE | 1 | 0.01-0.05 | NR | NR | NR |
| 8M | CEO | 1132(E) | PVE | 1 | 0.01-0.05 | NR | NR | NR |
| 8N | CO | 1132(E) | PVE | 1 | 0.01-0.05 | NR | NR | NR |
| 8O | Comp | 1132(E) | POE | 5A | 0.01-0.1 | NR | NR | NR |
| 8P | CEO | 1132(E) | POE | 5A | 0.01-0.1 | NR | NR | NR |
| 8Q | CO | 1132(E) | POE | 5A | 0.01-0.1 | NR | NR | NR |
| 8R | Comp | 1132(E) | PVE | 5A | 0.01-0.1 | NR | NR | NR |
| 8S | CEO | 1132(E) | PVE | 5A | 0.01-0.1 | NR | NR | NR |
| 8T | CO | 1132(E) | PVE | 5A | 0.01-0.1 | NR | NR | NR |
| 9A | Comp | R-125 | YES | 1 | NR | NR | NR | NR |
| 9B | CEO | R-125 | YES | 1 | NR | NR | NR | NR |
| 9C | CO | R-125 | YES | 1 | NR | NR | NR | NR |
| 9D | Comp | R-125 | YES | 1 | 0.01-0.1 | NR | NR | NR |
| 9E | CEO | R-125 | YES | 1 | 0.01-0.1 | NR | NR | NR |
| 9F | Comp | R-125 | YES | 1 | 0.01-0.05 | NR | NR | NR |
| 9G | CEO | R-125 | YES | 1 | 0.01-0.05 | NR | NR | NR |
| 9H | CO | R-125 | YES | 1 | 0.01-0.05 | NR | NR | NR |
| 9I | Comp | R-125 | POE | 1 | 0.01-0.05 | NR | NR | NR |
| 9J | CEO | R-125 | POE | 1 | 0.01-0.05 | NR | NR | NR |
| 9K | CO | R-125 | POE | 1 | 0.01-0.05 | NR | NR | NR |
| 9L | Comp | R-125 | PVE | 1 | 0.01-0.05 | NR | NR | NR |
| 9M | CEO | R-125 | PVE | 1 | 0.01-0.05 | NR | NR | NR |
| 9N | CO | R-125 | PVE | 1 | 0.01-0.05 | NR | NR | NR |
| 9O | Comp | R-125 | POE | 5A | 0.01-0.1 | NR | NR | NR |
| 9P | CEO | R-125 | POE | 5A | 0.01-0.1 | NR | NR | NR |
| 9Q | CC | R-125 | POE | 5A | 0.01-0.1 | NR | NR | NR |
| 9R | Comp | R-125 | PVE | 5A | 0.01-0.1 | NR | NR | NR |
| 9S | CEO | R-125 | PVE | 5A | 0.01-0.1 | NR | NR | NR |
| 9T | CO | R-125 | PVE | 5A | 0.01-0.1 | NR | NR | NR |
| 10A | Comp | R-125 | YES | 1 | NR | NR | NR | NR |
| 10B | CEO | R-125 | YES | 1 | NR | NR | NR | NR |
| 10C | CO | R-125 | YES | 1 | NR | NR | NR | NR |
| 10D | Comp | R-125 | YES | 1 | 0.01-0.1 | NR | NR | NR |
| 10E | CEO | R-125 | YES | 1 | 0.01-0.1 | NR | NR | NR |
| 10F | Comp | R-125 | YES | 1 | 0.01-0.05 | NR | NR | NR |
| 10G | CEO | R-125 | YES | 1 | 0.01-0.05 | NR | NR | NR |
| 10H | CC | R-125 | YES | 1 | 0.01-0.05 | NR | NR | NR |
| 10I | Comp | R-125 | POE | 1 | 0.01-0.05 | NR | NR | NR |
| 10J | CEO | R-125 | POE | 1 | 0.01-0.05 | NR | NR | NR |
| 10K | CO | R-125 | POE | 1 | 0.01-0.05 | NR | NR | NR |
| 10L | Comp | R-125 | PVE | 1 | 0.01-0.05 | NR | NR | NR |
| 10M | CEO | R-125 | PVE | 1 | 0.01-0.05 | NR | NR | NR |
| 10N | CO | R-125 | PVE | 1 | 0.01-0.05 | NR | NR | NR |
| 10O | Comp | R-125 | POE | 5A | 0.01-0.1 | NR | NR | NR |
| 10P | CEO | R-125 | POE | 5A | 0.01-0.1 | NR | NR | NR |
| 10Q | CO | R-125 | POE | 5A | 0.01-0.1 | NR | NR | NR |
| 10R | Comp | R-125 | PVE | 5A | 0.01-0.1 | NR | NR | NR |
| 10S | CEO | R-125 | PVE | 5A | 0.01-0.1 | NR | NR | NR |
| 10T | CO | R-125 | PVE | 5A | 0.01-0.1 | NR | NR | NR |
| 11A | Comp | R-134a | YES | 1 | NR | NR | NR | NR |
| 11B | CEO | R-134a | YES | 1 | NR | NR | NR | NR |
| 11C | CO | R-134a | YES | 1 | NR | NR | NR | NR |
| 11D | Comp | R-134a | YES | 1 | 0.01-0.1 | NR | NR | NR |
| 11E | CEO | R-134a | YES | 1 | 0.01-0.1 | NR | NR | NR |
| 11F | Comp | R-134a | YES | 1 | 0.01-0.05 | NR | NR | NR |
| 11G | CEO | R-134a | YES | 1 | 0.01-0.05 | NR | NR | NR |
| 11H | CO | R-134a | YES | 1 | 0.01-0.05 | NR | NR | NR |
| 11I | Comp | R-134a | POE | 1 | 0.01-0.05 | NR | NR | NR |
| 11J | CEO | R-134a | POE | 1 | 0.01-0.05 | NR | NR | NR |
| 11K | CO | R-134a | POE | 1 | 0.01-0.05 | NR | NR | NR |
| 11L | Comp | R-134a | PVE | 1 | 0.01-0.05 | NR | NR | NR |
| 11M | CEO | R-134a | PVE | 1 | 0.01-0.05 | NR | NR | NR |
| 11N | CO | R-134a | PVE | 1 | 0.01-0.05 | NR | NR | NR |
| 12A | CEO | R-143a | YES | 1 | NR | NR | NR | NR |
| 12B | CO | R-143a | YES | 1 | NR | NR | NR | NR |
| 12C | Comp | R-143a | YES | 1 | 0.01-0.1 | NR | NR | NR |
| 12D | CEO | R-143a | YES | 1 | 0.01-0.1 | NR | NR | NR |
| 12E | Comp | R-143a | YES | 1 | 0.01-0.05 | NR | NR | NR |
| 12F | CEO | R-143a | YES | 1 | 0.01-0.05 | NR | NR | NR |
| 12G | CO | R-143a | YES | 1 | 0.01-0.05 | NR | NR | NR |
| 12H | Comp | R-143a | POE | 1 | 0.01-0.05 | NR | NR | NR |
| 12I | CEO | R-143a | POE | 1 | 0.01-0.05 | NR | NR | NR |
| 12J | CO | R-143a | POE | 1 | 0.01-0.05 | NR | NR | NR |
| 12K | Comp | R-143a | PVE | 1 | 0.01-0.05 | NR | NR | NR |
| 12L | CEO | R-143a | PVE | 1 | 0.01-0.05 | NR | NR | NR |
| 12M | CO | R-143a | PVE | 1 | 0.01-0.05 | NR | NR | NR |
| 13A | Comp | R-227ea | YES | 1 | NR | NR | NR | NR |
| 13B | CEO | R-227ea | YES | 1 | NR | NR | NR | NR |
| 13C | CO | R-227ea | YES | 1 | NR | NR | NR | NR |
| 13D | Comp | R-227ea | YES | 1 | 0.01-0.1 | NR | NR | NR |
| 13E | CEO | R-227ea | YES | 1 | 0.01-0.1 | NR | NR | NR |
| 13F | Comp | R-227ea | YES | 1 | 0.01-0.05 | NR | NR | NR |
| 13G | CEO | R-227ea | YES | 1 | 0.01-0.05 | NR | NR | NR |
| 13H | CO | R-227ea | YES | 1 | 0.01-0.05 | NR | NR | NR |
| 13I | Comp | R-227ea | POE | 1 | 0.01-0.05 | NR | NR | NR |
| 13J | CEO | R-227ea | POE | 1 | 0.01-0.05 | NR | NR | NR |
| 13K | CO | R-227ea | POE | 1 | 0.01-0.05 | NR | NR | NR |
| 13L | Comp | R-227ea | PVE | 1 | 0.01-0.05 | NR | NR | NR |
| 13M | CEO | R-227ea | PVE | 1 | 0.01-0.05 | NR | NR | NR |
| 13N | CO | R-227ea | PVE | 1 | 0.01-0.05 | NR | NR | NR |
| 13O | Comp | R-227ea | POE | 5A | 0.01-0.1 | NR | NR | NR |
| 13P | CEO | R-227ea | POE | 5A | 0.01-0.1 | NR | NR | NR |
| 13Q | CO | R-227ea | POE | 5A | 0.01-0.1 | NR | NR | NR |
| 13R | Comp | R-227ea | PVE | 5A | 0.01-0.1 | NR | NR | NR |
| 13S | CEO | R-227ea | PVE | 5A | 0.01-0.1 | NR | NR | NR |
| 13T | CO | R-227ea | PVE | 5A | 0.01-0.1 | NR | NR | NR |
| 14A | Comp | CF3I | YES | 1 | NR | NR | NR | NR |
| 14B | CEO | CF3I | YES | 1 | NR | NR | NR | NR |
| 14C | CO | CF3I | YES | 1 | NR | NR | NR | NR |
| 14D | Comp | CF3I | YES | 1 | 0.01-0.1 | NR | NR | NR |
| 14E | CEO | CF3I | YES | 1 | 0.01-0.1 | NR | NR | NR |
| 14F | Comp | CF3I | YES | 1 | 0.01-0.05 | NR | NR | NR |
| 14G | CEO | CF3I | YES | 1 | 0.01-0.05 | NR | NR | NR |
| 14H | CO | CF3I | YES | 1 | 0.01-0.05 | NR | NR | NR |
| 14I | Comp | CF3I | POE | 1 | 0.01-0.05 | NR | NR | NR |
| 14J | CEO | CF3I | POE | 1 | 0.01-0.05 | NR | NR | NR |
| 14K | CO | CF3I | POE | 1 | 0.01-0.05 | NR | NR | NR |
| 14L | Comp | CF3I | PVE | 1 | 0.01-0.05 | NR | NR | NR |
| 14M | CEO | CF3I | PVE | 1 | 0.01-0.05 | NR | NR | NR |
| 14N | CO | CF3I | PVE | 1 | 0.01-0.05 | NR | NR | NR |
| 14O | Comp | CF3I | POE | 1 | 0.01-0.1 | AN4 | ADM4 | NR |
| 14P | CEO | CF3I | POE | 1 | 0.01-0.1 | AN4 | ADM4 | NR |
| 14Q | CO | CF3I | POE | 1 | 0.01-0.1 | AN4 | ADM4 | NR |
| 14R | Comp | CF3I | PVE | 1 | 0.01-0.1 | AN4 | ADM4 | NR |
| 14S | CEO | CF3I | PVE | 1 | 0.01-0.1 | AN4 | ADM4 | NR |
| 14T | CO | CF3I | PVE | 1 | 0.01-0.1 | AN4 | ADM4 | NR |
| 14U | Comp | CF3I | POE | 5A | 0.01-0.1 | AN4 | ADM4 | NR |
| 14V | CEO | CF3I | POE | 5A | 0.01-0.1 | AN4 | ADM4 | NR |
| 14W | CO | CF3I | POE | 5A | 0.01-0.1 | AN4 | ADM4 | NR |
| 14X | Comp | CF3I | PVE | 5A | 0.01-0.05 | AN4 | ADM4 | NR |
| 14Y | CEO | CF3I | PVE | 5A | 0.01-0.05 | AN4 | ADM4 | NR |
| 14Z | CO | CF3I | PVE | 5A | 0.01-0.05 | AN4 | ADM4 | NR |
| 15A | Comp | R448A | YES | 1 | NR | NR | NR | NR |
| 15B | CEO | R448A | YES | 1 | NR | NR | NR | NR |
| 15C | CO | R448A | YES | 1 | NR | NR | NR | NR |
| 15D | Comp | R448A | YES | 1 | 0.01-0.1 | NR | NR | NR |
| 15E | CEO | R448A | YES | 1 | 0.01-0.1 | NR | NR | NR |
| 15F | Comp | R448A | YES | 1 | 0.01-0.05 | NR | NR | NR |
| 15G | CEO | R448A | YES | 1 | 0.01-0.05 | NR | NR | NR |
| 15H | CO | R448A | YES | 1 | 0.01-0.05 | NR | NR | NR |
| 15I | Comp | R448A | POE | 1 | 0.01-0.05 | NR | NR | NR |
| 15J | CEO | R448A | POE | 1 | 0.01-0.05 | NR | NR | NR |
| 15K | CO | R448A | POE | 1 | 0.01-0.05 | NR | NR | NR |
| 15L | Comp | R448A | PVE | 1 | 0.01-0.05 | NR | NR | NR |
| 15M | CEO | R448A | PVE | 1 | 0.01-0.05 | NR | NR | NR |
| 15N | CO | R448A | PVE | 1 | 0.01-0.05 | NR | NR | NR |
| 15O | Comp | R448A | POE | 5A | 0.01-0.1 | NR | NR | NR |
| 15P | CEO | R448A | POE | 5A | 0.01-0.1 | NR | NR | NR |
| 15Q | CO | R448A | POE | 5A | 0.01-0.1 | NR | NR | NR |
| 15R | Comp | R448A | PVE | 5A | 0.01-0.1 | NR | NR | NR |
| 15S | CEO | R448A | PVE | 5A | 0.01-0.1 | NR | NR | NR |
| 15T | CO | R448A | PVE | 5A | 0.01-0.1 | NR | NR | NR |
| 15U | Comp | R448A | POE | 5A | 0.01-0.05 | NR | NR | NR |
| 15V | CEO | R448A | POE | 5A | 0.01-0.05 | NR | NR | NR |
| 15W | CO | R448A | POE | 5A | 0.01-0.05 | NR | NR | NR |
| 15X | Comp | R448A | PVE | 5A | 0.01-0.05 | NR | NR | NR |
| 15Y | CEO | R448A | PVE | 5A | 0.01-0.05 | NR | NR | NR |
| 15Z | CO | R448A | PVE | 5A | 0.01-0.05 | NR | NR | NR |
| 16A | Comp | R448B | YES | 1 | NR | NR | NR | NR |
| 16B | CEO | R448B | YES | 1 | NR | NR | NR | NR |
| 16C | CO | R448B | YES | 1 | NR | NR | NR | NR |
| 16D | Comp | R448B | YES | 1 | 0.01-0.1 | NR | NR | NR |
| 16E | CEO | R448B | YES | 1 | 0.01-0.1 | NR | NR | NR |
| 16F | Comp | R448B | YES | 1 | 0.01-0.05 | NR | NR | NR |
| 16G | CEO | R448B | YES | 1 | 0.01-0.05 | NR | NR | NR |
| 16H | CO | R448B | YES | 1 | 0.01-0.05 | NR | NR | NR |
| 16I | Comp | R448B | POE | 1 | 0.01-0.05 | NR | NR | NR |
| 16J | CEO | R448B | POE | 1 | 0.01-0.05 | NR | NR | NR |
| 16K | CO | R448B | POE | 1 | 0.01-0.05 | NR | NR | NR |
| 16L | Comp | R448B | PVE | 1 | 0.01-0.05 | NR | NR | NR |
| 16M | CEO | R448B | PVE | 1 | 0.01-0.05 | NR | NR | NR |
| 16N | CO | R448B | PVE | 1 | 0.01-0.05 | NR | NR | NR |
| 16O | Comp | R448B | POE | 5A | 0.01-0.1 | NR | NR | NR |
| 16P | CEO | R448B | POE | 5A | 0.01-0.1 | NR | NR | NR |
| 16Q | CO | R448B | POE | 5A | 0.01-0.1 | NR | NR | NR |
| 16R | Comp | R448B | PVE | 5A | 0.01-0.1 | NR | NR | NR |
| 16S | CEO | R448B | PVE | 5A | 0.01-0.1 | NR | NR | NR |
| 16T | CO | R448B | PVE | 5A | 0.01-0.1 | NR | NR | NR |
| 16U | Comp | R448B | POE | 5A | 0.01-0.05 | NR | NR | NR |
| 16V | CEO | R448B | POE | 5A | 0.01-0.05 | NR | NR | NR |
| 16W | CO | R448B | POE | 5A | 0.01-0.05 | NR | NR | NR |
| 16X | Comp | R448B | PVE | 5A | 0.01-0.05 | NR | NR | NR |
| 16Y | CEO | R448B | PVE | 5A | 0.01-0.05 | NR | NR | NR |
| 16Z | CO | R448B | PVE | 5A | 0.01-0.05 | NR | NR | NR |
| 17A | Comp | R449A | YES | 1 | NR | NR | NR | NR |
| 17B | CEO | R449A | YES | 1 | NR | NR | NR | NR |
| 17C | CO | R449A | YES | 1 | NR | NR | NR | NR |
| 17D | Comp | R449A | YES | 1 | 0.01-0.1 | NR | NR | NR |
| 17E | CEO | R449A | YES | 1 | 0.01-0.1 | NR | NR | NR |
| 17F | Comp | R449A | YES | 1 | 0.01-0.05 | NR | NR | NR |
| 17G | CEO | R449A | YES | 1 | 0.01-0.05 | NR | NR | NR |
| 17H | CO | R449A | YES | 1 | 0.01-0.05 | NR | NR | NR |
| 17I | Comp | R449A | POE | 1 | 0.01-0.05 | NR | NR | NR |
| 17J | CEO | R449A | POE | 1 | 0.01-0.05 | NR | NR | NR |
| 17K | CO | R449A | POE | 1 | 0.01-0.05 | NR | NR | NR |
| 17L | Comp | R449A | PVE | 1 | 0.01-0.05 | NR | NR | NR |
| 17M | CEO | R449A | PVE | 1 | 0.01-0.05 | NR | NR | NR |
| 17N | CO | R449A | PVE | 1 | 0.01-0.05 | NR | NR | NR |
| 17O | Comp | R449A | POE | 5A | 0.01-0.1 | NR | NR | NR |
| 17P | CEO | R449A | POE | 5A | 0.01-0.1 | NR | NR | NR |
| 17Q | CO | R449A | POE | 5A | 0.01-0.1 | NR | NR | NR |
| 17R | Comp | R449A | PVE | 5A | 0.01-0.1 | NR | NR | NR |
| 17S | CEO | R449A | PVE | 5A | 0.01-0.1 | NR | NR | NR |
| 17T | CO | R449A | PVE | 5A | 0.01-0.1 | NR | NR | NR |
| 18A | Comp | R449B | YES | 1 | NR | NR | NR | NR |
| 18B | CEO | R449B | YES | 1 | NR | NR | NR | NR |
| 18C | CO | R449B | YES | 1 | NR | NR | NR | NR |
| 18D | Comp | R449B | YES | 1 | 0.01-0.1 | NR | NR | NR |
| 18E | CEO | R449B | YES | 1 | 0.01-0.1 | NR | NR | NR |
| 18F | Comp | R449B | YES | 1 | 0.01-0.05 | NR | NR | NR |
| 18G | CEO | R449B | YES | 1 | 0.01-0.05 | NR | NR | NR |
| 18H | CO | R449B | YES | 1 | 0.01-0.05 | NR | NR | NR |
| 18I | Comp | R449B | POE | 1 | 0.01-0.05 | NR | NR | NR |
| 18J | CEO | R449B | POE | 1 | 0.01-0.05 | NR | NR | NR |
| 18K | CO | R449B | POE | 1 | 0.01-0.05 | NR | NR | NR |
| 18L | Comp | R449B | PVE | 1 | 0.01-0.05 | NR | NR | NR |
| 18M | CEO | R449B | PVE | 1 | 0.01 -0.05 | NR | NR | NR |
| 18N | CO | R449B | PVE | 1 | 0.01-0.05 | NR | NR | NR |
| 18O | Comp | R449B | POE | 5A | 0.01-0.1 | NR | NR | NR |
| 18P | CEO | R449B | POE | 5A | 0.01-0.1 | NR | NR | NR |
| 18Q | CC | R449B | POE | 5A | 0.01-0.1 | NR | NR | NR |
| 18R | Comp | R449B | PVE | 5A | 0.01-0.1 | NR | NR | NR |
| 18S | CEO | R449B | PVE | 5A | 0.01-0.1 | NR | NR | NR |
| 18T | CO | R449B | PVE | 5A | 0.01-0.1 | NR | NR | NR |
| 19A | Comp | R449C | YES | 1 | NR | NR | NR | NR |
| 19B | CEO | R449C | YES | 1 | NR | NR | NR | NR |
| 19C | CO | R449C | YES | 1 | NR | NR | NR | NR |
| 19D | Comp | R449C | YES | 1 | 0.01-0.1 | NR | NR | NR |
| 19E | CEO | R449C | YES | 1 | 0.01-0.1 | NR | NR | NR |
| 19F | Comp | R449C | YES | 1 | 0.01-0.05 | NR | NR | NR |
| 19G | CEO | R449C | YES | 1 | 0.01-0.05 | NR | NR | NR |
| 19H | CO | R449C | YES | 1 | 0.01-0.05 | NR | NR | NR |
| 19I | Comp | R449C | POE | 1 | 0.01-0.05 | NR | NR | NR |
| 19J | CEO | R449C | POE | 1 | 0.01-0.05 | NR | NR | NR |
| 19K | CO | R449C | POE | 1 | 0.01-0.05 | NR | NR | NR |
| 19L | Comp | R449C | PVE | 1 | 0.01-0.05 | NR | NR | NR |
| 19M | CEO | R449C | PVE | 1 | 0.01-0.05 | NR | NR | NR |
| 19N | CO | R449C | PVE | 1 | 0.01-0.05 | NR | NR | NR |
| 19O | Comp | R449C | POE | 5A | 0.01-0.1 | NR | NR | NR |
| 19P | CEO | R449C | POE | 5A | 0.01-0.1 | NR | NR | NR |
| 19Q | CO | R449C | POE | 5A | 0.01-0.1 | NR | NR | NR |
| 19R | Comp | R449C | PVE | 5A | 0.01-0.1 | NR | NR | NR |
| 19S | CEO | R449C | PVE | 5A | 0.01-0.1 | NR | NR | NR |
| 19T | CO | R449C | PVE | 5A | 0.01-0.1 | NR | NR | NR |
| 20A | Comp | R450A | YES | 1 | NR | NR | NR | NR |
| 20B | CEO | R450A | YES | 1 | NR | NR | NR | NR |
| 20C | CO | R450A | YES | 1 | NR | NR | NR | NR |
| 20D | Comp | R450A | YES | 1 | 0.01-0.1 | NR | NR | NR |
| 20E | CEO | R450A | YES | 1 | 0.01-0.1 | NR | NR | NR |
| 20F | Comp | R450A | YES | 1 | 0.01-0.05 | NR | NR | NR |
| 20G | CEO | R450A | YES | 1 | 0.01-0.05 | NR | NR | NR |
| 20H | CO | R450A | YES | 1 | 0.01-0.05 | NR | NR | NR |
| 20I | Comp | R450A | POE | 1 | 0.01-0.05 | NR | NR | NR |
| 20J | CEO | R450A | POE | 1 | 0.01-0.05 | NR | NR | NR |
| 20K | CO | R450A | POE | 1 | 0.01-0.05 | NR | NR | NR |
| 20L | Comp | R450A | PVE | 1 | 0.01-0.05 | NR | NR | NR |
| 20M | CEO | R450A | PVE | 1 | 0.01-0.05 | NR | NR | NR |
| 20N | CO | R450A | PVE | 1 | 0.01-0.05 | NR | NR | NR |
| 20O | Comp | R450A | POE | 5A | 0.01-0.1 | NR | NR | NR |
| 20P | CEO | R450A | POE | 5A | 0.01-0.1 | NR | NR | NR |
| 20Q | CO | R450A | POE | 5A | 0.01-0.1 | NR | NR | NR |
| 20R | Comp | R450A | PVE | 5A | 0.01-0.1 | NR | NR | NR |
| 20S | CEO | R450A | PVE | 5A | 0.01-0.1 | NR | NR | NR |
| 20T | CC | R450A | PVE | 5A | 0.01-0.1 | NR | NR | NR |
| 21A | Comp | R452A | YES | 1 | NR | NR | NR | NR |
| 21B | CEO | R452A | YES | 1 | NR | NR | NR | NR |
| 21C | CO | R452A | YES | 1 | NR | NR | NR | NR |
| 21D | Comp | R452A | YES | 1 | 0.01-0.1 | NR | NR | NR |
| 21E | CEO | R452A | YES | 1 | 0.01-0.1 | NR | NR | NR |
| 21F | Comp | R452A | YES | 1 | 0.01-0.05 | NR | NR | NR |
| 21G | CEO | R452A | YES | 1 | 0.01-0.05 | NR | NR | NR |
| 21H | CO | R452A | YES | 1 | 0.01-0.05 | NR | NR | NR |
| 21I | Comp | R452A | POE | 1 | 0.01-0.05 | NR | NR | NR |
| 21J | CEO | R452A | POE | 1 | 0.01-0.05 | NR | NR | NR |
| 21K | CO | R452A | POE | 1 | 0.01-0.05 | NR | NR | NR |
| 21L | Comp | R452A | PVE | 1 | 0.01-0.05 | NR | NR | NR |
| 21M | CEO | R452A | PVE | 1 | 0.01-0.05 | NR | NR | NR |
| 21N | CO | R452A | PVE | 1 | 0.01-0.05 | NR | NR | NR |
| 21O | Comp | R452A | POE | 5A | 0.01-0.1 | NR | NR | NR |
| 21P | CEO | R452A | POE | 5A | 0.01-0.1 | NR | NR | NR |
| 21Q | CO | R452A | POE | 5A | 0.01-0.1 | NR | NR | NR |
| 21R | Comp | R452A | PVE | 5A | 0.01-0.1 | NR | NR | NR |
| 21S | CEO | R452A | PVE | 5A | 0.01-0.1 | NR | NR | NR |
| 21T | CO | R452A | PVE | 5A | 0.01-0.1 | NR | NR | NR |
| 22A | Comp | R452B | YES | 1 | NR | NR | NR | NR |
| 22B | CEO | R452B | YES | 1 | NR | NR | NR | NR |
| 22C | CO | R452B | YES | 1 | NR | NR | NR | NR |
| 22D | Comp | R452B | YES | 1 | 0.01-0.1 | NR | NR | NR |
| 22E | CEO | R452B | YES | 1 | 0.01-0.1 | NR | NR | NR |
| 22F | Comp | R452B | YES | 1 | 0.01-0.05 | NR | NR | NR |
| 22G | CEO | R452B | YES | 1 | 0.01-0.05 | NR | NR | NR |
| 22H | CO | R452B | YES | 1 | 0.01-0.05 | NR | NR | NR |
| 22I | Comp | R452B | POE | 1 | 0.01-0.05 | NR | NR | NR |
| 22J | CEO | R452B | POE | 1 | 0.01-0.05 | NR | NR | NR |
| 22K | CO | R452B | POE | 1 | 0.01-0.05 | NR | NR | NR |
| 22L | Comp | R452B | PVE | 1 | 0.01-0.05 | NR | NR | NR |
| 22M | CEO | R452B | PVE | 1 | 0.01-0.05 | NR | NR | NR |
| 22N | CO | R452B | PVE | 1 | 0.01-0.05 | NR | NR | NR |
| 22O | Comp | R452B | POE | 5A | 0.01-0.1 | NR | NR | NR |
| 22P | CEO | R452B | POE | 5A | 0.01-0.1 | NR | NR | NR |
| 22Q | CO | R452B | POE | 5A | 0.01-0.1 | NR | NR | NR |
| 22R | Comp | R452B | PVE | 5A | 0.01-0.1 | NR | NR | NR |
| 22S | CEO | R452B | PVE | 5A | 0.01-0.1 | NR | NR | NR |
| 22T | CO | R452B | PVE | 5A | 0.01-0.1 | NR | NR | NR |
| 23A | Comp | R454A | YES | 1 | NR | NR | NR | NR |
| 23B | CEO | R454A | YES | 1 | NR | NR | NR | NR |
| 23C | CO | R454A | YES | 1 | NR | NR | NR | NR |
| 23D | Comp | R454A | YES | 1 | 0.01-0.1 | NR | NR | NR |
| 23E | CEO | R454A | YES | 1 | 0.01-0.1 | NR | NR | NR |
| 23F | Comp | R454A | YES | 1 | 0.01-0.05 | NR | NR | NR |
| 23G | CEO | R454A | YES | 1 | 0.01-0.05 | NR | NR | NR |
| 23H | CO | R454A | YES | 1 | 0.01-0.05 | NR | NR | NR |
| 23I | Comp | R454A | POE | 1 | 0.01-0.05 | NR | NR | NR |
| 23J | CEO | R454A | POE | 1 | 0.01-0.05 | NR | NR | NR |
| 23K | CO | R454A | POE | 1 | 0.01-0.05 | NR | NR | NR |
| 23L | Comp | R454A | PVE | 1 | 0.01-0.05 | NR | NR | NR |
| 23M | CEO | R454A | PVE | 1 | 0.01-0.05 | NR | NR | NR |
| 23N | CO | R454A | PVE | 1 | 0.01-0.05 | NR | NR | NR |
| 23O | Comp | R454A | POE | 5A | 0.01-0.1 | NR | NR | NR |
| 23P | CEO | R454A | POE | 5A | 0.01-0.1 | NR | NR | NR |
| 23Q | CO | R454A | POE | 5A | 0.01-0.1 | NR | NR | NR |
| 23R | Comp | R454A | PVE | 5A | 0.01-0.1 | NR | NR | NR |
| 23S | CEO | R454A | PVE | 5A | 0.01-0.1 | NR | NR | NR |
| 23T | CO | R454A | PVE | 5A | 0.01-0.1 | NR | NR | NR |
| 24A | Comp | R454B | YES | 1 | NR | NR | NR | NR |
| 24B | CEO | R454B | YES | 1 | NR | NR | NR | NR |
| 24C | CO | R454B | YES | 1 | NR | NR | NR | NR |
| 24D | Comp | R454B | YES | 1 | 0.01-0.1 | NR | NR | NR |
| 24E | CEO | R454B | YES | 1 | 0.01-0.1 | NR | NR | NR |
| 24F | Comp | R454B | YES | 1 | 0.01-0.05 | NR | NR | NR |
| 24G | CEO | R454B | YES | 1 | 0.01-0.05 | NR | NR | NR |
| 24H | CO | R454B | YES | 1 | 0.01-0.05 | NR | NR | NR |
| 24I | Comp | R454B | POE | 1 | 0.01-0.05 | NR | NR | NR |
| 24J | CEO | R454B | POE | 1 | 0.01-0.05 | NR | NR | NR |
| 24K | CO | R454B | POE | 1 | 0.01-0.05 | NR | NR | NR |
| 24L | Comp | R454B | PVE | 1 | 0.01-0.05 | NR | NR | NR |
| 24M | CEO | R454B | PVE | 1 | 0.01-0.05 | NR | NR | NR |
| 24N | CO | R454B | PVE | 1 | 0.01-0.05 | NR | NR | NR |
| 24O | Comp | R454B | POE | 5A | 0.01-0.1 | NR | NR | NR |
| 24P | CEO | R454B | POE | 5A | 0.01-0.1 | NR | NR | NR |
| 24Q | CO | R454B | POE | 5A | 0.01-0.1 | NR | NR | NR |
| 24R | Comp | R454B | PVE | 5A | 0.01-0.1 | NR | NR | NR |
| 24S | CEO | R454B | PVE | 5A | 0.01-0.1 | NR | NR | NR |
| 24T | CO | R454B | PVE | 5A | 0.01-0.1 | NR | NR | NR |
| 25A | Comp | R454C | YES | 1 | NR | NR | NR | NR |
| 25B | CEO | R454C | YES | 1 | NR | NR | NR | NR |
| 25C | CO | R454C | YES | 1 | NR | NR | NR | NR |
| 25D | Comp | R454C | YES | 1 | 0.01-0.1 | NR | NR | NR |
| 25E | CEO | R454C | YES | 1 | 0.01-0.1 | NR | NR | NR |
| 25F | Comp | R454C | YES | 1 | 0.01-0.05 | NR | NR | NR |
| 25G | CEO | R454C | YES | 1 | 0.01-0.05 | NR | NR | NR |
| 25H | CO | R454C | YES | 1 | 0.01-0.05 | NR | NR | NR |
| 25I | Comp | R454C | POE | 1 | 0.01-0.05 | NR | NR | NR |
| 25J | CEO | R454C | POE | 1 | 0.01-0.05 | NR | NR | NR |
| 25K | CO | R454C | POE | 1 | 0.01-0.05 | NR | NR | NR |
| 25L | Comp | R454C | PVE | 1 | 0.01-0.05 | NR | NR | NR |
| 25M | CEO | R454C | PVE | 1 | 0.01-0.05 | NR | NR | NR |
| 25N | CC | R454C | PVE | 1 | 0.01-0.05 | NR | NR | NR |
| 25O | Comp | R454C | POE | 5A | 0.01-0.1 | NR | NR | NR |
| 25P | CEO | R454C | POE | 5A | 0.01-0.1 | NR | NR | NR |
| 25Q | CO | R454C | POE | 5A | 0.01-0.1 | NR | NR | NR |
| 25R | Comp | R454C | PVE | 5A | 0.01-0.1 | NR | NR | NR |
| 25S | CEO | R454C | PVE | 5A | 0.01-0.1 | NR | NR | NR |
| 25T | CO | R454C | PVE | 5A | 0.01-0.1 | NR | NR | NR |
| 26A | Comp | R455A | YES | 1 | NR | NR | NR | NR |
| 26B | CEO | R455A | YES | 1 | NR | NR | NR | NR |
| 26C | CO | R455A | YES | 1 | NR | NR | NR | NR |
| 26D | Comp | R455A | YES | 1 | 0.01-0.1 | NR | NR | NR |
| 26E | CEO | R455A | YES | 1 | 0.01-0.1 | NR | NR | NR |
| 26F | Comp | R455A | YES | 1 | 0.01-0.05 | NR | NR | NR |
| 26G | CEO | R455A | YES | 1 | 0.01-0.05 | NR | NR | NR |
| 26H | CO | R455A | YES | 1 | 0.01-0.05 | NR | NR | NR |
| 26I | Comp | R455A | POE | 1 | 0.01-0.05 | NR | NR | NR |
| 26J | CEO | R455A | POE | 1 | 0.01-0.05 | NR | NR | NR |
| 26K | CO | R455A | POE | 1 | 0.01-0.05 | NR | NR | NR |
| 26L | Comp | R455A | PVE | 1 | 0.01-0.05 | NR | NR | NR |
| 26M | CEO | R455A | PVE | 1 | 0.01-0.05 | NR | NR | NR |
| 26N | CO | R455A | PVE | 1 | 0.01-0.05 | NR | NR | NR |
| 26O | Comp | R455A | POE | 5A | 0.01-0.1 | NR | NR | NR |
| 26P | CEO | R455A | POE | 5A | 0.01-0.1 | NR | NR | NR |
| 26Q | CO | R455A | POE | 5A | 0.01-0.1 | NR | NR | NR |
| 26R | Comp | R455A | PVE | 5A | 0.01-0.1 | NR | NR | NR |
| 26S | CEO | R455A | PVE | 5A | 0.01-0.1 | NR | NR | NR |
| 26T | CO | R455A | PVE | 5A | 0.01-0.1 | NR | NR | NR |
| 27A | Comp | R456A | YES | 1 | NR | NR | NR | NR |
| 27B | CEO | R456A | YES | 1 | NR | NR | NR | NR |
| 27C | CO | R456A | YES | 1 | NR | NR | NR | NR |
| 27D | Comp | R456A | YES | 1 | 0.01-0.1 | NR | NR | NR |
| 27E | CEO | R456A | YES | 1 | 0.01-0.1 | NR | NR | NR |
| 27F | Comp | R456A | YES | 1 | 0.01-0.05 | NR | NR | NR |
| 27G | CEO | R456A | YES | 1 | 0.01-0.05 | NR | NR | NR |
| 27H | CO | R456A | YES | 1 | 0.01-0.05 | NR | NR | NR |
| 27I | Comp | R456A | POE | 1 | 0.01-0.05 | NR | NR | NR |
| 27J | CEO | R456A | POE | 1 | 0.01-0.05 | NR | NR | NR |
| 27K | CO | R456A | POE | 1 | 0.01-0.05 | NR | NR | NR |
| 27L | Comp | R456A | PVE | 1 | 0.01-0.05 | NR | NR | NR |
| 27M | CEO | R456A | PVE | 1 | 0.01-0.05 | NR | NR | NR |
| 27N | CO | R456A | PVE | 1 | 0.01-0.05 | NR | NR | NR |
| 27O | Comp | R456A | POE | 5A | 0.01-0.1 | NR | NR | NR |
| 27P | CEO | R456A | POE | 5A | 0.01-0.1 | NR | NR | NR |
| 27Q | CO | R456A | POE | 5A | 0.01-0.1 | NR | NR | NR |
| 27R | Comp | R456A | PVE | 5A | 0.01-0.1 | NR | NR | NR |
| 27S | CEO | R456A | PVE | 5A | 0.01-0.1 | NR | NR | NR |
| 27T | CO | R456A | PVE | 5A | 0.01-0.1 | NR | NR | NR |
| 27U | Comp | R456A | POE | 5A | 0.01-0.05 | NR | NR | NR |
| 27V | CEO | R456A | POE | 5A | 0.01-0.05 | NR | NR | NR |
| 27W | CO | R456A | POE | 5A | 0.01-0.05 | NR | NR | NR |
| 27X | Comp | R456A | PVE | 5A | 0.01-0.05 | NR | NR | NR |
| 27Y | CEO | R456A | PVE | 5A | 0.01-0.05 | NR | NR | NR |
| 27Z | CO | R456A | PVE | 5A | 0.01-0.05 | NR | NR | NR |
| 28A | Comp | R457A | YES | 1 | NR | NR | NR | NR |
| 28B | CEO | R457A | YES | 1 | NR | NR | NR | NR |
| 28C | CO | R457A | YES | 1 | NR | NR | NR | NR |
| 28D | Comp | R457A | YES | 1 | 0.01-0.1 | NR | NR | NR |
| 28E | CEO | R457A | YES | 1 | 0.01-0.1 | NR | NR | NR |
| 28F | Comp | R457A | YES | 1 | 0.01-0.05 | NR | NR | NR |
| 28G | CEO | R457A | YES | 1 | 0.01-0.05 | NR | NR | NR |
| 28H | CO | R457A | YES | 1 | 0.01-0.05 | NR | NR | NR |
| 28I | Comp | R457A | POE | 1 | 0.01-0.05 | NR | NR | NR |
| 28J | CEO | R457A | POE | 1 | 0.01-0.05 | NR | NR | NR |
| 28K | CO | R457A | POE | 1 | 0.01-0.05 | NR | NR | NR |
| 28L | Comp | R457A | PVE | 1 | 0.01-0.05 | NR | NR | NR |
| 28M | CEO | R457A | PVE | 1 | 0.01-0.05 | NR | NR | NR |
| 28N | CO | R457A | PVE | 1 | 0.01-0.05 | NR | NR | NR |
| 28O | Comp | R457A | POE | 5A | 0.01-0.1 | NR | NR | NR |
| 28P | CEO | R457A | POE | 5A | 0.01-0.1 | NR | NR | NR |
| 28Q | CO | R457A | POE | 5A | 0.01-0.1 | NR | NR | NR |
| 28R | Comp | R457A | PVE | 5A | 0.01-0.1 | NR | NR | NR |
| 28S | CEO | R457A | PVE | 5A | 0.01-0.1 | NR | NR | NR |
| 28T | CO | R457A | PVE | 5A | 0.01-0.1 | NR | NR | NR |
| 28A | Comp | R457B | YES | 1 | NR | NR | NR | NR |
| 28B | CEO | R457B | YES | 1 | NR | NR | NR | NR |
| 28C | CO | R457B | YES | 1 | NR | NR | NR | NR |
| 28D | Comp | R457B | YES | 1 | 0.01-0.1 | NR | NR | NR |
| 28E | CO | R457B | YES | 1 | 0.01-0.1 | NR | NR | NR |
| 28F | Comp | R457B | YES | 1 | 0.01-0.05 | NR | NR | NR |
| 28G | CEO | R457B | YES | 1 | 0.01-0.05 | NR | NR | NR |
| 28H | CO | R457B | YES | 1 | 0.01-0.05 | NR | NR | NR |
| 28I | Comp | R457B | POE | 1 | 0.01-0.05 | NR | NR | NR |
| 28J | CEO | R457B | POE | 1 | 0.01-0.05 | NR | NR | NR |
| 28K | CO | R457B | POE | 1 | 0.01-0.05 | NR | NR | NR |
| 28L | Comp | R457B | PVE | 1 | 0.01-0.05 | NR | NR | NR |
| 28M | CEO | R457B | PVE | 1 | 0.01-0.05 | NR | NR | NR |
| 28N | CO | R457B | PVE | 1 | 0.01-0.05 | NR | NR | NR |
| 28O | Comp | R457B | POE | 5A | 0.01-0.1 | NR | NR | NR |
| 28P | CEO | R457B | POE | 5A | 0.01-0.1 | NR | NR | NR |
| 28Q | CO | R457B | POE | 5A | 0.01-0.1 | NR | NR | NR |
| 28R | Comp | R457B | PVE | 5A | 0.01-0.1 | NR | NR | NR |
| 28S | CEO | R457B | PVE | 5A | 0.01-0.1 | NR | NR | NR |
| 28T | CO | R457B | PVE | 5A | 0.01-0.1 | NR | NR | NR |
| 29A | Comp | R457C | YES | 1 | NR | NR | NR | NR |
| 29B | CEO | R457C | YES | 1 | NR | NR | NR | NR |
| 29C | CO | R457C | YES | 1 | NR | NR | NR | NR |
| 29D | Comp | R457C | YES | 1 | 0.01-0.1 | NR | NR | NR |
| 29E | CEO | R457C | YES | 1 | 0.01-0.1 | NR | NR | NR |
| 29F | Comp | R457C | YES | 1 | 0.01-0.05 | NR | NR | NR |
| 29G | CEO | R457C | YES | 1 | 0.01-0.05 | NR | NR | NR |
| 29H | CO | R457C | YES | 1 | 0.01-0.05 | NR | NR | NR |
| 29I | Comp | R457C | POE | 1 | 0.01-0.05 | NR | NR | NR |
| 29J | CEO | R457C | POE | 1 | 0.01-0.05 | NR | NR | NR |
| 29K | CO | R457C | POE | 1 | 0.01-0.05 | NR | NR | NR |
| 29L | Comp | R457C | PVE | 1 | 0.01-0.05 | NR | NR | NR |
| 29M | CEO | R457C | PVE | 1 | 0.01-0.05 | NR | NR | NR |
| 29N | CO | R457C | PVE | 1 | 0.01-0.05 | NR | NR | NR |
| 29O | Comp | R457C | POE | 5A | 0.01-0.1 | NR | NR | NR |
| 29P | CEO | R457C | POE | 5A | 0.01-0.1 | NR | NR | NR |
| 29Q | CO | R457C | POE | 5A | 0.01-0.1 | NR | NR | NR |
| 29R | Comp | R457C | PVE | 5A | 0.01-0.1 | NR | NR | NR |
| 29S | CEO | R457C | PVE | 5A | 0.01-0.1 | NR | NR | NR |
| 29T | CO | R457C | PVE | 5A | 0.01-0.1 | NR | NR | NR |
| 30A | Comp | R466A | YES | 1 | NR | NR | NR | NR |
| 30B | CEO | R466A | YES | 1 | NR | NR | NR | NR |
| 30C | CO | R466A | YES | 1 | NR | NR | NR | NR |
| 30D | Comp | R466A | YES | 1 | 0.01-0.1 | NR | NR | NR |
| 30E | CEO | R466A | YES | 1 | 0.01-0.1 | NR | NR | NR |
| 30F | Comp | R466A | YES | 1 | 0.01-0.05 | NR | NR | NR |
| 30G | CEO | R466A | YES | 1 | 0.01-0.05 | NR | NR | NR |
| 30H | CO | R466A | YES | 1 | 0.01-0.05 | NR | NR | NR |
| 30I | Comp | R466A | POE | 1 | 0.01-0.05 | NR | NR | NR |
| 30J | CEO | R466A | POE | 1 | 0.01-0.05 | NR | NR | NR |
| 30K | CO | R466A | POE | 1 | 0.01-0.05 | NR | NR | NR |
| 30L | Comp | R466A | PVE | 1 | 0.01-0.05 | NR | NR | NR |
| 30M | CEO | R466A | PVE | 1 | 0.01-0.05 | NR | NR | NR |
| 30N | CO | R466A | PVE | 1 | 0.01-0.05 | NR | NR | NR |
| 30O | Comp | R466A | POE | 5A | 0.01-0.1 | NR | NR | NR |
| 30P | CEO | R466A | POE | 5A | 0.01-0.1 | NR | NR | NR |
| 30Q | CO | R466A | POE | 5A | 0.01-0.1 | NR | NR | NR |
| 30R | Comp | R466A | PVE | 5A | 0.01-0.1 | NR | NR | NR |
| 30S | CEO | R466A | PVE | 5A | 0.01-0.1 | NR | NR | NR |
| 30T | CO | R466A | PVE | 5A | 0.01-0.1 | NR | NR | NR |
| 31A | Comp | HDR-139 | YES | 1 | NR | NR | NR | NR |
| 31B | CEO | HDR-139 | YES | 1 | NR | NR | NR | NR |
| 31C | CO | HDR-139 | YES | 1 | NR | NR | NR | NR |
| 31D | Comp | HDR-139 | YES | 1 | 0.01-0.1 | NR | NR | NR |
| 31E | CEO | HDR-139 | YES | 1 | 0.01-0.1 | NR | NR | NR |
| 31F | Comp | HDR-139 | YES | 1 | 0.01-0.05 | NR | NR | NR |
| 31G | CEO | HDR-139 | YES | 1 | 0.01-0.05 | NR | NR | NR |
| 31H | CO | HDR-139 | YES | 1 | 0.01-0.05 | NR | NR | NR |
| 31I | Comp | HDR-139 | POE | 1 | 0.01-0.05 | NR | NR | NR |
| 31J | CEO | HDR-139 | POE | 1 | 0.01-0.05 | NR | NR | NR |
| 31K | CO | HDR-139 | POE | 1 | 0.01-0.05 | NR | NR | NR |
| 31L | Comp | HDR-139 | PVE | 1 | 0.01-0.05 | NR | NR | NR |
| 31M | CEO | HDR-139 | PVE | 1 | 0.01-0.05 | NR | NR | NR |
| 31N | CO | HDR-139 | PVE | 1 | 0.01-0.05 | NR | NR | NR |
| 31O | Comp | HDR-139 | POE | 5A | 0.01-0.1 | NR | NR | NR |
| 31P | CEO | HDR-139 | POE | 5A | 0.01-0.1 | NR | NR | NR |
| 31Q | CO | HDR-139 | POE | 5A | 0.01-0.1 | NR | NR | NR |
| 31R | Comp | HDR-139 | PVE | 5A | 0.01-0.1 | NR | NR | NR |
| 31S | CEO | HDR-139 | PVE | 5A | 0.01-0.1 | NR | NR | NR |
| 31T | CO | HDR-139 | PVE | 5A | 0.01-0.1 | NR | NR | NR |
| 31U | Comp | HDR-139 | POE | 5A | 0.01-0.1 | AN4 | ADM4 | NR |
| 31V | CEO | HDR-139 | POE | 5A | 0.01-0.1 | AN4 | ADM4 | NR |
| 31W | CO | HDR-139 | POE | 5A | 0.01-0.1 | AN4 | ADM4 | NR |
| 31X | Comp | HDR-139 | PVE | 5A | 0.01-0.05 | AN4 | ADM4 | NR |
| 31Y | CEO | HDR-139 | PVE | 5A | 0.01-0.05 | AN4 | ADM4 | NR |
| 31Z | CO | HDR-139 | PVE | 5A | 0.01-0.05 | AN4 | ADM4 | NR |
| 32A | Comp | HDR-147 | YES | 1 | NR | NR | NR | NR |
| 32B | CEO | HDR-147 | YES | 1 | NR | NR | NR | NR |
| 32C | CO | HDR-147 | YES | 1 | NR | NR | NR | NR |
| 32D | Comp | HDR-147 | YES | 1 | 0.01-0.1 | NR | NR | NR |
| 32E | CEO | HDR-147 | YES | 1 | 0.01-0.1 | NR | NR | NR |
| 32F | Comp | HDR-147 | YES | 1 | 0.01-0.05 | NR | NR | NR |
| 32G | CEO | HDR-147 | YES | 1 | 0.01-0.05 | NR | NR | NR |
| 32H | CO | HDR-147 | YES | 1 | 0.01-0.05 | NR | NR | NR |
| 32I | Comp | HDR-147 | POE | 1 | 0.01-0.05 | NR | NR | NR |
| 32J | CEO | HDR-147 | POE | 1 | 0.01-0.05 | NR | NR | NR |
| 32K | CO | HDR-147 | POE | 1 | 0.01-0.05 | NR | NR | NR |
| 32L | Comp | HDR-147 | PVE | 1 | 0.01-0.05 | NR | NR | NR |
| 32M | CEO | HDR-147 | PVE | 1 | 0.01-0.05 | NR | NR | NR |
| 32N | CO | HDR-147 | PVE | 1 | 0.01-0.05 | NR | NR | NR |
| 32O | Comp | HDR-147 | POE | 5A | 0.01-0.1 | NR | NR | NR |
| 32P | CEO | HDR-147 | POE | 5A | 0.01-0.1 | NR | NR | NR |
| 32Q | CO | HDR-147 | POE | 5A | 0.01-0.1 | NR | NR | NR |
| 32R | Comp | HDR-147 | PVE | 5A | 0.01-0.1 | NR | NR | NR |
| 32S | CEO | HDR-147 | PVE | 5A | 0.01-0.1 | NR | NR | NR |
| 32T | CO | HDR-147 | PVE | 5A | 0.01-0.1 | NR | NR | NR |
| 32U | Comp | HDR-147 | POE | 5A | 0.01-0.1 | AN4 | ADM4 | NR |
| 32V | CEO | HDR-147 | POE | 5A | 0.01-0.1 | AN4 | ADM4 | NR |
| 32W | CO | HDR-147 | POE | 5A | 0.01-0.1 | AN4 | ADM4 | NR |
| 32X | Comp | HDR-147 | PVE | 5A | 0.01-0.05 | AN4 | ADM4 | NR |
| 32Y | CEO | HDR-147 | PVE | 5A | 0.01-0.05 | AN4 | ADM4 | NR |
| 32Z | CO | HDR-147 | PVE | 5A | 0.01-0.05 | AN4 | ADM4 | NR |
| 33A | Comp | HDR-171 | YES | 1 | NR | NR | NR | NR |
| 33B | CEO | HDR-171 | YES | 1 | NR | NR | NR | NR |
| 33C | CO | HDR-171 | YES | 1 | NR | NR | NR | NR |
| 33D | Comp | HDR-171 | YES | 1 | 0.01-0.1 | NR | NR | NR |
| 33E | CEO | HDR-171 | YES | 1 | 0.01-0.1 | NR | NR | NR |
| 33F | Comp | HDR-171 | YES | 1 | 0.01-0.05 | NR | NR | NR |
| 33G | CEO | HDR-171 | YES | 1 | 0.01-0.05 | NR | NR | NR |
| 33H | CO | HDR-171 | YES | 1 | 0.01-0.05 | NR | NR | NR |
| 33I | Comp | HDR-171 | POE | 1 | 0.01-0.05 | NR | NR | NR |
| 33J | CEO | HDR-171 | POE | 1 | 0.01-0.05 | NR | NR | NR |
| 33K | CO | HDR-171 | POE | 1 | 0.01-0.05 | NR | NR | NR |
| 33L | Comp | HDR-171 | PVE | 1 | 0.01-0.05 | NR | NR | NR |
| 33M | CEO | HDR-171 | PVE | 1 | 0.01-0.05 | NR | NR | NR |
| 33N | CO | HDR-171 | PVE | 1 | 0.01-0.05 | NR | NR | NR |
| 33O | Comp | HDR-171 | POE | 5A | 0.01-0.1 | NR | NR | NR |
| 33P | CEO | HDR-171 | POE | 5A | 0.01-0.1 | NR | NR | NR |
| 33Q | CO | HDR-171 | POE | 5A | 0.01-0.1 | NR | NR | NR |
| 33R | Comp | HDR-171 | PVE | 5A | 0.01-0.1 | NR | NR | NR |
| 33S | CEO | HDR-171 | PVE | 5A | 0.01-0.1 | NR | NR | NR |
| 33T | CO | HDR-171 | PVE | 5A | 0.01-0.1 | NR | NR | NR |
| 34A | Comp | HDR-173 | YES | 1 | NR | NR | NR | NR |
| 34B | CEO | HDR-173 | YES | 1 | NR | NR | NR | NR |
| 34C | CO | HDR-173 | YES | 1 | NR | NR | NR | NR |
| 34D | Comp | HDR-173 | YES | 1 | 0.01-0.1 | NR | NR | NR |
| 34E | CEO | HDR-173 | YES | 1 | 0.01-0.1 | NR | NR | NR |
| 34F | Comp | HDR-173 | YES | 1 | 0.01-0.05 | NR | NR | NR |
| 34G | CEO | HDR-173 | YES | 1 | 0.01-0.05 | NR | NR | NR |
| 34H | CO | HDR-173 | YES | 1 | 0.01-0.05 | NR | NR | NR |
| 34I | Comp | HDR-173 | POE | 1 | 0.01-0.05 | NR | NR | NR |
| 34J | CEO | HDR-173 | POE | 1 | 0.01-0.05 | NR | NR | NR |
| 34K | CO | HDR-173 | POE | 1 | 0.01-0.05 | NR | NR | NR |
| 34L | Comp | HDR-173 | PVE | 1 | 0.01-0.05 | NR | NR | NR |
| 34M | CEO | HDR-173 | PVE | 1 | 0.01-0.05 | NR | NR | NR |
| 34N | CO | HDR-173 | PVE | 1 | 0.01-0.05 | NR | NR | NR |
| 34O | Comp | HDR-173 | POE | 5A | 0.01-0.1 | NR | NR | NR |
| 34P | CEO | HDR-173 | POE | 5A | 0.01-0.1 | NR | NR | NR |
| 34Q | CO | HDR-173 | POE | 5A | 0.01-0.1 | NR | NR | NR |
| 34R | Comp | HDR-173 | PVE | 5A | 0.01-0.1 | NR | NR | NR |
| 34S | CEO | HDR-173 | PVE | 5A | 0.01-0.1 | NR | NR | NR |
| 34T | CO | HDR-173 | PVE | 5A | 0.01-0.1 | NR | NR | NR |
| 35A | Comp | R471A | YES | 1 | NR | NR | NR | NR |
| 35B | CEO | R471A | YES | 1 | NR | NR | NR | NR |
| 35C | CO | R471A | YES | 1 | NR | NR | NR | NR |
| 35D | Comp | R471A | YES | 1 | 0.01-0.1 | NR | NR | NR |
| 35E | CEO | R471A | YES | 1 | 0.01-0.1 | NR | NR | NR |
| 35F | Comp | R471A | YES | 1 | 0.01-0.05 | NR | NR | NR |
| 35G | CEO | R471A | YES | 1 | 0.01-0.05 | NR | NR | NR |
| 35H | CO | R471A | YES | 1 | 0.01-0.05 | NR | NR | NR |
| 35I | Comp | R471A | POE | 1 | 0.01-0.05 | NR | NR | NR |
| 35J | CEO | R471A | POE | 1 | 0.01-0.05 | NR | NR | NR |
| 35K | CO | R471A | POE | 1 | 0.01-0.05 | NR | NR | NR |
| 35L | Comp | R471A | PVE | 1 | 0.01-0.05 | NR | NR | NR |
| 35M | CEO | R471A | PVE | 1 | 0.01-0.05 | NR | NR | NR |
| 35N | CO | R471A | PVE | 1 | 0.01-0.05 | NR | NR | NR |
| 35O | Comp | R471A | POE | 5A | 0.01-0.1 | NR | NR | NR |
| 35P | CEO | R471A | POE | 5A | 0.01-0.1 | NR | NR | NR |
| 35Q | CO | R471A | POE | 5A | 0.01-0.1 | NR | NR | NR |
| 35R | Comp | R471A | PVE | 5A | 0.01-0.1 | NR | NR | NR |
| 35S | CEO | R471A | PVE | 5A | 0.01-0.1 | NR | NR | NR |
| 35T | CO | R471A | PVE | 5A | 0.01-0.1 | NR | NR | NR |
| 36A | Comp | R474A | YES | 1 | NR | NR | NR | NR |
| 36B | CEO | R474A | YES | 1 | NR | NR | NR | NR |
| 36C | CO | R474A | YES | 1 | NR | NR | NR | NR |
| 36D | Comp | R474A | YES | 1 | 0.01-0.1 | NR | NR | NR |
| 36E | CEO | R474A | YES | 1 | 0.01-0.1 | NR | NR | NR |
| 36F | Comp | R474A | YES | 1 | 0.01-0.05 | NR | NR | NR |
| 36G | CEO | R474A | YES | 1 | 0.01-0.05 | NR | NR | NR |
| 36H | CO | R474A | YES | 1 | 0.01-0.05 | NR | NR | NR |
| 36I | Comp | R474A | POE | 1 | 0.01-0.05 | NR | NR | NR |
| 36J | CEO | R474A | POE | 1 | 0.01-0.05 | NR | NR | NR |
| 36K | CO | R474A | POE | 1 | 0.01-0.05 | NR | NR | NR |
| 36L | Comp | R474A | PVE | 1 | 0.01-0.05 | NR | NR | NR |
| 36M | CEO | R474A | PVE | 1 | 0.01-0.05 | NR | NR | NR |
| 36N | CO | R474A | PVE | 1 | 0.01-0.05 | NR | NR | NR |
| 36O | Comp | R474A | POE | 5A | 0.01-0.1 | NR | NR | NR |
| 36P | CEO | R474A | POE | 5A | 0.01-0.1 | NR | NR | NR |
| 36Q | CO | R474A | POE | 5A | 0.01-0.1 | NR | NR | NR |
| 36R | Comp | R474A | PVE | 5A | 0.01-0.1 | NR | NR | NR |
| 36S | CEO | R474A | PVE | 5A | 0.01-0.1 | NR | NR | NR |
| 36T | CO | R474A | PVE | 5A | 0.01-0.1 | NR | NR | NR |
| 37A | Comp | R474B | YES | 1 | NR | NR | NR | NR |
| 37B | CEO | R474B | YES | 1 | NR | NR | NR | NR |
| 37C | CO | R474B | YES | 1 | NR | NR | NR | NR |
| 37D | Comp | R474B | YES | 1 | 0.01-0.1 | NR | NR | NR |
| 37E | CEO | R474B | YES | 1 | 0.01-0.1 | NR | NR | NR |
| 37F | Comp | R474B | YES | 1 | 0.01-0.05 | NR | NR | NR |
| 37G | CEO | R474B | YES | 1 | 0.01-0.05 | NR | NR | NR |
| 37H | CO | R474B | YES | 1 | 0.01-0.05 | NR | NR | NR |
| 37I | Comp | R474B | POE | 1 | 0.01-0.05 | NR | NR | NR |
| 37J | CEO | R474B | POE | 1 | 0.01-0.05 | NR | NR | NR |
| 37K | CO | R474B | POE | 1 | 0.01-0.05 | NR | NR | NR |
| 37L | Comp | R474B | PVE | 1 | 0.01-0.05 | NR | NR | NR |
| 37M | CEO | R474B | PVE | 1 | 0.01-0.05 | NR | NR | NR |
| 37N | CO | R474B | PVE | 1 | 0.01-0.05 | NR | NR | NR |
| 37O | Comp | R474B | POE | 5A | 0.01-0.1 | NR | NR | NR |
| 37P | CEO | R474B | POE | 5A | 0.01-0.1 | NR | NR | NR |
| 37Q | CO | R474B | POE | 5A | 0.01-0.1 | NR | NR | NR |
| 37R | Comp | R474B | PVE | 5A | 0.01-0.1 | NR | NR | NR |
| 37S | CEO | R474B | PVE | 5A | 0.01-0.1 | NR | NR | NR |
| 37T | CO | R474B | PVE | 5A | 0.01-0.1 | NR | NR | NR |
| 38A | Comp | R476A | YES | 1 | NR | NR | NR | NR |
| 38B | CEO | R476A | YES | 1 | NR | NR | NR | NR |
| 38C | CO | R476A | YES | 1 | NR | NR | NR | NR |
| 38D | Comp | R476A | YES | 1 | 0.01-0.1 | NR | NR | NR |
| 38E | CEO | R476A | YES | 1 | 0.01-0.1 | NR | NR | NR |
| 38F | Comp | R476A | YES | 1 | 0.01-0.05 | NR | NR | NR |
| 38G | CEO | R476A | YES | 1 | 0.01-0.05 | NR | NR | NR |
| 38H | CO | R476A | YES | 1 | 0.01-0.05 | NR | NR | NR |
| 38I | Comp | R476A | POE | 1 | 0.01-0.05 | NR | NR | NR |
| 38J | CEO | R476A | POE | 1 | 0.01-0.05 | NR | NR | NR |
| 38K | CO | R476A | POE | 1 | 0.01-0.05 | NR | NR | NR |
| 38L | Comp | R476A | PVE | 1 | 0.01-0.05 | NR | NR | NR |
| 38M | CEO | R476A | PVE | 1 | 0.01-0.05 | NR | NR | NR |
| 38N | CO | R476A | PVE | 1 | 0.01-0.05 | NR | NR | NR |
| 38O | Comp | R476A | POE | 5A | 0.01-0.1 | NR | NR | NR |
| 38P | CEO | R476A | POE | 5A | 0.01-0.1 | NR | NR | NR |
| 38Q | CO | R476A | POE | 5A | 0.01-0.1 | NR | NR | NR |
| 38R | Comp | R476A | PVE | 5A | 0.01-0.1 | NR | NR | NR |
| 38S | CEO | R476A | PVE | 5A | 0.01-0.1 | NR | NR | NR |
| 38T | CO | R476A | PVE | 5A | 0.01-0.1 | NR | NR | NR |
| 39A | Comp | R479A | YES | 1 | NR | NR | NR | NR |
| 39B | CEO | R479A | YES | 1 | NR | NR | NR | NR |
| 39C | CO | R479A | YES | 1 | NR | NR | NR | NR |
| 39D | Comp | R479A | YES | 1 | 0.01-0.1 | NR | NR | NR |
| 39E | CEO | R479A | YES | 1 | 0.01-0.1 | NR | NR | NR |
| 39F | Comp | R479A | YES | 1 | 0.01-0.05 | NR | NR | NR |
| 39G | CEO | R479A | YES | 1 | 0.01-0.05 | NR | NR | NR |
| 39H | CO | R479A | YES | 1 | 0.01-0.05 | NR | NR | NR |
| 39I | Comp | R479A | POE | 1 | 0.01-0.05 | NR | NR | NR |
| 39J | CEO | R479A | POE | 1 | 0.01-0.05 | NR | NR | NR |
| 39K | CO | R479A | POE | 1 | 0.01-0.05 | NR | NR | NR |
| 39L | Comp | R479A | PVE | 1 | 0.01-0.05 | NR | NR | NR |
| 39M | CEO | R479A | PVE | 1 | 0.01-0.05 | NR | NR | NR |
| 39N | CO | R479A | PVE | 1 | 0.01-0.05 | NR | NR | NR |
| 39O | Comp | R479A | POE | 5A | 0.01-0.1 | NR | NR | NR |
| 39P | CEO | R479A | POE | 5A | 0.01-0.1 | NR | NR | NR |
| 39Q | CO | R479A | POE | 5A | 0.01-0.1 | NR | NR | NR |
| 39R | Comp | R479A | PVE | 5A | 0.01-0.1 | NR | NR | NR |
| 39S | CEO | R479A | PVE | 5A | 0.01-0.1 | NR | NR | NR |
| 39T | CO | R479A | PVE | 5A | 0.01-0.1 | NR | NR | NR |
| 40A | Comp | R482A | YES | 1 | NR | NR | NR | NR |
| 40B | CEO | R482A | YES | 1 | NR | NR | NR | NR |
| 40C | CO | R482A | YES | 1 | NR | NR | NR | NR |
| 40D | Comp | R482A | YES | 1 | 0.01-0.1 | NR | NR | NR |
| 40E | CEO | R482A | YES | 1 | 0.01-0.1 | NR | NR | NR |
| 40F | Comp | R482A | YES | 1 | 0.01-0.05 | NR | NR | NR |
| 40G | CEO | R482A | YES | 1 | 0.01-0.05 | NR | NR | NR |
| 40H | CO | R482A | YES | 1 | 0.01-0.05 | NR | NR | NR |
| 40I | Comp | R482A | POE | 1 | 0.01-0.05 | NR | NR | NR |
| 40J | CEO | R482A | POE | 1 | 0.01-0.05 | NR | NR | NR |
| 40K | CO | R482A | POE | 1 | 0.01-0.05 | NR | NR | NR |
| 40L | Comp | R482A | PVE | 1 | 0.01-0.05 | NR | NR | NR |
| 40M | CEO | R482A | PVE | 1 | 0.01-0.05 | NR | NR | NR |
| 40N | CO | R482A | PVE | 1 | 0.01-0.05 | NR | NR | NR |
| 40O | Comp | R482A | POE | 5A | 0.01-0.1 | NR | NR | NR |
| 40P | CEO | R482A | POE | 5A | 0.01-0.1 | NR | NR | NR |
| 40Q | CO | R482A | POE | 5A | 0.01-0.1 | NR | NR | NR |
| 40R | Comp | R482A | PVE | 5A | 0.01-0.1 | NR | NR | NR |
| 40S | CEO | R482A | PVE | 5A | 0.01-0.1 | NR | NR | NR |
| 40T | CO | R482A | PVE | 5A | 0.01-0.1 | NR | NR | NR |
| 41A | Comp | R513A | YES | 1 | NR | NR | NR | NR |
| 41B | CEO | R513A | YES | 1 | NR | NR | NR | NR |
| 41C | CO | R513A | YES | 1 | NR | NR | NR | NR |
| 41D | Comp | R513A | YES | 1 | 0.01-0.1 | NR | NR | NR |
| 41E | CEO | R513A | YES | 1 | 0.01-0.1 | NR | NR | NR |
| 41F | Comp | R513A | YES | 1 | 0.01-0.05 | NR | NR | NR |
| 41G | CEO | R513A | YES | 1 | 0.01-0.05 | NR | NR | NR |
| 41H | CO | R513A | YES | 1 | 0.01-0.05 | NR | NR | NR |
| 41I | Comp | R513A | POE | 1 | 0.01-0.05 | NR | NR | NR |
| 41J | CEO | R513A | POE | 1 | 0.01-0.05 | NR | NR | NR |
| 41K | CO | R513A | POE | 1 | 0.01-0.05 | NR | NR | NR |
| 41L | Comp | R513A | PVE | 1 | 0.01-0.05 | NR | NR | NR |
| 41M | CEO | R513A | PVE | 1 | 0.01-0.05 | NR | NR | NR |
| 41N | CO | R513A | PVE | 1 | 0.01-0.05 | NR | NR | NR |
| 41O | Comp | R513A | POE | 5A | 0.01-0.1 | NR | NR | NR |
| 41P | CEO | R513A | POE | 5A | 0.01-0.1 | NR | NR | NR |
| 41Q | CO | R513A | POE | 5A | 0.01-0.1 | NR | NR | NR |
| 41R | Comp | R513A | PVE | 5A | 0.01-0.1 | NR | NR | NR |
| 41S | CEO | R513A | PVE | 5A | 0.01-0.1 | NR | NR | NR |
| 41T | CO | R513A | PVE | 5A | 0.01-0.1 | NR | NR | NR |
| 42A | Comp | R513B | YES | 1 | NR | NR | NR | NR |
| 42B | CEO | R513B | YES | 1 | NR | NR | NR | NR |
| 42C | CO | R513B | YES | 1 | NR | NR | NR | NR |
| 42D | Comp | R513B | YES | 1 | 0.01-0.1 | NR | NR | NR |
| 42E | CEO | R513B | YES | 1 | 0.01-0.1 | NR | NR | NR |
| 42F | Comp | R513B | YES | 1 | 0.01-0.05 | NR | NR | NR |
| 42G | CEO | R513B | YES | 1 | 0.01-0.05 | NR | NR | NR |
| 42H | CO | R513B | YES | 1 | 0.01-0.05 | NR | NR | NR |
| 42I | Comp | R513B | POE | 1 | 0.01-0.05 | NR | NR | NR |
| 42J | CEO | R513B | POE | 1 | 0.01-0.05 | NR | NR | NR |
| 42K | CO | R513B | POE | 1 | 0.01-0.05 | NR | NR | NR |
| 42L | Comp | R513B | PVE | 1 | 0.01-0.05 | NR | NR | NR |
| 42M | CEO | R513B | PVE | 1 | 0.01-0.05 | NR | NR | NR |
| 42N | CO | R513B | PVE | 1 | 0.01-0.05 | NR | NR | NR |
| 42O | Comp | R513B | POE | 5A | 0.01-0.1 | NR | NR | NR |
| 42P | CEO | R513B | POE | 5A | 0.01-0.1 | NR | NR | NR |
| 42Q | CO | R513B | POE | 5A | 0.01-0.1 | NR | NR | NR |
| 42R | Comp | R513B | PVE | 5A | 0.01-0.1 | NR | NR | NR |
| 42S | CEO | R513B | PVE | 5A | 0.01-0.1 | NR | NR | NR |
| 42T | CO | R513B | PVE | 5A | 0.01-0.1 | NR | NR | NR |
| 43A | Comp | R514A | YES | 1 | NR | NR | NR | NR |
| 43B | CEO | R514A | YES | 1 | NR | NR | NR | NR |
| 43C | CO | R514A | YES | 1 | NR | NR | NR | NR |
| 43D | Comp | R514A | YES | 1 | 0.01-0.1 | NR | NR | NR |
| 43E | CEO | R514A | YES | 1 | 0.01-0.1 | NR | NR | NR |
| 43F | Comp | R514A | YES | 1 | 0.01-0.05 | NR | NR | NR |
| 43G | CEO | R514A | YES | 1 | 0.01-0.05 | NR | NR | NR |
| 43H | CO | R514A | YES | 1 | 0.01-0.05 | NR | NR | NR |
| 43I | Comp | R514A | POE | 1 | 0.01-0.05 | NR | NR | NR |
| 43J | CEO | R514A | POE | 1 | 0.01-0.05 | NR | NR | NR |
| 43K | CO | R514A | POE | 1 | 0.01-0.05 | NR | NR | NR |
| 43L | Comp | R514A | PVE | 1 | 0.01-0.05 | NR | NR | NR |
| 43M | CEO | R514A | PVE | 1 | 0.01-0.05 | NR | NR | NR |
| 43N | CO | R514A | PVE | 1 | 0.01-0.05 | NR | NR | NR |
| 43O | Comp | R514A | POE | 5A | 0.01-0.1 | NR | NR | NR |
| 43P | CEO | R514A | POE | 5A | 0.01-0.1 | NR | NR | NR |
| 43Q | CO | R514A | POE | 5A | 0.01-0.1 | NR | NR | NR |
| 43R | Comp | R514A | PVE | 5A | 0.01-0.1 | NR | NR | NR |
| 43S | CEO | R514A | PVE | 5A | 0.01-0.1 | NR | NR | NR |
| 43T | CO | R514A | PVE | 5A | 0.01-0.1 | NR | NR | NR |
| 44A | Comp | R515A | YES | 1 | NR | NR | NR | NR |
| 44B | CEO | R515A | YES | 1 | NR | NR | NR | NR |
| 44C | CO | R515A | YES | 1 | NR | NR | NR | NR |
| 44D | Comp | R515A | YES | 1 | 0.01-0.1 | NR | NR | NR |
| 44E | CEO | R515A | YES | 1 | 0.01-0.1 | NR | NR | NR |
| 44F | Comp | R515A | YES | 1 | 0.01-0.05 | NR | NR | NR |
| 44G | CEO | R515A | YES | 1 | 0.01-0.05 | NR | NR | NR |
| 44H | CO | R515A | YES | 1 | 0.01-0.05 | NR | NR | NR |
| 44I | Comp | R515A | POE | 1 | 0.01-0.05 | NR | NR | NR |
| 44J | CEO | R515A | POE | 1 | 0.01-0.05 | NR | NR | NR |
| 44K | CO | R515A | POE | 1 | 0.01-0.05 | NR | NR | NR |
| 44L | Comp | R515A | PVE | 1 | 0.01-0.05 | NR | NR | NR |
| 44M | CEO | R515A | PVE | 1 | 0.01-0.05 | NR | NR | NR |
| 44N | CO | R515A | PVE | 1 | 0.01-0.05 | NR | NR | NR |
| 44O | Comp | R515A | POE | 5A | 0.01-0.1 | NR | NR | NR |
| 44P | CEO | R515A | POE | 5A | 0.01-0.1 | NR | NR | NR |
| 44Q | CO | R515A | POE | 5A | 0.01-0.1 | NR | NR | NR |
| 44R | Comp | R515A | PVE | 5A | 0.01-0.1 | NR | NR | NR |
| 44S | CEO | R515A | PVE | 5A | 0.01-0.1 | NR | NR | NR |
| 44T | CO | R515A | PVE | 5A | 0.01-0.1 | NR | NR | NR |
| 45A | Comp | R515B | YES | 1 | NR | NR | NR | NR |
| 45B | CEO | R515B | YES | 1 | NR | NR | NR | NR |
| 45C | CO | R515B | YES | 1 | NR | NR | NR | NR |
| 45D | Comp | R515B | YES | 1 | 0.01-0.1 | NR | NR | NR |
| 45E | CEO | R515B | YES | 1 | 0.01-0.1 | NR | NR | NR |
| 45F | Comp | R515B | YES | 1 | 0.01-0.05 | NR | NR | NR |
| 45G | CEO | R515B | YES | 1 | 0.01-0.05 | NR | NR | NR |
| 45H | CO | R515B | YES | 1 | 0.01-0.05 | NR | NR | NR |
| 45I | Comp | R515B | POE | 1 | 0.01-0.05 | NR | NR | NR |
| 45J | CEO | R515B | POE | 1 | 0.01-0.05 | NR | NR | NR |
| 45K | CO | R515B | POE | 1 | 0.01-0.05 | NR | NR | NR |
| 45L | Comp | R515B | PVE | 1 | 0.01-0.05 | NR | NR | NR |
| 45M | CEO | R515B | PVE | 1 | 0.01-0.05 | NR | NR | NR |
| 45N | CO | R515B | PVE | 1 | 0.01-0.05 | NR | NR | NR |
| 45O | Comp | R515B | POE | 5A | 0.01-0.1 | NR | NR | NR |
| 45P | CEO | R515B | POE | 5A | 0.01-0.1 | NR | NR | NR |
| 45Q | CO | R515B | POE | 5A | 0.01-0.1 | NR | NR | NR |
| 45R | Comp | R515B | PVE | 5A | 0.01-0.1 | NR | NR | NR |
| 45S | CEO | R515B | PVE | 5A | 0.01-0.1 | NR | NR | NR |
| 45T | CO | R515B | PVE | 5A | 0.01-0.1 | NR | NR | NR |
| 46A | Comp | R516A | YES | 1 | NR | NR | NR | NR |
| 46B | CEO | R516A | YES | 1 | NR | NR | NR | NR |
| 46C | CO | R516A | YES | 1 | NR | NR | NR | NR |
| 46D | Comp | R516A | YES | 1 | 0.01-0.1 | NR | NR | NR |
| 46E | CEO | R516A | YES | 1 | 0.01-0.1 | NR | NR | NR |
| 46F | Comp | R516A | YES | 1 | 0.01-0.05 | NR | NR | NR |
| 46G | CEO | R516A | YES | 1 | 0.01-0.05 | NR | NR | NR |
| 46H | CO | R516A | YES | 1 | 0.01-0.05 | NR | NR | NR |
| 46I | Comp | R516A | POE | 1 | 0.01-0.05 | NR | NR | NR |
| 46J | CEO | R516A | POE | 1 | 0.01-0.05 | NR | NR | NR |
| 46K | CO | R516A | POE | 1 | 0.01-0.05 | NR | NR | NR |
| 46L | Comp | R516A | PVE | 1 | 0.01-0.05 | NR | NR | NR |
| 46M | CEO | R516A | PVE | 1 | 0.01-0.05 | NR | NR | NR |
| 46N | CO | R516A | PVE | 1 | 0.01-0.05 | NR | NR | NR |
| 46O | Comp | R516A | POE | 5A | 0.01-0.1 | NR | NR | NR |
| 46P | CEO | R516A | POE | 5A | 0.01-0.1 | NR | NR | NR |
| 46Q | CO | R516A | POE | 5A | 0.01-0.1 | NR | NR | NR |
| 46R | Comp | R516A | PVE | 5A | 0.01-0.1 | NR | NR | NR |
| 46S | CEO | R516A | PVE | 5A | 0.01-0.1 | NR | NR | NR |
| 46T | CO | R516A | PVE | 5A | 0.01-0.1 | NR | NR | NR |

For the purposes of convenience, each of the heat transfer compositions identified by number designation in the first column of Table 1 above represent a definition of a heat transfer composition, and reference to a heat transfer composition by that number is a reference to a composition having the constituents (and amounts where specified). Also, as mentioned above, reference herein to a defined group, such as “Heat Transfer Compositions 3-46,” or to a composition defined by a number, refers to each composition within that group or composition, including wherein a definition number includes a suffix. For example, reference to “Heat Transfer Composition 3” is intended to include each composition that includes the root 3, for example, HTC3 includes HTC3A in Table 1, HTC3B3 in Table 2, etc.

Preferably, the heat transfer compositions of the present invention, including each of Heat Transfer Compositions 1-46, include refrigerant in an amount of greater than 40% by weight of the heat transfer composition.

Preferably, the heat transfer compositions of the present invention, including each of Heat Transfer 1-46, include refrigerant in an amount of greater than 50% by weight, or greater than 70% by weight, or greater than 80% by weight, or greater than 90%, of the heat transfer composition.

The heat transfer compositions of the invention may include other components for the purpose of enhancing or providing certain functionality to the compositions, preferably without negating the features provided by the use of the present protective agent in accordance with present invention. Such other components or additives may include, stabilizers, dyes, solubilizing agents, compatibilizers, auxiliary stabilizers, antioxidants, corrosion inhibitors, extreme pressure additives and anti-wear additives.

Preferably, the heat transfer compositions of the present invention, including each of Heat Transfer Compositions 1-46, include a stabilizer. Preferably one or more of the following stabilizers are included.

### Stabilizers:

### Alkylated Naphthalenes

Applicants have surprisingly and unexpectedly found that alkylated naphthalenes are highly effective as stabilizers for the heat transfer compositions of the present invention. As used herein, the term “alkylated naphthalene” refers to compounds having the following structure:

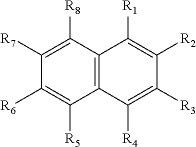

where each R₁-R₈ is independently selected from linear alkyl group, a branched alkyl group and hydrogen. The particular length of the alkyl chains and the mixtures or branched and straight chains and hydrogens can vary within the scope of the present invention, and it will be appreciated and understood by those skilled in the art that such variation is reflects the physical properties of the alkylated naphthalene, including in particular the viscosity of the alkylated compound, and producers of such materials frequently define the materials by reference to one or more of such properties as an alternative the specification of the particular R groups.

Applicants have found unexpected, surprising and advantageous results are associated with the use of alkylated naphthalene as a stabilizer according to the present invention, including each of Heat Transfer Compositions 1-46, having the following properties, and alkylated naphthalene compounds having the indicated properties are referred to for convenience herein as Alkylated Naphthalene 1 (or AN1)—Alkylated Naphthalene 5 (or AN5) as indicated respectively in rows 1-5 in the Table AN-A below:

TABLE AN-A

| Property | AN1 | AN2 | AN3 | AN4 | AN5 |
|---|---|---|---|---|---|
| Viscosity | 20-200 | 20-100 | 20-50 | 30-40 | about 36 |
| @ 40° C. | | | | | |
| (ASTM D445), cSt | | | | | |
| Viscosity | 3-20 | 3-10 | 3-8 | 5-7 | about 5.6 |
| @ 100° C. | | | | | |
| (ASTM D445), cSt | | | | | |
| Pour Point | −50 to −20 | −45 to −25 | −40 to −30 | −45 to −30 | about −33 |
| (ASTM D97), ° C. | | | | | |

As used herein in connection with viscosity at 40° C. measured according to ASTM D445, the term “about” means+/−4 cSt.

As used herein in connection with viscosity at 100° C. measured according to ASTM D445, the term “about” means+/−0.4 cSt.

As used herein in connection with pour point as measured according to ASTM D97, the term “about” means+/−5° C.

Applicants have also found that unexpected, surprising and advantageous results are associated with the use of alkylated naphthalenes as a stabilizer according to the present invention, including each of Heat Transfer Compositions 1-46, having the following properties, and alkylated naphthalene compounds having the indicated properties are referred to for convenience herein as Alkylated Naphthalene 6 (or AN6)—Alkylated Naphthalene 10 (or AN10) as indicated respectively in rows 6-10 in the Table AN-B below:

TABLE AN-B

| Property | AN6 | AN7 | AN 8 | AN 9 | AN10 |
|---|---|---|---|---|---|
| Viscosity | 20-200 | 20-100 | 20-50 | 30-40 | about 36 |
| @ 40° C. | | | | | |
| (ASTM D445), cSt | | | | | |
| Viscosity | 3-20 | 3-10 | 3-8 | 5-7 | about 5.6 |
| @ 100° C. | | | | | |
| (ASTM D445), cSt | | | | | |
| Aniline Point | 40-110 | 50-90 | 50-80 | 60-70 | about 36 |
| (ASTM D611), ° C. | | | | | |
| Noack Volatility | 1-50 | 5-30 | 5-15 | 10-15 | about 12 |
| CEC L40 | | | | | |
| (ASTM D6375), wt. % | | | | | |
| Pour Point | −50 to −20 | −45 to −25 | −40 to −30 | −45 to −30 | about −33 |
| (ASTM D97), ° C. | | | | | |
| Flash Point | 200-300 | 200-270 | 220-250 | 230-240 | about 236 |
| (ASTM D92)), ° C. | | | | | |

Examples of alkylated naphthalenes within the meaning of Alkylated Naphthalene 1 and Alkylated Naphthalene 6 include those sold by King Industries under the trade designations NA-LUBE KR-007A; KR-008; KR-009; KR-015; KR-019; KR-005FG; KR-015FG; and KR-029FG.

Examples of alkylated naphthalenes within the meaning of Alkylated Naphthalene 2 and Alkylated Naphthalene 7 include those sold by King Industries under the trade designations NA-LUBE KR-007A; KR-008; KR-009; and KR-005FG.

An example of an alkylated naphthalene that is within the meaning of Alkylated Naphthalene 5 and Alkylated Naphthalene 10 includes the product sold by King Industries under the trade designation NA-LUBE KR-008.

The present invention included heat transfer compositions, including each of Heat Transfer Compositions 14 and 30-32 hereof, wherein the alkylated naphthalene is AN1, AN2, of AN3, or AN4, or AN5, or AN6, or AN7, or AN8, or AN9 or AN10.

### Acid Depleting Moieties (ADM)

Those skilled in the art will be able to determine, without undo experimentation, a variety of ADMs that are useful in accordance with the present invention, and all such ADMs are within the scope hereof.

### Epoxides

Applicants have found that epoxides, and particularly alkylated epoxides, are effective at producing the enhanced stability discussed herein when used in combination with alkylated naphthalene stabilizers, and while applicants are not necessarily bound by theory it is believed that this synergistic enhancement stems at least in part due to its effective functioning as an ADM in the heat transfer compositions of the present invention.

In preferred embodiments, including each of Heat Transfer Compositions 1-46, the epoxide is selected from the group consisting of epoxides that undergo ring-opening reactions with acids, thereby depleting the system of acid while not otherwise deleteriously affecting the system.

Useful epoxides include aromatic epoxides, alkyl epoxides (including alkyl ether epoxides), and alkenyl epoxides.

Preferred epoxides include epoxides of the following Formula I:

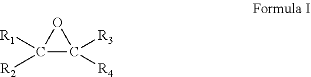

where at least one of said R₁-R₄ is selected from a two to fifteen carbon (C2-C15) acyclic group, a C2-C15 aliphatic group and a C2-C15 ether group. The group of epoxides according to Formula I with R groups as defined in this paragraph is sometimes referred to herein for convenience as ADM1A.

Preferred epoxides also include epoxides of the following Formula I:

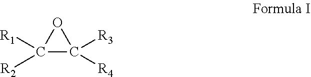

where each of said R₁-R₄ is independently selected from H, a C2-C15 acyclic group, a C2-C15 aliphatic group and C2-C15 ether group, provided that at least one of said R₁-R₄ is H and at least one of said R₁-R₄ is selected from a C2-C15 acyclic group, a C2-C15 aliphatic group and a C2-C15 ether group. The group of epoxides according to Formula I with R groups as defined in this paragraph is sometimes referred to herein for convenience as ADM1B.

Preferred epoxides also include epoxides of the following Formula I:

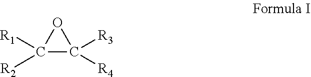

where each of said R₁-R₄ is independently selected from H, a C2-C15 acyclic group, a C2-C15 aliphatic group and a C2-C15 ether group, provided that at least two of said R₁-R₄ are H and at least one of said R₁-R₄ is selected from a C2-C15 acyclic group, a C2-C15 aliphatic group and a C2-C15 ether group. The group of epoxides according to Formula I with R groups as defined in this paragraph is sometimes referred to herein for convenience as ADM1C.

Preferred epoxides also include epoxides of the following Formula I:

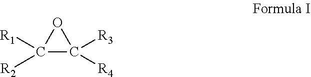

where each of said R₁-R₄ is independently selected from H, a C2-C15 acyclic group, a C2-C15 aliphatic group and a C2-C15 ether group, provided that three of said R₁-R₄ are H and one of said R₁-R₄ is selected from a C2-C15 acyclic group, a C2-C15 aliphatic group and a C2-C15 ether group. The group of epoxides according to Formula I with R groups as defined in this paragraph is sometimes referred to herein for convenience as ADM1 D.

In a preferred embodiment, at least one of R1-R4 of Formula I is an ether having the following structure:

R₅—O—R₆ Formula II

where each of R5 and R6 is independently a C1-C14 straight chain or branched chain, preferably unsubstituted, alkyl group. The group of epoxides according as defined in this paragraph is sometimes referred to herein for convenience as ADM2A.

In a preferred embodiment, at least one of R1-R4 of Formula I is an ether having the following structure:

R₅—O—R₆ Formula II

where
R5 is a C1-C3 alkyl group, preferably unsubstituted; and
R6 is a C3-C10 straight chain or branched chain, preferably unsubstituted, alkyl group.
   The group of epoxides as defined in this paragraph is sometimes referred to herein for convenience as ADM2B.

In a preferred embodiment, one of R1-R4 of Formula I is an ether having the following structure:

R₅—O—R₆ Formula II

where each of R₅ and R₆ is independently a C1-C14 straight chain or branched chain, preferably unsubstituted, alkyl group, and the remaining three of R₁-R₄ are H. The group of epoxides as defined in this paragraph is sometimes referred to herein for convenience as ADM3A.

In a preferred embodiment, one of R1-R4 of Formula I is an ether having the following structure:

R₅—O—R₆ Formula II

where
R₅ is connected to said epoxide group and is a C1-C3 straight chain or branched, unsubstituted alkyl group; and
R₆ is a C3-C10 straight chain or branched chain unsubstituted, alkyl group, and the remaining three of R₁-R₄ are H. The group of epoxides as defined in this paragraph is sometimes referred to herein for convenience as ADM3B.

In a preferred embodiment, one of R1-R4 of Formula I is an ether having the following structure:

R₅—O—R₆ Formula II

where
R₅ is connected to said epoxide group and is a C1 unsubstituted alkyl; and
R₆ is a C8 branched chain, unsubstituted alkyl group, and the remaining three of R₁-R₄ are H. The group of epoxides as defined in this paragraph is sometimes referred to herein for convenience as ADM3C.

In preferred embodiments the epoxide comprises, consists essentially of or consists of 2-ethylhexyl glycidyl ether, which is an ADM3C compound having the following structure:

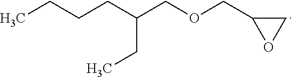

An epoxide according to this paragraph is sometimes referred to herein for convenience as ADM4.

In a preferred embodiment, one of R1-R4 of Formula I is an ether having the following structure:

R₅—O—R₆ Formula II

where each of R₅ and R₆ is independently a C1-C14 straight chain or branched chain, substituted or unsubstituted, alkyl group, and the remaining three of R₁-R₄ are H. The group of epoxides as defined in this paragraph is sometimes referred to herein for convenience as ADM5A.

In a preferred embodiment, one of R1-R4 of Formula I is an ether having the following structure:

R₅—O—R₆ Formula II

where
R₅ is connected to said epoxide group and is a C1-C3 straight chain or branched chain, unsubstituted alkyl group; and
R₆ is a C3-C10 straight chain or branched chain, substituted alkyl group, and the remaining three of R₁-R₄ are H. The group of epoxides as defined in this paragraph is sometimes referred to herein for convenience as ADM5B.

In a preferred embodiment, one of R1-R4 of Formula I is an ether having the following structure:

R₅—O—R₆ Formula II

where
R₅ is connected to said epoxide group and is a C1 unsubstituted alkyl; and
R₆ is a C8 branched chain, substituted alkyl group, and the remaining three of R₁-R4 are H. The group of epoxides according to Formula I with R groups as defined in this paragraph is sometimes referred to herein for convenience as ADM5C.

In a preferred embodiment, one of R1-R4 of Formula I is an ether having the following structure:

R₅—O—R₆ Formula II

where
R₅ is connected to said epoxide group and is a C1 unsubstituted alkyl; and
R₆ is a C8 branched chain, oxygen-substituted alkyl group, and the remaining three of R₁-R₄ are H. The group of epoxides according to Formula I with R groups as defined in this paragraph is sometimes referred to herein for convenience as ADM5D.

In preferred embodiments the epoxide comprises, consists essentially of or consists of glycidyl neodecanoate, which is an ADM5C compound in which the substituent on R6 is O and which has the following structure:

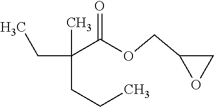

An epoxide according to this paragraph is sometimes referred to herein for convenience as ADM6.

The present invention includes heat transfer compositions, including each of Heat Transfer Compositions 1 and 30-32, wherein the alkylated naphthalene is AN1 or AN2 or AN3 or AN4 or AN5 or AN6 or AN7 or AN8 or AN9 or AN10 and further comprising any one or more of ADM1-ADM6.

In the heat transfer compositions of the present invention, including each of Heat Transfer Compositions 1 and 30-32, the ADM is preferably present in an amount of about 0.05% to about 2.5%, preferably 0.05% to about 1.5%, or preferably 0.05-0.5% by weight, all based on the weight of the lubricant plus the ADM.

In the heat transfer compositions of the present invention, including each of Heat Transfer Compositions 1 and 30-32, the alkylated naphthalene is preferably present in an amount of from 0.01% to about 10%, or from about 1.5% to about 4.5%, or from about 2.5% to about 3.5%, where amounts are in percent by weight based on the amount of alkylated naphthalene plus refrigerant in the system. The amounts specified in this paragraph are especially preferred when an ADM is also present.

In the heat transfer compositions of the present invention, including each of Heat Transfer Compositions 1 and 30-32, the alkylated naphthalene is preferably present in an amount of from 0.1% to about 20%, or from 1.5% to about 10%, or from 1.5% to about 8%, where amounts are in percent by weight based on the amount of alkylated naphthalene plus lubricant in the system. The amounts specified in this paragraph are especially preferred when an ADM is also present.

### Carbodiimides

The ADM can include carbodiimides. In preferred embodiments the carbodiimides include compounds having the following structure:

R¹—N═C═N—R²

### Other Stabilizers

It is contemplated that stabilizers other than the alkylated naphthalenes and ADM may be included in the heat transfer compositions of the present invention, including each of Heat Transfer Compositions 1-46. Examples of such other stabilizers are described hereinafter.

### Phenol-Based Compounds

In preferred embodiments, the stabilizer further includes a phenol-based compound.

The phenol-based compound can be one or more compounds selected from 4,4′-methylenebis(2,6-di-tert-butylphenol); 4,4′-bis(2,6-di-tert-butylphenol); 2,2- or 4,4-biphenyldiols, including 4,4′-bis(2-methyl-6-tert-butylphenol); derivatives of 2,2- or 4,4-biphenyldiols; 2,2′-methylenebis(4-ethyl-6-tertbutylphenol); 2,2′-methylenebis(4-methyl-6-tert-butylphenol); 4,4-butylidenebis(3-methyl-6-tert-butylphenol); 4,4-isopropylidenebis(2,6-di-tert-butylphenol); 2,2′-methylenebis(4-methyl-6-nonylphenol); 2,2′-isobutylidenebis(4,6-dimethylphenol); 2,2′-methylenebis(4-methyl-6-cyclohexylphenol); 2,6-di-tert-butyl-4-methylphenol (BHT); 2,6-di-tert-butyl-4-ethylphenol: 2,4-dimethyl-6-tert-butylphenol; 2,6-di-tert-alpha-dimethylamino-p-cresol; 2,6-di-tert-butyl-4(N,N′-dimethylaminomethylphenol); 4,4′-thiobis(2-methyl-6-tert-butylphenol); 4,4′-thiobis(3-methyl-6-tert-butylphenol); 2,2′-thiobis(4-methyl-6-tert-butylphenol); bis(3-methyl-4-hydroxy-5-tert-butylbenzyl) sulfide; bis(3,5-di-tert-butyl-4-hydroxybenzyl)sulfide, tocopherol, hydroquinone, 2,2′6,6′-tetra-tert-butyl-4,4′-methylenediphenol and t-butyl hydroquinone, and preferably BHT.

The phenol compounds, and in particular BHT, can be provided in the heat transfer composition in an amount of greater than 0 and preferably from 0.0001% by weight to about 5% by weight, preferably 0.001% by weight to about 2.5% by weight, and more preferably from 0.01% to about 1% by weight. In each case, percentage by weight refers to the weight of the heat transfer composition.

The phenol compounds, and in particular BHT, can be provided in the heat transfer composition in an amount of greater than 0 and preferably from 0.0001% by weight to about 5% by weight, preferably 0.001% by weight to about 2.5% by weight, and more preferably from 0.01% to about 1% by weight. In each case, percentage by weight refers to the weight based on the weight of the lubricant in the heat transfer composition.

The present invention also includes stabilizer comprising from about 40% to about 95% by weight of alkylated naphthalenes, including each of AN1-AN10, and from 0.1 to about 10% by weight of BHT, based on the weight of the all the stabilizer components in the composition.

The present invention also includes stabilizer comprising from about 40% to about 95% by weight of alkylated naphthalenes, including each of AN1-AN10, from 5% to about 30% by weight of ADM, including each of ADM1-ADM6, and from 0.1 to about 10% by weight of BHT, based on the weight of the all the stabilizer components in the composition.

### Diene-Based Compounds

The diene-based compounds include C3 to C15 dienes and compounds formed by reaction of any two or more C3 to C4 dienes. Preferably, the diene-based compounds are selected from the group consisting of allyl ethers, propadiene, butadiene, isoprene, and terpenes. The diene-based compounds are preferably terpenes, which include but are not limited to terebene, retinal, geraniol, terpinene, delta-3 carene, terpinolene, phellandrene, fenchene, myrcene, farnesene, pinene, nerol, citral, camphor, menthol, limonene, nerolidol, phytol, carnosic acid, and vitamin A1. Preferably, the stabilizer is farnesene. Preferred terpene stabilizers are disclosed in U.S. Provisional Patent Application No. 60/638,003 filed on Dec. 12, 2004, published as US 2006/0167044A1, which is incorporated herein by reference.

In addition, the diene-based compounds can be provided in the heat transfer composition in an amount greater than 0 and preferably from 0.0001% by weight to about 5% by weight, preferably 0.001% by weight to about 2.5% by weight, and more preferably from 0.01% to about 1% by weight. In each case, percentage by weight refers to the weight of the heat transfer composition.

### Phosphorus-Based Compounds

The phosphorus compound can be a phosphite or a phosphate compound. For the purposes of this invention, the phosphite compound can be a diaryl, dialkyl, triaryl and/or trialkyl phosphite, and/or a mixed aryl/alkyl di- or tri-substituted phosphite, in particular one or more compounds selected from hindered phosphites, tris-(di-tert-butylphenyl)phosphite, di-n-octyl phophite, iso-octyl diphenyl phosphite, iso-decyl diphenyl phosphite, tri-iso-decyl phosphate, triphenyl phosphite and diphenyl phosphite, particularly diphenyl phosphite.

The phosphate compounds can be a triaryl phosphate, trialkyl phosphate, alkyl mono acid phosphate, aryl diacid phosphate, amine phosphate, preferably triaryl phosphate and/or a trialkyl phosphate, particularly tri-n-butyl phosphate.

The present invention includes heat transfer compositions, including each of Heat Transfer Compositions 1-46, wherein the composition further comprises a phosphate.

The present invention includes heat transfer compositions, including each of Heat Transfer Compositions 1-46, wherein the composition further comprises a triaryl phosphate.

The present invention includes heat transfer compositions, including each of Heat Transfer Compositions 1-46, wherein the composition further comprises a trialkyl phosphate.

The phosphorus compounds can be provided in the heat transfer composition of the present invention, including each of Heat Transfer Compositions 1-46, in an amount of greater than 0 and preferably from 0.0001% by weight to about 5% by weight, preferably 0.001% by weight to about 2.5% by weight, and more preferably from 0.01% to about 1% by weight. In each case, by weight refers to weight of the heat transfer composition.

The phosphorus compounds can be provided in the heat transfer composition of the present invention, including each of Heat Transfer Compositions 1-46, in an amount of greater than 0 and preferably from 0.0002% by weight to about 10% by weight, preferably 0.002% by weight to about 5% by weight, and more preferably from 0.02% to about 2% by weight. In each case, by weight in this paragraph refers to weight of the lubricant and the phosphate stabilizer.

### Nitrogen Compounds

When the stabilizer is a nitrogen compound, the stabilizer may comprise an amine-based compound such as one or more secondary or tertiary amines selected from diphenylamine, p-phenylenediamine, triethylamine, tributylamine, diisopropylamine, triisopropylamine and triisobutylamine. The amine based compound can be an amine antioxidant such as a substituted piperidine compound, i.e. a derivative of an alkyl substituted piperidyl, piperidinyl, piperazinone, or alkyoxypiperidinyl, particularly one or more amine antioxidants selected from 2,2,6,6-tetramethyl-4-piperidone, 2,2,6,6-tetramethyl-4-piperidinol; bis-(1,2,2,6,6-pentamethylpiperidyl)sebacate; di(2,2,6,6-tetramethyl-4-piperidyl)sebacate, poly(N-hydroxyethyl-2,2,6,6-tetramethyl-4-hydroxy-piperidyl succinate; alkylated paraphenylenediamines such as N-phenyl-N′-(1,3-dimethyl-butyl)-p-phenylenediamine or N,N′-di-sec-butyl-p-phenylenediamine and hydroxylamines such as tallow amines, methyl bis tallow amine and bis tallow amine, or phenol-alpha-napththylamine or Tinuvin®765 (Ciba), BLS® 1944 (Mayzo Inc) and BLS @1770 (Mayzo Inc). For the purposes of this invention, the amine-based compound also can be an alkyldiphenyl amine such as bis (nonylphenyl amine), dialkylamine such as (N-(1-methylethyl)-2-propylamine, or one or more of phenyl-alpha-naphthyl amine (PANA), alkyl-phenyl-alpha-naphthyl-amine (APANA), and bis (nonylphenyl) amine. Preferably the amine-based compound is one or more of phenyl-alpha-naphthyl amine (PANA), alkyl-phenyl-alpha-naphthyl-amine (APANA) and bis (nonylphenyl) amine, and more preferably phenyl-alpha-naphthyl amine (PANA).

Alternatively, or in addition to the nitrogen compounds identified above, one or more compounds selected from dinitrobenzene, nitrobenzene, nitromethane, nitrosobenzene, and TEMPO [(2,2,6,6-tetramethylpiperidin-1-yl)oxyl]may be used as the stabilizer.

The nitrogen compounds can be provided in the heat transfer composition in an amount of greater than 0 and from 0.0001% by weight to about 5% by weight, preferably 0.001% by weight to about 2.5% by weight, and more preferably from 0.01% to about 1% by weight. In each case, percentage by weight refers to the weight of the heat transfer composition.

### Isobutylene

Isobutylene may also be used as a stabilizer according to the present invention.

### Lubricants

The heat transfer compositions of the present invention, including each of Heat Transfer Compositions 1-46, preferably comprises a POE lubricant and/or a PVE lubricant wherein the lubricant is preferably present in amounts preferably of from about 0.1% by weight to about 5%, or from 0.1% by weight to about 1% by weight, or from 0.1% by weight to about 0.5% by weight, based on the weight of the heat transfer composition.

### POE Lubricants

The POE lubricant of the present invention includes in preferred embodiments a neopentyl POE lubricant. As used herein, the term neopentyl POE lubricant refers to polyol esters (POEs) derived from a reaction between a neopentyl polyol (preferably pentaerythritol, trimethylolpropane, or neopentyl glycol, and in embodiments where higher viscosities are preferred, dipentaerythritol) and a linear or branched carboxylic acid.

Commercially available POEs include neopentyl glycol dipelargonate which is available as Emery 2917 (registered trademark) and Hatcol 2370 (registered trademark) and pentaerythritol derivatives including those sold under the trade designations Emkarate RL32-3MAF and Emkarate RL68H by CPI Fluid Engineering. Emkarate RL32-3MAF and Emkarate RL68H are preferred neopently POE lubricants having the properties identified below:

| Property | RL32-3MAF | RL68H |
|---|---|---|
| Viscosity | about 31 | about 67 |
| @ 40° C. (ASTM D445), cSt | | |
| Viscosity | about 5.6 | about 9.4 |
| @ 100° C. | | |
| (ASTM D445), cSt | | |
| Pour Point | about −40 | about −40 |
| (ASTM D97), ° C. | | |

Other useful esters include phosphate esters, di-basic acid esters and fluoro esters.

### PVE Lubricants

The lubricant of the present invention can include PVE lubricants generally. In preferred embodiments the PVE lubricant is as PVE according to Formula II below:

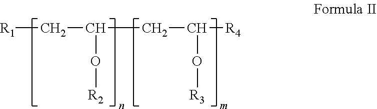

where R₂ and R₃ are each independently C1-C10 hydrocarbons, preferably C2-C8 hydrocarbons, and R₁ and R₄ are each independently alkyl, alkylene glycol, or polyoxyalkylene glycol units and n and m are selected preferably according to the needs of those skilled in the art to obtain a lubricant with the desired properties, and preferable n and m are selected to obtain a lubricant with a viscosity at 40° C. measured in accordance with ASTM D445 of from about 30 to about 70 cSt. Commercially available polyvinyl ethers include those lubricants sold under the trade designations FVC32D and FVC68D, from Idemitsu.

### Methods, Uses and Systems

The heat transfer compositions disclosed herein are provided for use and find advantage and produce unexpected results in essentially all heat transfer applications, uses, methods and systems, and all such applications, uses, methods and systems are included in the broad scope of the present invention. In preferred embodiments, the heat transfer compositions disclosed herein, including each of Heat Transfer Compositions 1-46 are provided for use, and find advantage and produce unexpected results in refrigeration applications, stationary air conditioning applications, mobile and transport air conditioning applications, and stationary and mobile heat pumps. Particularly preferred embodiments are disclosed in the following Table 2, in which the following abbreviations are used and have the following meanings: “ComRef” means commercial refrigeration; “ComAC” means commercial air conditioning; “ResAC” means residential air conditioning; “Stat. Heat Pump” means stationary heat pump; “Mobile Heat Pump” means a heat pump used in mobile applications, such as cars, trucks, buses and the like; “Mobile AC” means air conditioning used in mobile applications, such as cars, trucks, buses and the like; “IndRef” means industrial refrigeration; and “TransRef” means transport refrigeration.

The heat transfer compositions column of the Table 2 use HTC numbers according to the definitions contained in Table 1 above.

TABLE 2

| | USES/SYSTEMS/METHODS | | | | | | | | |
|---|---|---|---|---|---|---|---|---|---|
| | | | | | Stat. | Mobile | | | |
| HTC | | | Res | | Heat | Heat | Mobile | | |
| No. | ComRef | ComAC | AC | Chiller | Pump | Pump | AC | IndRef | TransRef |
| 3A | x | x | x | x | x | — | — | x | x |
| 3B | x | x | x | x | x | — | — | x | x |
| 3C | x | x | x | x | x | — | — | x | x |
| 3D | x | x | x | x | x | — | — | x | x |
| 3E | x | x | x | x | x | — | — | x | x |
| 3F | x | x | x | x | x | — | — | x | x |
| 3G | x | x | x | x | x | — | — | x | x |
| 3H | x | x | x | x | x | — | — | x | x |
| 3I | x | x | x | x | x | — | — | x | x |
| 3J | x | x | x | x | x | — | — | x | x |
| 3K | x | x | x | x | x | — | — | x | x |
| 3L | x | x | x | x | x | — | — | x | x |
| 3M | x | x | x | x | x | — | — | x | x |
| 3N | x | x | x | x | x | — | — | x | x |
| 3O | x | x | x | x | x | — | — | x | x |
| 3P | x | x | x | x | x | — | — | x | x |
| 3Q | x | x | x | x | x | — | — | x | x |
| 3R | x | x | x | x | x | — | — | x | x |
| 3S | x | x | x | x | x | — | — | x | x |
| 3T | x | x | x | x | x | — | — | x | x |
| 3U | x | x | x | x | x | — | — | x | x |
| 3V | x | x | x | x | x | — | — | x | x |
| 3W | x | x | x | x | x | — | — | x | x |
| 3X | x | x | x | x | x | — | — | x | x |
| 3Y | x | x | x | x | x | — | — | x | x |
| 3Z | x | x | x | x | x | — | — | x | x |
| 4A | x | — | — | — | x | x | x | x | x |
| 4B | x | — | — | — | x | x | x | x | x |
| 4C | x | — | — | — | x | x | x | x | x |
| 4D | x | — | — | — | x | x | x | x | x |
| 4E | x | — | — | — | x | x | x | x | x |
| 4F | x | — | — | — | x | x | x | x | x |
| 4G | x | — | — | — | x | x | x | x | x |
| 4H | x | — | — | — | x | x | x | x | x |
| 4I | x | — | — | — | x | x | x | x | x |
| 4J | x | — | — | — | x | x | x | x | x |
| 4K | x | — | — | — | x | x | x | x | x |
| 4L | x | — | — | — | x | x | x | x | x |
| 4M | x | — | — | — | x | x | x | x | x |
| 4N | x | — | — | — | x | x | x | x | x |
| 4O | x | — | — | — | x | x | x | x | x |
| 4P | x | — | — | — | x | x | x | x | x |
| 4Q | x | — | — | — | x | x | x | x | x |
| 4R | x | — | — | — | x | x | x | x | x |
| 4S | x | — | — | — | x | x | x | x | x |
| 4T | x | — | — | — | x | x | x | x | x |
| 5A | — | — | — | X | X | — | — | — | — |
| 5B | — | — | — | X | X | — | — | — | — |
| 5C | — | — | — | X | X | — | — | — | — |
| 5D | — | — | — | X | X | — | — | — | — |
| 5E | — | — | — | X | X | — | — | — | — |
| 5F | — | — | — | X | X | — | — | — | — |
| 5G | — | — | — | X | X | — | — | — | — |
| 5H | — | — | — | X | X | — | — | — | — |
| 5I | — | — | — | X | X | — | — | — | — |
| 5J | — | — | — | X | X | — | — | — | — |
| 5K | — | — | — | X | X | — | — | — | — |
| 5L | — | — | — | X | X | — | — | — | — |
| 5M | — | — | — | X | X | — | — | — | — |
| 5N | — | — | — | X | X | — | — | — | — |
| 5O | — | — | — | X | X | — | — | — | — |
| 5P | — | — | — | X | X | — | — | — | — |
| 5Q | — | — | — | X | X | — | — | — | — |
| 5R | — | — | — | X | X | — | — | — | — |
| 5S | — | — | — | X | X | — | — | — | — |
| 5T | — | — | — | X | X | — | — | — | — |
| 6A | — | — | — | X | X | — | — | — | — |
| 6B | — | — | — | X | X | — | — | — | — |
| 6C | — | — | — | X | X | — | — | — | — |
| 6D | — | — | — | X | X | — | — | — | — |
| 6E | — | — | — | X | X | — | — | — | — |
| 6F | — | — | — | X | X | — | — | — | — |
| 6G | — | — | — | X | X | — | — | — | — |
| 6H | — | — | — | X | X | — | — | — | — |
| 6I | — | — | — | X | X | — | — | — | — |
| 6J | — | — | — | X | X | — | — | — | — |
| 6K | — | — | — | X | X | — | — | — | — |
| 6L | — | — | — | X | X | — | — | — | — |
| 6M | — | — | — | X | X | — | — | — | — |
| 6N | — | — | — | X | X | — | — | — | — |
| 6O | — | — | — | X | X | — | — | — | — |
| 6P | — | — | — | X | X | — | — | — | — |
| 6Q | — | — | — | X | X | — | — | — | — |
| 6R | — | — | — | X | X | — | — | — | — |
| 6S | — | — | — | X | X | — | — | — | — |
| 6T | — | — | — | X | X | — | — | — | — |
| 7A | — | — | — | — | X | — | — | — | — |
| 7B | — | — | — | — | X | — | — | — | — |
| 7C | — | — | — | — | X | — | — | — | — |
| 7D | — | — | — | — | X | — | — | — | — |
| 7E | — | — | — | — | X | — | — | — | — |
| 7F | — | — | — | — | X | — | — | — | — |
| 7G | — | — | — | — | X | — | — | — | — |
| 7H | — | — | — | — | X | — | — | — | — |
| 7I | — | — | — | — | X | — | — | — | — |
| 7J | — | — | — | — | X | — | — | — | — |
| 7K | — | — | — | — | X | — | — | — | — |
| 7L | — | — | — | — | X | — | — | — | — |
| 7M | — | — | — | — | X | — | — | — | — |
| 7N | — | — | — | — | X | — | — | — | — |
| 7O | — | — | — | — | X | — | — | — | — |
| 7P | — | — | — | — | X | — | — | — | — |
| 7Q | — | — | — | — | X | — | — | — | — |
| 7R | — | — | — | — | X | — | — | — | — |
| 7S | — | — | — | — | X | — | — | — | — |
| 7T | — | — | — | — | X | — | — | — | — |
| 15A | X | — | — | — | — | — | — | X | X |
| 15B | X | — | — | — | — | — | — | X | X |
| 15C | X | — | — | — | — | — | — | X | X |
| 15D | X | — | — | — | — | — | — | X | X |
| 15E | X | — | — | — | — | — | — | X | X |
| 15F | X | — | — | — | — | — | — | X | X |
| 15G | X | — | — | — | — | — | — | X | X |
| 15H | X | — | — | — | — | — | — | X | X |
| 15I | X | — | — | — | — | — | — | X | X |
| 15J | X | — | — | — | — | — | — | X | X |
| 15K | X | — | — | — | — | — | — | X | X |
| 15L | X | — | — | — | — | — | — | X | X |
| 15M | X | — | — | — | — | — | — | X | X |
| 15N | X | — | — | — | — | — | — | X | X |
| 15O | X | — | — | — | — | — | — | X | X |
| 15P | X | — | — | — | — | — | — | X | X |
| 15Q | X | — | — | — | — | — | — | X | X |
| 15R | X | — | — | — | — | — | — | X | X |
| 15S | X | — | — | — | — | — | — | X | X |
| 15T | X | — | — | — | — | — | — | X | X |
| 15U | X | — | — | — | — | — | — | X | X |
| 15V | X | — | — | — | — | — | — | X | X |
| 15W | X | — | — | — | — | — | — | X | X |
| 15X | X | — | — | — | — | — | — | X | X |
| 15Y | X | — | — | — | — | — | — | X | X |
| 15Z | X | — | — | — | — | — | — | X | X |
| 16A | X | — | — | — | — | — | — | X | X |
| 16B | X | — | — | — | — | — | — | X | X |
| 16C | X | — | — | — | — | — | — | X | X |
| 16D | X | — | — | — | — | — | — | X | X |
| 16E | X | — | — | — | — | — | — | X | X |
| 16F | X | — | — | — | — | — | — | X | X |
| 16G | X | — | — | — | — | — | — | X | X |
| 16H | X | — | — | — | — | — | — | X | X |
| 16I | X | — | — | — | — | — | — | X | X |
| 16J | X | — | — | — | — | — | — | X | X |
| 16K | X | — | — | — | — | — | — | X | X |
| 16L | X | — | — | — | — | — | — | X | X |
| 16M | X | — | — | — | — | — | — | X | X |
| 16N | X | — | — | — | — | — | — | X | X |
| 16O | X | — | — | — | — | — | — | X | X |
| 16P | X | — | — | — | — | — | — | X | X |
| 16Q | X | — | — | — | — | — | — | X | X |
| 16R | X | — | — | — | — | — | — | X | X |
| 16S | X | — | — | — | — | — | — | X | X |
| 16T | X | — | — | — | — | — | — | X | X |
| 16U | X | — | — | — | — | — | — | X | X |
| 16V | X | — | — | — | — | — | — | X | X |
| 16W | X | — | — | — | — | — | — | X | X |
| 16X | X | — | — | — | — | — | — | X | X |
| 16Y | X | — | — | — | — | — | — | X | X |
| 16Z | X | — | — | — | — | — | — | X | X |
| 17A | X | — | — | — | — | — | — | X | X |
| 17B | X | — | — | — | — | — | — | X | X |
| 17C | X | — | — | — | — | — | — | X | X |
| 17D | X | — | — | — | — | — | — | X | X |
| 17E | X | — | — | — | — | — | — | X | X |
| 17F | X | — | — | — | — | — | — | X | X |
| 17G | X | — | — | — | — | — | — | X | X |
| 17H | X | — | — | — | — | — | — | X | X |
| 17I | X | — | — | — | — | — | — | X | X |
| 17J | X | — | — | — | — | — | — | X | X |
| 17K | X | — | — | — | — | — | — | X | X |
| 17L | X | — | — | — | — | — | — | X | X |
| 17M | X | — | — | — | — | — | — | X | X |
| 17N | X | — | — | — | — | — | — | X | X |
| 17O | X | — | — | — | — | — | — | X | X |
| 17P | X | — | — | — | — | — | — | X | X |
| 17Q | X | — | — | — | — | — | — | X | X |
| 17R | X | — | — | — | — | — | — | X | X |
| 17S | X | — | — | — | — | — | — | X | X |
| 17T | X | — | — | — | — | — | — | X | X |
| 20A | x | — | — | x | x | — | — | — | — |
| 20B | x | — | — | x | x | — | — | — | — |
| 20C | x | — | — | x | x | — | — | — | — |
| 20D | x | — | — | x | x | — | — | — | — |
| 20E | x | — | — | x | x | — | — | — | — |
| 20F | x | — | — | x | x | — | — | — | — |
| 20G | x | — | — | x | x | — | — | — | — |
| 20H | x | — | — | x | x | — | — | — | — |
| 20I | x | — | — | x | x | — | — | — | — |
| 20J | x | — | — | x | x | — | — | — | — |
| 20K | x | — | — | x | x | — | — | — | — |
| 20L | x | — | — | x | x | — | — | — | — |
| 20M | x | — | — | x | x | — | — | — | — |
| 20N | x | — | — | x | x | — | — | — | — |
| 20O | x | — | — | x | x | — | — | — | — |
| 20P | x | — | — | x | x | — | — | — | — |
| 20Q | x | — | — | x | x | — | — | — | — |
| 20R | x | — | — | x | x | — | — | — | — |
| 20S | x | — | — | x | x | — | — | — | — |
| 20T | x | — | — | x | x | — | — | — | — |
| 21A | — | — | — | — | — | — | — | X | X |
| 21B | — | — | — | — | — | — | — | X | X |
| 21C | — | — | — | — | — | — | — | X | X |
| 21D | — | — | — | — | — | — | — | X | X |
| 21E | — | — | — | — | — | — | — | X | X |
| 21F | — | — | — | — | — | — | — | X | X |
| 21G | — | — | — | — | — | — | — | X | X |
| 21H | — | — | — | — | — | — | — | X | X |
| 21I | — | — | — | — | — | — | — | X | X |
| 21J | — | — | — | — | — | — | — | X | X |
| 21K | — | — | — | — | — | — | — | X | X |
| 21L | — | — | — | — | — | — | — | X | X |
| 21M | — | — | — | — | — | — | — | X | X |
| 21N | — | — | — | — | — | — | — | X | X |
| 21O | — | — | — | — | — | — | — | X | X |
| 21P | — | — | — | — | — | — | — | X | X |
| 21Q | — | — | — | — | — | — | — | X | X |
| 21R | — | — | — | — | — | — | — | X | X |
| 21S | — | — | — | — | — | — | — | X | X |
| 21T | — | — | — | — | — | — | — | X | X |
| 23A | X | x | x | x | x | — | — | x | x |
| 23B | X | x | x | x | x | — | — | x | x |
| 23C | X | x | x | x | x | — | — | x | x |
| 23D | X | x | x | x | x | — | — | x | x |
| 23E | X | x | x | x | x | — | — | x | x |
| 23F | X | x | x | x | x | — | — | x | x |
| 23G | X | x | x | x | x | — | — | x | x |
| 23H | X | x | x | x | x | — | — | x | x |
| 23I | X | x | x | x | x | — | — | x | x |
| 23J | X | x | x | x | x | — | — | x | x |
| 23K | X | x | x | x | x | — | — | x | x |
| 23L | X | x | x | x | x | — | — | x | x |
| 23M | X | x | x | x | x | — | — | x | x |
| 23N | X | x | x | x | x | — | — | x | x |
| 23O | X | x | x | x | x | — | — | x | x |
| 23P | X | x | x | x | x | — | — | x | x |
| 23Q | X | x | x | x | x | — | — | x | x |
| 23R | X | x | x | x | x | — | — | x | x |
| 23S | X | x | x | x | x | — | — | x | x |
| 23T | X | x | x | x | x | — | — | x | x |
| 24A | — | x | x | x | x | — | — | — | — |
| 24B | — | x | x | x | x | — | — | — | — |
| 24C | — | x | x | x | x | — | — | — | — |
| 24D | — | x | x | x | x | — | — | — | — |
| 24E | — | x | x | x | x | — | — | — | — |
| 24F | — | x | x | x | x | — | — | — | — |
| 24G | — | x | x | x | x | — | — | — | — |
| 24H | — | x | x | x | x | — | — | — | — |
| 24I | — | x | x | x | x | — | — | — | — |
| 24J | — | x | x | x | x | — | — | — | — |
| 24K | — | x | x | x | x | — | — | — | — |
| 24L | — | x | x | x | x | — | — | — | — |
| 24M | — | x | x | x | x | — | — | — | — |
| 24N | — | x | x | x | x | — | — | — | — |
| 24O | — | x | x | x | x | — | — | — | — |
| 24P | — | x | x | x | x | — | — | — | — |
| 24Q | — | x | x | x | x | — | — | — | — |
| 24R | — | x | x | x | x | — | — | — | — |
| 24S | — | x | x | x | x | — | — | — | — |
| 24T | — | x | x | x | x | — | — | — | — |
| 25A | X | x | x | x | x | x | x | x | x |
| 25B | X | x | x | x | x | x | x | x | x |
| 25C | X | x | x | x | x | x | x | x | x |
| 25D | X | x | x | x | x | x | x | x | x |
| 25E | X | x | x | x | x | x | x | x | x |
| 25F | X | x | x | x | x | x | x | x | x |
| 25G | X | x | x | x | x | x | x | x | x |
| 25H | X | x | x | x | x | x | x | x | x |
| 25I | X | x | x | x | x | x | x | x | x |
| 25J | X | x | x | x | x | x | x | x | x |
| 25K | X | x | x | x | x | x | x | x | x |
| 25L | X | x | x | x | x | x | x | x | x |
| 25M | X | x | x | x | x | x | x | x | x |
| 25N | X | x | x | x | x | x | x | x | x |
| 25O | X | x | x | x | x | x | x | x | x |
| 25P | X | x | x | x | x | x | x | x | x |
| 25Q | X | x | x | x | x | x | x | x | x |
| 25R | X | x | x | x | x | x | x | x | x |
| 25S | X | x | x | x | x | x | x | x | x |
| 25T | X | x | x | x | x | x | x | x | x |
| 26A | X | — | — | x | x | — | — | x | x |
| 26B | X | — | — | x | x | — | — | x | x |
| 26C | X | — | — | x | x | — | — | x | x |
| 26D | X | — | — | x | x | — | — | x | x |
| 26E | X | — | — | x | x | — | — | x | x |
| 26F | X | — | — | x | x | — | — | x | x |
| 26G | X | — | — | x | x | — | — | x | x |
| 26H | X | — | — | x | x | — | — | x | x |
| 26I | X | — | — | x | x | — | — | x | x |
| 26J | X | — | — | x | x | — | — | x | x |
| 26K | X | — | — | x | x | — | — | x | x |
| 26L | X | — | — | x | x | — | — | x | x |
| 26M | X | — | — | x | x | — | — | x | x |
| 26N | X | — | — | x | x | — | — | x | x |
| 26O | X | — | — | x | x | — | — | x | x |
| 26P | X | — | — | x | x | — | — | x | x |
| 26Q | X | — | — | x | x | — | — | x | x |
| 26R | X | — | — | x | x | — | — | x | x |
| 26S | X | — | — | x | x | — | — | x | x |
| 26T | X | — | — | x | x | — | — | x | x |
| 27A | — | — | — | — | — | — | x | — | — |
| 27B | — | — | — | — | — | — | x | — | — |
| 27C | — | — | — | — | — | — | x | — | — |
| 27D | — | — | — | — | — | — | x | — | — |
| 27E | — | — | — | — | — | — | x | — | — |
| 27F | — | — | — | — | — | — | x | — | — |
| 27G | — | — | — | — | — | — | x | — | — |
| 27H | — | — | — | — | — | — | x | — | — |
| 27I | — | — | — | — | — | — | x | — | — |
| 27J | — | — | — | — | — | — | x | — | — |
| 27K | — | — | — | — | — | — | x | — | — |
| 27L | — | — | — | — | — | — | x | — | — |
| 27M | — | — | — | — | — | — | x | — | — |
| 27N | — | — | — | — | — | — | x | — | — |
| 27O | — | — | — | — | — | — | x | — | — |
| 27P | — | — | — | — | — | — | x | — | — |
| 27Q | — | — | — | — | — | — | x | — | — |
| 27R | — | — | — | — | — | — | x | — | — |
| 27S | — | — | — | — | — | — | x | — | — |
| 27T | — | — | — | — | — | — | x | — | — |
| 27U | — | — | — | — | — | — | x | — | — |
| 27V | — | — | — | — | — | — | x | — | — |
| 27W | — | — | — | — | — | — | x | — | — |
| 27X | — | — | — | — | — | — | x | — | — |
| 27Y | — | — | — | — | — | — | x | — | — |
| 27Z | — | — | — | — | — | — | x | — | — |
| 30A | — | x | x | x | x | — | — | — | — |
| 30B | — | x | x | x | x | — | — | — | — |
| 30C | — | x | x | x | x | — | — | — | — |
| 30D | — | x | x | x | x | — | — | — | — |
| 30E | — | x | x | x | x | — | — | — | — |
| 30F | — | x | x | x | x | — | — | — | — |
| 30G | — | x | x | x | x | — | — | — | — |
| 30H | — | x | x | x | x | — | — | — | — |
| 30I | — | x | x | x | x | — | — | — | — |
| 30J | — | x | x | x | x | — | — | — | — |
| 30K | — | x | x | x | x | — | — | — | — |
| 30L | — | x | x | x | x | — | — | — | — |
| 30M | — | x | x | x | x | — | — | — | — |
| 30N | — | x | x | x | x | — | — | — | — |
| 30O | — | x | x | x | x | — | — | — | — |
| 30P | — | x | x | x | x | — | — | — | — |
| 30Q | — | x | x | x | x | — | — | — | — |
| 30R | — | x | x | x | x | — | — | — | — |
| 30S | — | x | x | x | x | — | — | — | — |
| 30T | — | x | x | x | x | — | — | — | — |
| | — | x | x | x | x | — | — | — | — |
| 31A | — | x | x | x | x | — | — | — | — |
| 31B | — | x | x | x | x | — | — | — | — |
| 31C | — | x | x | x | x | — | — | — | — |
| 31D | — | x | x | x | x | — | — | — | — |
| 31E | — | x | x | x | x | — | — | — | — |
| 31F | — | x | x | x | x | — | — | — | — |
| 31G | — | x | x | x | x | — | — | — | — |
| 31H | — | x | x | x | x | — | — | — | — |
| 31I | — | x | x | x | x | — | — | — | — |
| 31J | — | x | x | x | x | — | — | — | — |
| 31K | — | x | x | x | x | — | — | — | — |
| 31L | — | x | x | x | x | — | — | — | — |
| 31M | — | x | x | x | x | — | — | — | — |
| 31N | — | x | x | x | x | — | — | — | — |
| 31O | — | x | x | x | x | — | — | — | — |
| 31P | — | x | x | x | x | — | — | — | — |
| 31Q | — | x | x | x | x | — | — | — | — |
| 31R | — | x | x | x | x | — | — | — | — |
| 31S | — | x | x | x | x | — | — | — | — |
| 31T | — | x | x | x | x | — | — | — | — |
| 31U | — | x | x | x | x | — | — | — | — |
| 31V | — | x | x | x | x | — | — | — | — |
| 31W | — | x | x | x | x | — | — | — | — |
| 31X | — | x | x | x | x | — | — | — | — |
| 31Y | — | x | x | x | x | — | — | — | — |
| 31Z | — | x | x | x | x | — | — | — | — |
| 32A | — | x | x | x | x | — | — | — | — |
| 32B | — | x | x | x | x | — | — | — | — |
| 32C | — | x | x | x | x | — | — | — | — |
| 32D | — | x | x | x | x | — | — | — | — |
| 32E | — | x | x | x | x | — | — | — | — |
| 32F | — | x | x | x | x | — | — | — | — |
| 32G | — | x | x | x | x | — | — | — | — |
| 32H | — | x | x | x | x | — | — | — | — |
| 32I | — | x | x | x | x | — | — | — | — |
| 32J | — | x | x | x | x | — | — | — | — |
| 32K | — | x | x | x | x | — | — | — | — |
| 32L | — | x | x | x | x | — | — | — | — |
| 32M | — | x | x | x | x | — | — | — | — |
| 32N | — | x | x | x | x | — | — | — | — |
| 32O | — | x | x | x | x | — | — | — | — |
| 32P | — | x | x | x | x | — | — | — | — |
| 32Q | — | x | x | x | x | — | — | — | — |
| 32R | — | x | x | x | x | — | — | — | — |
| 32S | — | x | x | x | x | — | — | — | — |
| 32T | — | x | x | x | x | — | — | — | — |
| 32U | — | x | x | x | x | — | — | — | — |
| 32V | — | x | x | x | x | — | — | — | — |
| 32W | — | x | x | x | x | — | — | — | — |
| 32X | — | x | x | x | x | — | — | — | — |
| 32Y | — | x | x | x | x | — | — | — | — |
| 32Z | — | x | x | x | x | — | — | — | — |
| 33A | x | x | x | x | x | — | — | x | x |
| 33B | x | x | x | x | x | — | — | x | x |
| 33C | x | x | x | x | x | — | — | x | x |
| 33D | x | x | x | x | x | — | — | x | x |
| 33E | x | x | x | x | x | — | — | x | x |
| 33F | x | x | x | x | x | — | — | x | x |
| 33G | x | x | x | x | x | — | — | x | x |
| 33H | x | x | x | x | x | — | — | x | x |
| 33I | x | x | x | x | x | — | — | x | x |
| 33J | x | x | x | x | x | — | — | x | x |
| 33K | x | x | x | x | x | — | — | x | x |
| 33L | x | x | x | x | x | — | — | x | x |
| 33M | x | x | x | x | x | — | — | x | x |
| 33N | x | x | x | x | x | — | — | x | x |
| 33O | x | x | x | x | x | — | — | x | x |
| 33P | x | x | x | x | x | — | — | x | x |
| 33Q | x | x | x | x | x | — | — | x | x |
| 33R | x | x | x | x | x | — | — | x | x |
| 33S | x | x | x | x | x | — | — | x | x |
| 33T | x | x | x | x | x | — | — | x | x |
| 34A | x | x | x | x | x | — | — | x | x |
| 34B | x | x | x | x | x | — | — | x | x |
| 34C | x | x | x | x | x | — | — | x | x |
| 34D | x | x | x | x | x | — | — | x | x |
| 34E | x | x | x | x | x | — | — | x | x |
| 34F | x | x | x | x | x | — | — | x | x |
| 34G | x | x | x | x | x | — | — | x | x |
| 34H | x | x | x | x | x | — | — | x | x |
| 34I | x | x | x | x | x | — | — | x | x |
| 34J | x | x | x | x | x | — | — | x | x |
| 34K | x | x | x | x | x | — | — | x | x |
| 34L | x | x | x | x | x | — | — | x | x |
| 34M | x | x | x | x | x | — | — | x | x |
| 34N | x | x | x | x | x | — | — | x | x |
| 34O | x | x | x | x | x | — | — | x | x |
| 34P | x | x | x | x | x | — | — | x | x |
| 34Q | x | x | x | x | x | — | — | x | x |
| 34R | x | x | x | x | x | — | — | x | x |
| 34S | x | x | x | x | x | — | — | x | x |
| 34T | x | x | x | x | x | — | — | x | x |
| 35A | x | x | x | — | x | — | — | x | x |
| 35B | x | x | x | — | x | — | — | x | x |
| 35C | x | x | x | — | x | — | — | x | x |
| 35D | x | x | x | — | x | — | — | x | x |
| 35E | x | x | x | — | x | — | — | x | x |
| 35F | x | x | x | — | x | — | — | x | x |
| 35G | x | x | x | — | x | — | — | x | x |
| 35H | x | x | x | — | x | — | — | x | x |
| 35I | x | x | x | — | x | — | — | x | x |
| 35J | x | x | x | — | x | — | — | x | x |
| 35K | x | x | x | — | x | — | — | x | x |
| 35L | x | x | x | — | x | — | — | x | x |
| 35M | x | x | x | — | x | — | — | x | x |
| 35N | x | x | x | — | x | — | — | x | x |
| 35O | x | x | x | — | x | — | — | x | x |
| 35P | x | x | x | — | x | — | — | x | x |
| 35Q | x | x | x | — | x | — | — | x | x |
| 35R | x | x | x | — | x | — | — | x | x |
| 35S | x | x | x | — | x | — | — | x | x |
| 35T | x | x | x | — | x | — | — | x | x |
| 36A | x | x | x | x | x | x | x | x | x |
| 36B | x | x | x | x | x | x | x | x | x |
| 36C | x | x | x | x | x | x | x | x | x |
| 36D | x | x | x | x | x | x | x | x | x |
| 36E | x | x | x | x | x | x | x | x | x |
| 36F | x | x | x | x | x | x | x | x | x |
| 36G | x | x | x | x | x | x | x | x | x |
| 36H | x | x | x | x | x | x | x | x | x |
| 36I | x | x | x | x | x | x | x | x | x |
| 36J | x | x | x | x | x | x | x | x | x |
| 36K | x | x | x | x | x | x | x | x | x |
| 36L | x | x | x | x | x | x | x | x | x |
| 36M | x | x | x | x | x | x | x | x | x |
| 36N | x | x | x | x | x | x | x | x | x |
| 36O | x | x | x | x | x | x | x | x | x |
| 36P | x | x | x | x | x | x | x | x | x |
| 36Q | x | x | x | x | x | x | x | x | x |
| 36R | x | x | x | x | x | x | x | x | x |
| 36S | x | x | x | x | x | x | x | x | x |
| 36T | x | x | x | x | x | x | x | x | x |
| 37A | x | x | x | x | x | — | — | x | x |
| 37B | x | x | x | x | x | — | — | x | x |
| 37C | x | x | x | x | x | — | — | x | x |
| 37D | x | x | x | x | x | — | — | x | x |
| 37E | x | x | x | x | x | — | — | x | x |
| 37F | x | x | x | x | x | — | — | x | x |
| 37G | x | x | x | x | x | — | — | x | x |
| 37H | x | x | x | x | x | — | — | x | x |
| 37I | x | x | x | x | x | — | — | x | x |
| 37J | x | x | x | x | x | — | — | x | x |
| 37K | x | x | x | x | x | — | — | x | x |
| 37L | x | x | x | x | x | — | — | x | x |
| 37M | x | x | x | x | x | — | — | x | x |
| 37N | x | x | x | x | x | — | — | x | x |
| 37O | x | x | x | x | x | — | — | x | x |
| 37P | x | x | x | x | x | — | — | x | x |
| 37Q | x | x | x | x | x | — | — | x | x |
| 37R | x | x | x | x | x | — | — | x | x |
| 37S | x | x | x | x | x | — | — | x | x |
| 37T | x | x | x | x | x | — | — | x | x |
| 38A | x | x | x | — | x | — | — | x | x |
| 38B | x | x | x | — | x | — | — | x | x |
| 38C | x | x | x | — | x | — | — | x | x |
| 38D | x | x | x | — | x | — | — | x | x |
| 38E | x | x | x | — | x | — | — | x | x |
| 38F | x | x | x | — | x | — | — | x | x |
| 38G | x | x | x | — | x | — | — | x | x |
| 38H | x | x | x | — | x | — | — | x | x |
| 38I | x | x | x | — | x | — | — | x | x |
| 38J | x | x | x | — | x | — | — | x | x |
| 38K | x | x | x | — | x | — | — | x | x |
| 38L | x | x | x | — | x | — | — | x | x |
| 38M | x | x | x | — | x | — | — | x | x |
| 38N | x | x | x | — | x | — | — | x | x |
| 38O | x | x | x | — | x | — | — | x | x |
| 38P | x | x | x | — | x | — | — | x | x |
| 38Q | x | x | x | — | x | — | — | x | x |
| 38R | x | x | x | — | x | — | — | x | x |
| 38S | x | x | x | — | x | — | — | x | x |
| 38T | x | x | x | — | x | — | — | x | x |
| 39A | x | x | x | x | x | x | x | x | x |
| 39B | x | x | x | x | x | x | x | x | x |
| 39C | x | x | x | x | x | x | x | x | x |
| 39D | x | x | x | x | x | x | x | x | x |
| 39E | x | x | x | x | x | x | x | x | x |
| 39F | x | x | x | x | x | x | x | x | x |
| 39G | x | x | x | x | x | x | x | x | x |
| 39H | x | x | x | x | x | x | x | x | x |
| 39I | x | x | x | x | x | x | x | x | x |
| 39J | x | x | x | x | x | x | x | x | x |
| 39K | x | x | x | x | x | x | x | x | x |
| 39L | x | x | x | x | x | x | x | x | x |
| 39M | x | x | x | x | x | x | x | x | x |
| 39N | x | x | x | x | x | x | x | x | x |
| 39O | x | x | x | x | x | x | x | x | x |
| 39P | x | x | x | x | x | x | x | x | x |
| 39Q | x | x | x | x | x | x | x | x | x |
| 39R | x | x | x | x | x | x | x | x | x |
| 39S | x | x | x | x | x | x | x | x | x |
| 39T | x | x | x | x | x | x | x | x | x |
| 40A | x | x | x | — | x | — | — | x | x |
| 40B | x | x | x | — | x | — | — | x | x |
| 40C | x | x | x | — | x | — | — | x | x |
| 40D | x | x | x | — | x | — | — | x | x |
| 40E | x | x | x | — | x | — | — | x | x |
| 40F | x | x | x | — | x | — | — | x | x |
| 40G | x | x | x | — | x | — | — | x | x |
| 40H | x | x | x | — | x | — | — | x | x |
| 40I | x | x | x | — | x | — | — | x | x |
| 40J | x | x | x | — | x | — | — | x | x |
| 40K | x | x | x | — | x | — | — | x | x |
| 40L | x | x | x | — | x | — | — | x | x |
| 40M | x | x | x | — | x | — | — | x | x |
| 40N | x | x | x | — | x | — | — | x | x |
| 40O | x | x | x | — | x | — | — | x | x |
| 40P | x | x | x | — | x | — | — | x | x |
| 40Q | x | x | x | — | x | — | — | x | x |
| 40R | x | x | x | — | x | — | — | x | x |
| 40S | x | x | x | — | x | — | — | x | x |
| 40T | x | x | x | — | x | — | — | x | x |
| 41A | x | — | — | x | x | — | — | x | x |
| 41B | x | — | — | x | x | — | — | x | x |
| 41C | x | — | — | x | x | — | — | x | x |
| 41D | x | — | — | x | x | — | — | x | x |
| 41E | x | — | — | x | x | — | — | x | x |
| 41F | x | — | — | x | x | — | — | x | x |
| 41G | x | — | — | x | x | — | — | x | x |
| 41H | x | — | — | x | x | — | — | x | x |
| 41I | x | — | — | x | x | — | — | x | x |
| 41J | x | — | — | x | x | — | — | x | x |
| 41K | x | — | — | x | x | — | — | x | x |
| 41L | x | — | — | x | x | — | — | x | x |
| 41M | x | — | — | x | x | — | — | x | x |
| 41N | x | — | — | x | x | — | — | x | x |
| 41O | x | — | — | x | x | — | — | x | x |
| 41P | x | — | — | x | x | — | — | x | x |
| 41Q | x | — | — | x | x | — | — | x | x |
| 41R | x | — | — | x | x | — | — | x | x |
| 41S | x | — | — | x | x | — | — | x | x |
| 41T | x | — | — | x | x | — | — | x | x |
| 45A | x | x | x | x | x | — | — | x | x |
| 45B | x | x | x | x | x | — | — | x | x |
| 45C | x | x | x | x | x | — | — | x | x |
| 45D | x | x | x | x | x | — | — | x | x |
| 45E | x | x | x | x | x | — | — | x | x |
| 45F | x | x | x | x | x | — | — | x | x |
| 45G | x | x | x | x | x | — | — | x | x |
| 45H | x | x | x | x | x | — | — | x | x |
| 45I | x | x | x | x | x | — | — | x | x |
| 45J | x | x | x | x | x | — | — | x | x |
| 45K | x | x | x | x | x | — | — | x | x |
| 45L | x | x | x | x | x | — | — | x | x |
| 45M | x | x | x | x | x | — | — | x | x |
| 45N | x | x | x | x | x | — | — | x | x |
| 45O | x | x | x | x | x | — | — | x | x |
| 45P | x | x | x | x | x | — | — | x | x |
| 45Q | x | x | x | x | x | — | — | x | x |
| 45R | x | x | x | x | x | — | — | x | x |
| 45S | x | x | x | x | x | — | — | x | x |
| 45T | x | x | x | x | x | — | — | x | x |

For heat transfer systems, uses and methods of the present invention that include a compressor and lubricant for the compressor in the system, including each of those identified in Table 2 above, the system can comprises a loading of refrigerant and lubricant such that the lubricant loading in the system is from about 5% to 60% by weight, or from about 10% to about 60% by weight, or from about 20% to about 50% by weight, or from about 20% to about 40% by weight, or from about 20% to about 30% by weight, or from about 30% to about 50% by weight, or from about 30% to about 40% by weight. As used herein, the term “lubricant loading” refers to the total weight of lubricant contained in the system as a percentage of total of lubricant and refrigerant contained in the system. Such systems may also include a lubricant loading of from about 5% to about 10% by weight, or about 8% by weight of the heat transfer composition.

The heat transfer systems uses and methods of the present invention that include a compressor and lubricant for the compressor in the system, including each of those identified in Table 2 above, can comprise a compressor, an evaporator, a condenser and an expansion device, in fluid communication with each other, a Heat Transfer Compositions 1-46, and a sequestration material in the system, wherein said sequestration material preferably comprises: i. copper or a copper alloy, or ii. activated alumina, or iii. a zeolite molecular sieve comprising copper, silver, lead or a combination thereof, or iv. an anion exchange resin, or v. a moisture-removing material, preferably a moisture-removing molecular sieve, or vi. a combination of two or more of the above.

The present invention also includes methods for transferring heat of the type comprising evaporating refrigerant liquid to produce a refrigerant vapor, compressing in a compressor at least a portion of the refrigerant vapor and condensing refrigerant vapor in a plurality of repeating cycles, said method comprising:
(a) providing a heat transfer composition according to the present invention, including each of Heat Transfer Compositions 1-46;
(b) optionally but preferably providing lubricant for said compressor; and
(b) exposing at least a portion of said refrigerant and/or at least a portion of said lubricant to a sequestration material.

In preferred embodiments, residential air conditioning systems and methods, including those identified in Table 2 above, have refrigerant evaporating temperatures in the range of from about 0° C. to about 10° C. and the condensing temperature is in the range of about 40° C. to about 70° C.

In preferred embodiments, residential air conditioning systems and methods used in a heating mode, including those identified in Table 2 above, have refrigerant evaporating temperatures in the range of from about −20° C. to about 3° C. and the condensing temperature is in the range of about 35° C. to about 50° C.

In preferred embodiments, commercial air conditioning systems and methods including those identified in Table 2 above, have refrigerant evaporating temperatures in the range of from about 0° C. to about 10° C. and the condensing temperature is in the range of about 40° C. to about 70° C.

In preferred embodiments, hydronic system systems and methods, including those identified in Table 2 above, have refrigerant evaporating temperatures in the range of from about −20° C. to about 3° C. and the condensing temperature is in the range of about 50° C. to about 90° C.

In preferred embodiments, medium temperature systems and methods, including those identified in Table 2 above, have refrigerant evaporating temperatures in the range of from about −12° C. to about 0° C. and the condensing temperature is in the range of about 40° C. to about 70° C.

In preferred embodiments, low temperature systems and methods, including those identified in Table 2 above, have refrigerant evaporating temperatures in the range of from about −40° C. to about −12° C. and the condensing temperature is in the range of about 40° C. to about 70° C.

In preferred embodiments, rooftop air conditioning systems and methods, including those identified in Table 2 above, have refrigerant evaporating temperatures in the range of from about 0° C. to about 10° C. and the condensing temperature is in the range of about 40° C. to about 70° C.

In preferred embodiments, VRF systems and methods, including those identified in Table 2 above, have refrigerant evaporating temperatures in the range of from about 0° C. to about 10° C. and the condensing temperature is in the range of about 40° C. to about 70° C.

Examples of commonly used compressors, for the purposes of this invention, including for each of the uses, systems and methods identified in Table 2, include reciprocating, rotary (including rolling piston and rotary vane), scroll, screw, and centrifugal compressors. Thus, the present invention provides each and any of the refrigerants and/or heat transfer compositions as described herein for use in a heat transfer system comprising a reciprocating, rotary (including rolling piston and rotary vane), scroll, screw, or centrifugal compressor.

Examples of commonly used expansion devices, for the purposes of this invention, including for each of the uses, systems and methods identified in Table 2, include a capillary tube, a fixed orifice, a thermal expansion valve and an electronic expansion valve. Thus, the present invention provides each and any of the heat transfer compositions as described herein, including Heat Transfer Compositions 1-46, for use in a heat transfer system comprising a capillary tube, a fixed orifice, a thermal expansion valve or an electronic expansion valve.

For the purposes of this invention, including for each of the uses, systems and methods identified in Table 2, the evaporator and the condenser can each be in the form of a heat exchanger, preferably selected from a finned tube heat exchanger, a microchannel heat exchanger, a shell and tube, a plate heat exchanger, and a tube-in-tube heat exchanger. Thus, the present invention, including for each of the uses, systems and methods identified in Table 2, provides each and any of the heat transfer compositions as described herein for use in a heat transfer system wherein the evaporator and condenser together form a finned tube heat exchanger, a microchannel heat exchanger, a shell and tube, a plate heat exchanger, or a tube-in-tube heat exchanger.

The systems, uses and methods of the present invention, including for each of the uses, systems and methods identified in Table 2, thus preferably include a sequestration material in contact with at least a portion of a refrigerant and/or at least a portion of a the lubricant according to the present invention wherein the temperature of said sequestration material and/or the temperature of said refrigerant and/or the temperature of said lubricant when in said contact are at a temperature that is preferably at least about 10C wherein the sequestration material preferably comprises a combination of: an anion exchange resin, activated alumina, a zeolite molecular sieve comprising silver, and a moisture-removing material, preferably a moisture-removing molecular sieve.

As used in this application, the term “in contact with at least a portion” is intended in its broad sense to include each of said sequestration materials and any combination of sequestration materials being in contact with the same or separate portions of the refrigerant and/or the lubricant in the system and is intended to include but not necessarily limited to embodiments in which each type or specific sequestration material is: (i) located physically together with each other type or specific material, if present; (ii) is located physically separate from each other type or specific material, if present, and (iii) combinations in which two or more materials are physically together and at least one sequestration material is physically separate from at least one other sequestration material.

The heat transfer composition of the invention can be used in heating and cooling applications.

In a particular feature of the invention, the heat transfer composition can be used in a method of cooling comprising condensing a heat transfer composition and subsequently evaporating said composition in the vicinity of an article or body to be cooled.

Thus, the invention relates to a method of cooling in a heat transfer system comprising an evaporator, a condenser and a compressor, the process comprising i) condensing a heat transfer composition as described herein; and
ii) evaporating the composition in the vicinity of body or article to be cooled;
wherein the evaporator temperature of the heat transfer system is in the range of from about −400C to about +10° C.

Alternatively, or in addition, the heat transfer composition can be used in a method of heating comprising condensing the heat transfer composition in the vicinity of an article or body to be heated and subsequently evaporating said composition.

Thus, the invention relates to a method of heating in a heat transfer system comprising an evaporator, a condenser and a compressor, the process comprising
i) condensing a heat transfer composition as described herein, in the vicinity of a body or article to be heated and
ii) evaporating the composition; wherein the evaporator temperature of the heat transfer system is in the range of about −30° C. to about 5° C.

The heat transfer composition of the invention is provided for use in air conditioning applications including both transport and stationary air conditioning applications. Thus, any of the heat transfer compositions described herein can be used in any one of:
an air conditioning application including mobile air conditioning, particularly in trains and buses conditioning,
a mobile heat pump, particularly an electric vehicle heat pump;
a chiller, particularly a positive displacement chiller, more particularly an air cooled or water-cooled direct expansion chiller, which is either modular or conventionally singularly packaged,
a residential air conditioning system, particularly a ducted split or a ductless split air conditioning system,
a residential heat pump,
a residential air to water heat pump/hydronic system,
an industrial air conditioning system,
a commercial air conditioning system, particularly a packaged rooftop unit and a variable refrigerant flow (VRF) system and
a commercial air source, water source or ground source heat pump system.

The heat transfer composition of the invention is provided for use in a refrigeration system. The term “refrigeration system” refers to any system or apparatus or any part or portion of such a system or apparatus which employs a refrigerant to provide cooling. Thus, any of the heat transfer compositions described herein can be used in any one of:
a low temperature refrigeration system,
a medium temperature refrigeration system,
a commercial refrigerator,
a commercial freezer,
an ice machine,
a vending machine,
a transport refrigeration system,
a domestic freezer,
a domestic refrigerator,
an industrial freezer,
an industrial refrigerator and
a chiller.

Each of the heat transfer compositions described herein, including Heat Transfer Compositions 1-46, is particularly provided for use in a residential air-conditioning system (with an evaporator temperature in the range of about 0 to about 10° C., particularly about 7° C. for cooling and/or in the range of about −20 to about 3° C., particularly about 0.5° C. for heating).

Alternatively, or additionally, each of the heat transfer compositions described herein, including each of Heat Transfer Compositions 1-101, is particularly provided for use in a residential air conditioning system with a reciprocating, rotary (rolling-piston or rotary vane) or scroll compressor.

Each of the heat transfer compositions described, including Heat Transfer Compositions 1-46, is particularly provided for use in an air-cooled chiller (with an evaporator temperature in the range of about 0 to about 10° C., particularly about 4.5° C.), particularly an air-cooled chiller with a positive displacement compressor, more particular an air-cooled chiller with a reciprocating scroll compressor.

Each of the heat transfer compositions described herein, including Heat Transfer Compositions 1-46, is particularly provided for use in a residential air to water heat pump hydronic system (with an evaporator temperature in the range of about −20 to about 3° C., particularly about 0.5° C. or with an evaporator temperature in the range of about −30 to about 5° C., particularly about 0.5° C.).

Each of the heat transfer compositions described herein, including Heat Transfer Compositions 1-46, is particularly provided for use in a medium temperature refrigeration system (with an evaporator temperature in the range of about −12 to about 0° C., particularly about −8° C.).

Each of the heat transfer compositions described herein, including Heat Transfer Compositions 1-46, is particularly provided for use in a low temperature refrigeration system (with an evaporator temperature in the range of about −40 to about −12° C., particularly about from about −40° C. to about −23° C. or preferably about −32° C.).

The heat transfer composition of the invention, including Heat Transfer Compositions 1-46, is provided for use in a residential air conditioning system, wherein the residential air-conditioning system is used to supply cool air (said air having a temperature of for example, about 10° C. to about 17° C., particularly about 12° C.) to buildings for example, in the summer.

The heat transfer composition of the invention, including Heat Transfer Compositions 1-46, is thus provided for use in a split residential air conditioning system, wherein the residential air-conditioning system is used to supply cool air (said air having a temperature of for example, about 10° C. to about 17° C., particularly about 12° C.).

The heat transfer composition of the invention, including Heat Transfer Compositions 1-46, is thus provided for use in a ducted split residential air conditioning system, wherein the residential air-conditioning system is used to supply cool air (said air having a temperature of for example, about 10° C. to about 17° C., particularly about 12° C.).

The heat transfer composition of the invention, including Heat Transfer Compositions 1-46, is thus provided for use in a window residential air conditioning system, wherein the residential air-conditioning system is used to supply cool air (said air having a temperature of for example, about 10° C. to about 17° C., particularly about 12° C.).

The heat transfer composition of the invention, including Heat Transfer Compositions 1-46, is thus provided for use in a portable residential air conditioning system, wherein the residential air-conditioning system is used to supply cool air (said air having a temperature of for example, about 10° C. to about 17° C., particularly about 12° C.).

The residential air conditions systems as described herein, including in the immediately preceding paragraphs, preferably have an air-to-refrigerant evaporator (indoor coil), a compressor, an air-to-refrigerant condenser (outdoor coil), and an expansion valve. The evaporator and condenser can be round tube plate fin, a finned tube or microchannel heat exchanger. The compressor can be a reciprocating or rotary (rolling-piston or rotary vane) or scroll compressor. The expansion valve can be a capillary tube, thermal or electronic expansion valve. The refrigerant evaporating temperature is preferably in the range of 0° C. to 10° C. The condensing temperature is preferably in the range of 40° C. to 70° C.

The heat transfer composition of the invention, including Heat Transfer Compositions 1-46, is provided for use in a residential heat pump system, wherein the residential heat pump system is used to supply warm air (said air having a temperature of for example, about 18° C. to about 24° C., particularly about 21° C.) to buildings in the winter. It can be the same system as the residential air-conditioning system, while in the heat pump mode the refrigerant flow is reversed, and the indoor coil becomes condenser, and the outdoor coil becomes evaporator. Typical system types are split and mini-split heat pump system. The evaporator and condenser are usually a round tube plate fin, a finned or microchannel heat exchanger. The compressor is usually a reciprocating or rotary (rolling-piston or rotary vane) or scroll compressor. The expansion valve is usually a thermal or electronic expansion valve. The refrigerant evaporating temperature is preferably in the range of about −20 to about 3° C. or about −30° C. to about 5° C. The condensing temperature is preferably in the range of about 35° C. to about 50° C.

The heat transfer composition of the invention, including Heat Transfer Compositions 1-46, is provided for use in a commercial air-conditioning system wherein the commercial air conditioning system can be a chiller which is used to supply chilled water (said water having a temperature of for example about 7° C.) to large buildings such as offices and hospitals, etc.

Depending on the application, the chiller system may be running all year long. The chiller system may be air-cooled or water-cooled. The air-cooled chiller usually has a plate, tube-in-tube or shell-and-tube evaporator to supply chilled water, a reciprocating or scroll compressor, a round tube plate fin, a finned tube or microchannel condenser to exchange heat with ambient air, and a thermal or electronic expansion valve. The water-cooled system usually has a shell-and-tube evaporator to supply chilled water, a reciprocating, scroll, screw or centrifugal compressor, a shell-and-tube condenser to exchange heat with water from cooling tower or lake, sea and other natural recourses, and a thermal or electronic expansion valve. The refrigerant evaporating temperature is preferably in the range of about 0° C. to about 10° C. The condensing temperature is preferably in the range of about 40° C. to about 70° C.

The heat transfer composition of the invention, including Heat Transfer Compositions 1-46, is provided for use in a residential air-to-water heat pump hydronic system, wherein the residential air-to-water heat pump hydronic system is used to supply hot water (said water having a temperature of for example about 50° C. or about 55° C.) to buildings for floor heating or similar applications in the winter. The hydronic system usually has a round tube plate fin, a finned tube or microchannel evaporator to exchange heat with ambient air, a reciprocating, scroll or rotary compressor, a plate, tube-in-tube or shell-in-tube condenser to heat the water, and a thermal or electronic expansion valve. The refrigerant evaporating temperature is preferably in the range of about −20° C. to about 3° C., or −30° C. to about 5° C. The condensing temperature is preferably in the range of about 50° C. to about 90° C.

The heat transfer composition of the invention, including Heat Transfer Compositions 1-46, is provided for use in a medium temperature refrigeration system, wherein the refrigerant has and evaporating temperature preferably in the range of about −12° C. to about 0° C., and in such systems the refrigerant has a condensing temperature preferably in the range of about 40° C. to about 70° C., or about 20° C. to about 70° C.

The present invention thus provides a medium temperature refrigeration system used to chill food or beverages, such as in a refrigerator or a bottle cooler, wherein the refrigerant has an evaporating temperature preferably in the range of about −12° C. to about 0° C., and in such systems the refrigerant has a condensing temperature preferably in the range of about 40° C. to about 70° C., or about 20° C. to about 70° C.

The medium temperature systems of the present invention, including the systems as described in the immediately preceding paragraphs, preferably have an air-to-refrigerant evaporator to provide chilling, for example to the food or beverage contained therein, a reciprocating, scroll or screw or rotary compressor, an air-to-refrigerant condenser to exchange heat with the ambient air, and a thermal or electronic expansion valve. The heat transfer composition of the invention, including Heat Transfer Compositions 1-46, is provided for use in a low temperature refrigeration system, wherein the refrigerant has an evaporating temperature that is preferably in the range of about −40° C. to about −12° C. and the refrigerant has a condensing temperature that is preferably in the range of about 40° C. to about 70° C., or about 20° C. to about 70° C.

The present invention thus provides a low temperature refrigeration system used to provide cooling in a freezer wherein the refrigerant has an evaporating temperature that is preferably in the range of about −40° C. to about −12° C. and the refrigerant has a condensing temperature that is preferably in the range of about 40° C. to about 70° C., or about 20 to about 70° C.

The present invention thus also provides a low temperature refrigeration system used to provide cooling in a cream machine refrigerant has an evaporating temperature that is preferably in the range of about −40° C. to about −12° C. and the refrigerant has a condensing temperature that is preferably in the range of about 40° C. to about 70° C., or about 20° C. to about 70° C.

The low temperature systems of the present invention, including the systems as described in the immediately preceding paragraphs, preferably have an air-to-refrigerant evaporator to chill the food or beverage, a reciprocating, scroll or rotary compressor, an air-to-refrigerant condenser to exchange heat with the ambient air, and a thermal or electronic expansion valve.

For the purposes of this invention, each heat transfer composition in accordance with the present invention, including each of Heat Transfer Compositions 1-46, is provided for use in a chiller with an evaporating temperature in the range of about 0° C. to about 10° C. and a condensing temperature in the range of about 40° C. to about 70° C. The chiller is provided for use in air conditioning or refrigeration, and preferably for commercial air conditioning. The chiller is preferably a positive displacement chiller, more particularly an air cooled or water-cooled direct expansion chiller, which is either modular or conventionally singularly packaged.

The present invention therefore provides the use of each heat transfer composition in accordance with the present invention, including each of Heat Transfer Compositions 1-46, in stationary air conditioning, particularly residential air conditioning, industrial air conditioning or commercial air conditioning.

The heat transfer system can be a refrigeration system, such as a low temperature refrigeration system, a medium temperature refrigeration system, a commercial refrigerator, a commercial freezer, an ice machine, a vending machine, a transport refrigeration system, a domestic freezer, a domestic refrigerator, an industrial freezer, an industrial refrigerator and a chiller.

### EXAMPLES

### Comparative Examples 1A-1C—Heat Transfer Compositions Comprising CF31-Containing Refrigerant, POE Lubricant and Stabilizers

A heat transfer composition is tested in accordance with ASHRAE Standard 97—“Sealed Glass Tube Method to Test the Chemical Stability of Materials for Use within Refrigerant Systems” to simulate long-term stability of the heat transfer compositions by accelerated aging. The testing is conducted with three different coupon combinations: Cu/Al/Fr; Cu/Al/Fe/Brass; Cu/Al/Fe/Zn. The tested refrigerant consists of 49% by weight R-32, 11.5% by weight of R-125 and 39.5% by weight of CF31 (R-466A). The POE lubricant was an 160SZ POE sold by Danfos having a viscosity at 40° C. of about 30-34 cSt and having a moisture content of 150 ppm or less. The stabilizer package comprises, in the amounts indicated in Table ExC1A below, NA-LUBE KR-008 (AN5), tricresyl phosphate (“TCP”) and 2-ethylhexyl glycidyl ether (ADM4).

TABLE EXC1A

| Fluid Composition Component | Concentration, wt % |
|---|---|
| R466A | 47.25 |
| 160SZ POE | 47.25 |
| KR-008 | 2 |
| TCP | 2 |
| ADM4 | 1.5 |
| TOTAL | 100 |

After testing, the fluid in each test tube was observed for clarity, total acid number (TAN) was determined, and the amount of various materials in the fluid were identified. The TAN value is considered to reflect the stability of the lubricant in the fluid under conditions of use in the heat transfer composition. The presence of trifluoromethane (R-23) is considered to reflect refrigerant stability since this compound is believed to be a product of the breakdown of CF31.

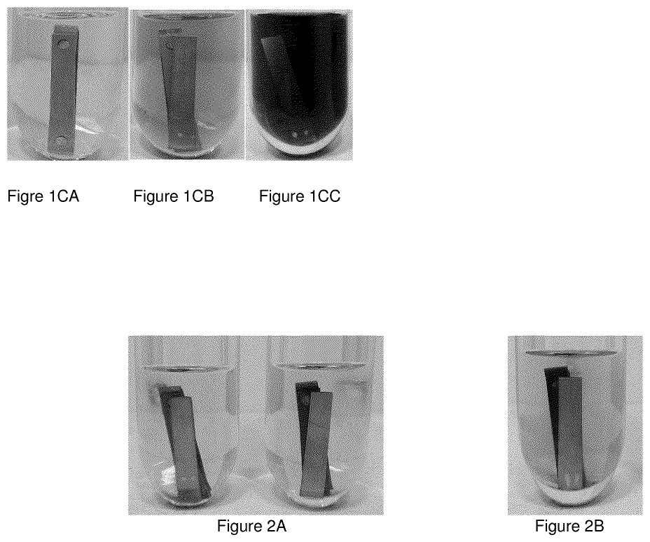

The stability of the fluid was tested by placing the sealed tube with the indicated coupons in an oven maintained at about 150° C. for 14 days. The results after the 14 day period were as indicated below in Table ExC1B and as illustrated in FIGS. 1CA, 1 CB and 1CC:

TABLE EXC2

| | ExC1A | ExC1B | ExC1C |
|---|---|---|---|
| Coupons | Cu/Al/Fe | Cu/Al/Fe + Brass | Cu/Al/Fe + Zn |
| Fluoride (ppm) | 2.2-7.5 | 46.0-46.2 | 22.4-19.6 |
| Iodide (ppm) | <1.5 | 141.4-151.6 | 767.0-188.1 |
| Al (ppm) | 6.3-4.3 | <3 | 3.2-3.6 |
| Fe (ppm) | 4.7-8.2 | 5.5-5.9 | 8.5-26.0 |
| Cu (ppm) | 9.8-34.1 | 5.8-10.4 | 3.0-3.2 |
| Zn (ppm) | 2.5-5.3 | 216-262 | 631-951 |
| TAN (mg | <0.1 | 1.9-2.1 | 2.7-3.2 |
| KOH/g) | | | |
| R-23 (ppm) | 140 | 635 | 1005 |
| KR-008 (wt %) | 2.02-2.06 | 2.19-2.06 | 2.16-2.19 |
| TCP (wt %) | 2.02-2.22 | 3.06-3.04 | 3.03-3.48 |
| EHGE (ppm) | 10091-9400 | <100 | <100 |

As can be seen from the results of the tests conducted by applicant in the presence of copper, aluminum and iron (ExC1A), the heat transfer composition with the indicated combination of stabilizers was able to produce acceptable results in the presence of those three metals (but in the absence of zinc). This is illustrated, for example, by fluoride content for ExC1A of less than 10 ppm, iodide content of less than 1.5, and TAN value of less than 0.1.

However, applicants have learned from their testing that stability deteriorates significantly in the presence of zinc (ExC1C) and zinc-containing metals such as brass (ExC1B). This is illustrated, for example, by the dramatic increase in the fluoride concentration (10×-20×) and iodide concentration (100×-500×). Similarly, the presence of zinc causes an order of magnitude increase in the TAN value and 4× to 7× increase in R-23. Further, the visual appearance confirms that the fluid did not remain stable in the presence of zinc. This deterioration in performance is reflected by the measurement of zinc in the tubes at the conclusion of the test. In particular, the concentration of zinc increase by an amount of from about 85× to 380×.

### Example 1—Heat Transfer Compositions Comprising CF31-Containing Refrigerant, POE Lubricant, Stabilizers and Protective Agent

The test of Comparative Example 1 is repeated except that a protective agent of the present invention is added to the fluid prior to testing in amounts of 0.05 wt % and 0.1 wt %, as reported in Table Ex1A.

TABLE Ex1A

| | |
|---|---|
| Ex1A | Ex1B |

Fluid Composition Component
Concentration, wt %

| | | |
|---|---|---|
| R466A | 47.225 | 47.22 |
| 160SZ POE | 47.225 | 47.22 |
| KR-008 | 2 | 2 |
| TCP | 2 | 2 |
| ADM4 (EHGE) | 1.5 | 1.5 |
| Protective Agent 5 | 0.05 | 0.1 |
| TOTAL | 100 | 100 |

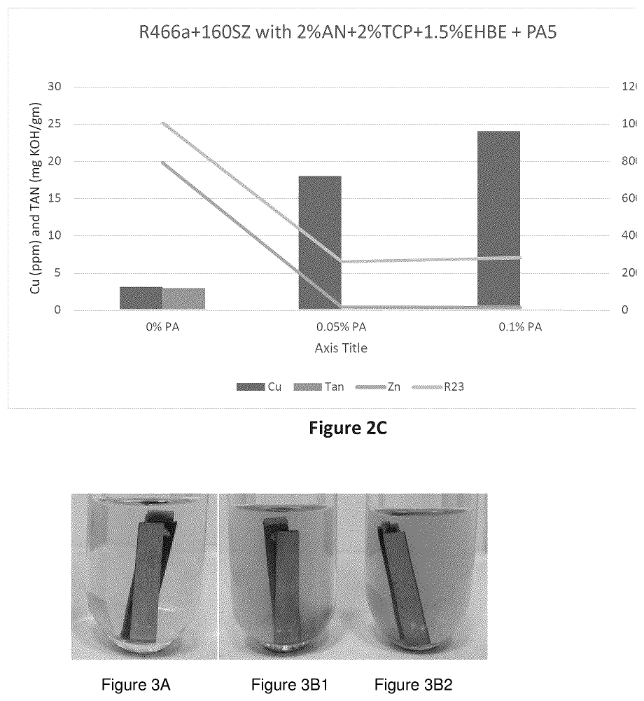

The stability of the fluid was then tested in the presence of zinc (in two separate test tubes for the Protective Agent concentration of 0.05 wt %) as described in Comparative Example 1, that is, by placing the sealed tubes with copper, aluminum, iron and zinc in an oven maintained at about 150° C. for 14 days. The results after the 14 day period were as indicated below in Table Ex1B and are illustrated in FIGS. 2A (showing the results of Example Ex1A) and 2B (showing the results of Ex1B, with the zinc coupons shown in front), and charted together with the results of Comparative Example (using average values) to facilitate comparison in FIG. 2C.

TABLE Ex1B

| | Ex1A | | | Ex1B |
|---|---|---|---|---|
| | Coupons | | | |
| | Cu/Al/Fe + Zn | | | Cu/Al/Fe + Zn |
| | Protective Agent Concentration, wt % | | | |
| | 0.05 wt % | | | |
| Tube | A | B | Avg A + B | 0.1 wt % |
| Al (ppm) | <3 | <3 | <3 | <3 |
| Fe (ppm) | 5 | 3 | 4 | <2 |
| Cu (ppm) | 19 | 17 | 18 | 24 |
| Zn (ppm) | 14 | 16 | 15 | 14 |
| TAN (mg KOH/g) | <0.1 | <0.1 | <0.1 | <0.1 |
| R-23 (ppm) | 260 | 260 | 260 | 380 |
| EHGE (ppm) | 10689 | 9178 | 9934 | 7457 |

As illustrated by the test results illustrated above, the addition a protective agent of the present invention unexpectedly results in a dramatic increase in the performance of the fluid from a stability standpoint, as represented for example by a zinc level that is only about 0.0002% of the zinc level without the protective agent of the present invention and by an R-23 level that is only 0.004% of the R-23 without the protective agent.

### Examples 2A and 2B1—Heat Transfer Compositions Comprising CF31-Containing Refrigerant, POE Lubricant, AN Stabilizer and Protective Agent

A heat transfer composition is tested in accordance with ASHRAE Standard 97-“Sealed Glass Tube Method to Test the Chemical Stability of Materials for Use within Refrigerant Systems” to simulate long-term stability of the heat transfer compositions by accelerated aging. The testing is conducted with the following four coupons: Cu/Al/Fe/Zn. The tested refrigerant consists of 49% by weight R-32, 11.5% by weight of R-125 and 39.5% by weight of CF31 (R-466A). The POE lubricant was the same 160SZ POE as described in Comparative Example 1 Also include was a stabilizer consisting of KR-008 and ADM5 (EHGE), and the protective agent of the present invention PA-5 in the amounts indicated in Table Ex2A below.

TABLE EX2

| | |
|---|---|
| Example 2A | Example 2B |

Fluid Composition Component
Concentration, wt %

| | | |
|---|---|---|
| R466A | 48.225 | 48.25 |
| 160SZ POE | 48.225 | 48.25 |
| KR-008 | 2 | 2 |
| EHGE | 1.5 | 1.5 |
| PA5 | 0.05 | 0.1 |
| TOTAL | 100 | 100 |

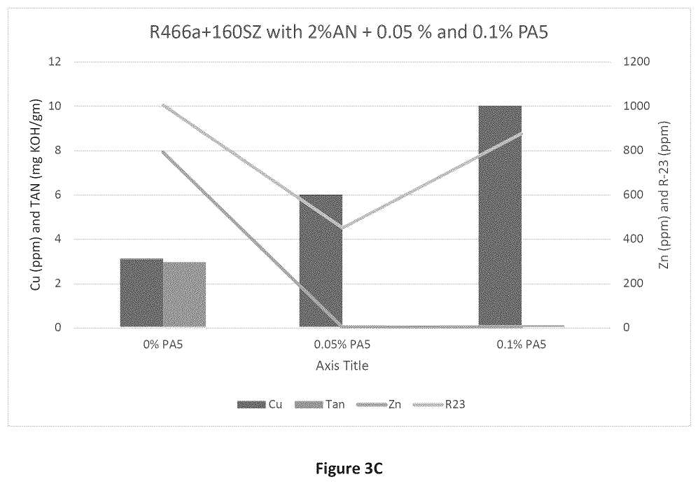

After testing, the fluid in each test tube was observed for clarity, total acid number (TAN) was determined, and the amount of various materials in the fluid were identified. The stability of the fluid was tested by placing the sealed tube with the indicated coupons in an oven maintained at about 150° C. for 14 days. The results after the 14 day period were as indicated below in Table Ex2B. Two test tubes for the PA5 concentration of 0.1 wt5 were used, and the average value for these results are reported below as Ex2BAvg. The results from Comparative Example C1C are also provided for ease of comparison. The results are also illustrated in FIG. 3A (showing the results of Example Ex2A), FIG. 3B1 and 3B2 (showing the results of Example 2B1 and 2B2), and charted together with the results of Comparative Example (using average values) to facilitate comparison in FIG. 3C

TABLE EX2B

| | Ex2A1 | Ex2B1 | Ex2B2 | Ex2BAvg | ExC1C |
|---|---|---|---|---|---|
| | Coupons | | | | |
| | Cu/Al/ | Cu/Al/ | Cu/Al/ | Cu/Al/ | Cu/Al/ |
| | Fe + Zn | Fe + Zn | Fe + Zn | Fe + Zn | Fe + Zn |
| Al (ppm) | <3 | <3 | <3 | <3 | 3.2-3.6 |
| Fe (ppm) | 4 | 3 | 9 | 6 | 8.5-26.0 |
| Cu (ppm) | 6 | 11 | 9 | 10 | 3.0-3.2 |
| Zn (ppm) | 2 | 2 | 5 | 3.5 | 631-951 |
| TAN (mg | <0.1 | <0.1 | <0.1 | <0.1 | 2.7-3.2 |
| KOH/g) | | | | | |
| R-23 (ppm) | 450 | 910 | 840 | 875 | 1005 |
| EHGE (ppm) | 10754 | 6623 | 7720 | 7171.5 | <100 |

As can be seen from the results of the tests conducted by applicant in the presence of copper, aluminum, iron and zinc, the heat transfer composition with 0.05% and 0.1% of PA5 each unexpectedly had a reduced level of Zn and R-23 compared to Comparative Example 1C. Even more unexpectedly, the best performance in terms of R-23 is achieved with a protective agent concentration of greater than zero but less than 0.1 wt %.

### Examples 3A and 3B—Heat Transfer Compositions Comprising CF31-Containing Refrigerant, POE Lubricant, ADM Stabilizer and Protective Agent

A heat transfer composition is tested in accordance with ASHRAE Standard 97-“Sealed Glass Tube Method to Test the Chemical Stability of Materials for Use within Refrigerant Systems” to simulate long-term stability of the heat transfer compositions by accelerated aging. The testing is conducted with the following four coupons: Cu/Al/Fe/Zn. The tested refrigerant consists of 49% by weight R-32, 11.5% by weight of R-125 and 39.5% by weight of CF31 (R-466A). The POE lubricant was the same 160SZ POE as described in Comparative Example 1. A Also included was stabilizer consisting of AN (KR-008), TCP and ADM5 (EHGE), and the protective agent of the present invention PA5 in the amounts indicated in Table Ex3A below.

TABLE EX3A

| | Example 3A | Example 3B | Example 3C |
|---|---|---|---|
| | Fluid Composition Component | | |
| | Concentration, wt % | | |
| R466A | 47.6125 | 47.6 | 47.725 |
| 160SZ POE | 47.6125 | 47.6 | 47.725 |
| KR-008 | 2 | 2 | 2 |
| TCP | 2 | 2 | 2 |
| EHGE | 1.5 | 0.75 | .5 |
| PA5 | 0.025 | 0.05 | 0.05 |
| TOTAL | 100 | 100 | 100 |

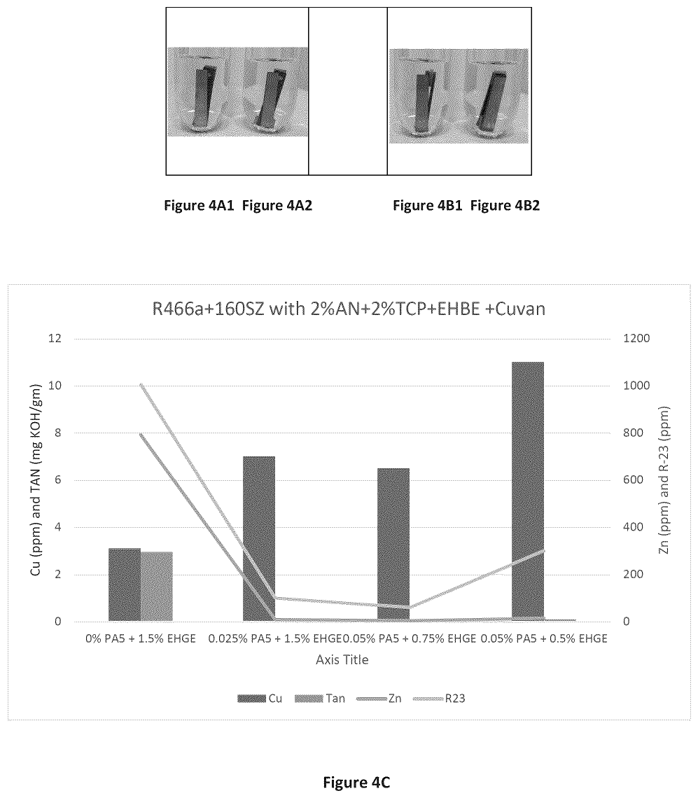

After testing, the fluid in each test tube was observed for clarity, total acid number (TAN) was determined, and the amount of various materials in the fluid were identified. The stability of the fluid was tested by placing the sealed tube with the indicated coupons in an oven maintained at about 150° C. for 14 days. The results after the 14 day period were as indicated below in Table Ex3B. Two test tubes were used for the EHGE concentrations at 0.5 wt % and 0.75%, and the average values of the results are reported below as Ex3AAvg and Ex3BAvg. The results are also illustrated in FIG. 4A1 (showing the results of Example Ex3A), FIG. 4A2 (showing the results of Example 3A21), FIG. 4B1 (showing the results of Example 3B1), FIG. 4B2 (showing the results of Example 3B2), and charted together with the results of Comparative Example (using average values) to facilitate comparison in FIG. 4C. The results from Comparative Example C1C are also provided in FIG. 4C for ease of comparison.

TABLE EX3B

| | Ex3A1 | Ex3A21 | Ex3AAvg | Ex3B1 | Ex3B2 | Ex3BAvg | Ex3C | ExC1C |
|---|---|---|---|---|---|---|---|---|
| | Coupons | | | | | | | |
| | Cu/Al/ | Cu/Al/ | Cu/Al/ | Cu/Al/ | Cu/Al/ | Cu/Al/ | Cu/Al/ | Cu/Al/ |
| | Fe + Zn | Fe + Zn | Fe + Zn | Fe + Zn | Fe + Zn | Fe + Zn | Fe + Zn | Fe + Zn |
| Fluoride (ppm) | 3 | 3 | 3 | 1 | 3 | 2 | NA | 22.4-19.6 |
| Iodide (ppm) | <0.4 | <0.4 | <0.4 | <0.4 | <0.4 | <0.4 | NA | 767.0-188.1 |
| Al (ppm) | <3 | <3 | <3 | <3 | <3 | <3 | <3 | 3.2-3.6 |
| Fe (ppm) | 11 | 9 | 10 | 41 | 19 | 30 | 12 | 8.5-26.0 |
| Cu (ppm) | 8 | 6 | 7 | 6 | 7 | 6.5 | 11 | 3.0-3.2 |
| Zn (ppm) | 10 | 8 | 9 | 3 | 6 | 4.5 | 14 | 631-951 |
| TAN (mg KOH/g) | 0.1 | <0.1 | <0.1 | <0.1 | <0.1 | <0.1 | <0.1 | 2.7-3.2 |
| R-23 (ppm) | 90 | 110 | 100 | 50 | 70 | 60 | 300 | 1005 |
| KR-008 (wt %) | 1.82 | 1.77 | 1.795 | 1.93 | 1.94 | 1.935 | 1.99 | 2.16-2.19 |
| TCP (wt %) | 2.02 | 1.97 | 1.995 | 2.00 | 2.03 | 2.15 | 2.05 | 3.03-3.48 |
| EHGE (ppm) | 13218 | 11589 | 12403 | 7028 | 5957 | 6492.5 | 2271 | <100 |

As can be seen from the results of the tests conducted by applicant in the presence of copper, aluminum, iron and zinc, the heat transfer composition with 0.025% and 0.0.5% of PA5, with various amounts of EHGE, each unexpectedly had a reduced level of Zn and R-23 compared to Comparative Example C1 (0% PA5). Even more unexpectedly, the best performance in terms of R-23 and copper is achieved with a protective agent concentration of greater than zero but less than 0.05 wt %.

### Comparative Examples 2A-2C—Heat Transfer Compositions Comprising R-1234Ze(E) and POE Lubricant

A heat transfer composition is tested in accordance with ASHRAE Standard 97-“Sealed Glass Tube Method to Test the Chemical Stability of Materials for Use within Refrigerant Systems” to simulate long-term stability of the heat transfer compositions by accelerated aging. The tested heat transfer composition consisted of 50% by weight of refrigerant (consisting of R-1234ze(E)) and 50% by weight of POE lubricant (RL32-3MAF sold by Emkrate having a viscosity at 40° C. of about 31 cSt). The testing was conducted with three different coupon combinations: Cu/Al/Fe; Brass; and Zn. Two (2) separate test tubes were used with CU/Al/Fe and Brass coupons, and the results reported below are the average of the results. Four (4) separate test tubes were used with Zn coupons, and the results reported below are the averages of all the results.

After testing, the fluid in each test tube was observed for clarity, total acid number (TAN) was determined, and the amount of various materials in the fluid were identified. The TAN value is considered to reflect the stability of the lubricant in the fluid under conditions of use in the heat transfer composition.

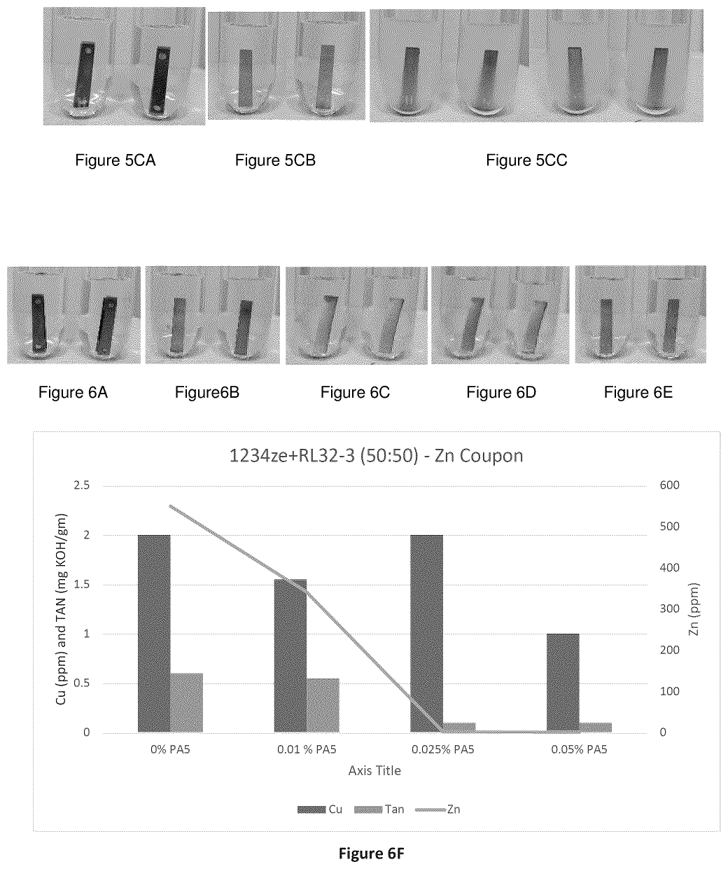

The stability of the fluid was tested by placing the sealed tube with the indicated coupons in an oven maintained at about 150° C. for 14 days. The results after the 14 day period were as indicated below in Table ExC2 and as illustrated in FIGS. 5C1, 5C2 and 5C3:

The results after the 14 day period were as indicated below in Table ExC2:

TABLE EXC2

| | ExC2A | ExC2B | ExC2C |
|---|---|---|---|
| Coupons | Cu/Al/Fe | Brass | Zn |
| Fluoride (ppm) | 3 | 7.5 | 4.75 |
| Iodide (ppm) | <0.4 | <0.4 | <0.1 |
| Al (ppm) | <3 | <3 | <3 |
| Fe (ppm) | 4 | 4 | <3.2 |
| Cu (ppm) | 3.5 | 1.5 | 1.6 |
| Zn (ppm) | 3.5 | 21.5 | 548.5 |
| TAN (mg | 0.25 | 0.4 | 0.775 |
| KOH/g) | | | |

As can be seen from the results of the tests conducted by applicant in the presence of copper, aluminum and iron (ExC2A), the heat transfer composition consisting of R-1234ze(E) and POE lubricant, even in the absence of stabilizers was able to produce acceptable results in the presence of those three metals (but in the absence of zinc). This is illustrated, for example, by fluoride content for ExC1A of less than 10 ppm, iodide content of less than 1.5, TAN value of less than 0.5 and Zn content of less than 0.3 ppm. However, applicants have learned from their testing that stability deteriorates significantly in the presence of zinc (ExC2C) and zinc-containing metals such as brass (ExC2B). This is illustrated, for example, by the dramatic increase in the Zn concentration that is more than 150 times greater than ExC2A and a TAN value that is more than 3 times greater than ExC2A.

### Examples 4A-4E—Heat Transfer Compositions Comprising CF31-Containing Refrigerant, POE Lubricant, Stabilizers and Protective Agent

The test of Comparative Example 2 is repeated except that a protective agent of the present invention, namely Protective Agent 5, is added to each of the fluids prior to testing in amounts of 0.01 wt %, 0.025 wt % and 0.05 wt %.

The stability of each fluid was then tested in the presence of the same coupons identified in Comparative Example 2 and under the same conditions. The results after the 14 day period were as indicated below in Table Ex4. The results are also illustrated in FIG. 6A (showing the results of Example Ex4A), FIG. 6B (showing the results of Example 4B), FIG. 6C (showing the results of Example 4C), FIG. 6D (showing the results of Example 4D), FIG. 6E (showing the results of Example 4E), and charted together with the results of Comparative Example 2 (using average values) to facilitate comparison in FIG. 6F. The results from Comparative Example C1C are also provided in FIG. 4C for ease of comparison,

TABLE Ex4

| | ExC2A | ExC2B | ExC2C | Ex4A | Ex4B | Ex4C | Ex4D | Ex4E |
|---|---|---|---|---|---|---|---|---|
| | Coupons | | | | | | | |
| | | | | Cu/Al/Fe + | Brass + | Zn + | Zn + | Zn + |
| | | | | 0.05 | 0.05 | 0.01 | 0.025 | 0.05 |
| | Cu/Al/Fe | Brass | Zn | wt % PA | wt % PA | wt % PA | wt % PA | wt % PA |
| Fluoride (ppm) | 3 | 7.5 | 4.75 | 1.5 | 2 | NA | NA | 2.5 |
| Iodide (ppm) | <0.4 | <0.4 | <0.1 | <0.4 | <0.4 | NA | NA | <0.4 |
| Al (ppm) | <3 | <3 | <3 | <3 | <3 | <3 | <3 | <3 |
| Fe (ppm) | 4 | 4 | <3.2 | <2.5 | <2.5 | 5.65 | <5.35 | <4 |
| Cu (ppm) | 3.5 | 1.5 | 1.6 | 7 | 2.5 | 1.55 | 1.95 | 1 |
| Zn (ppm) | 3.5 | 21.5 | 548.5 | <1 | <1.2 | 341 | 1.75 | <1 |
| TAN (mg KOH/g) | 0.25 | 0.4 | 0.775 | <0.1 | <0.1 | 0.55 | <0.1 | <0.1 |

As illustrated by the test results in the Table above and as illustrated in FIGS. 6A-6F, the addition of a protective agent of the present invention unexpectedly results in an increase in the performance of the fluid in the presence of zinc from a stability standpoint. This is represented, for example, by the use of 0.01 wt % of the protective agent of the present invention to produce a zinc level that is about 40% lower than the zinc level without the protective agent of the present invention and by a TAN value that is about 30% lower than the TAN value without the protective agent. Even more unexpectedly, the performance with the use of protective agent in amount greater than 0.01 wt % is able to lower the zinc level by two orders of magnitude, that is, to Zn levels of less than 10 ppm, and to lower the TAN value to less than 0.1 mg KOH/mg. This result is highly desirable and unexpected.

### Example 5a—Heat Transfer Compositions of the Invention Used in Medium Temperature Commercial Refrigeration with and without Suction Line (SI)/Liquid Line (LL) Heat Exchanger (HX)

A commercial refrigeration system having zinc-containing surfaces in contact with the heat transfer composition is operated with each of Heat Transfer Compositions 1-46 based on the following average operating conditions:
Condensing temperature=45.0° C.
Condensing Temperature−Ambient Temperature=10.0° C.
Condenser sub-cooling=0.0° C. (system with receiver)
Evaporating temperature=−8.0° C.,
Evaporator Superheat=5.5° C.
Compressor Isentropic Efficiency=65.0%
Volumetric Efficiency=100%
Temperature Rise in Suction Line=10.0° C.
Suction Line/Liquid Line Heat Exchanger Effectiveness: 0%, 35%, 55%, 75%

The system is operated over an extended period of time with each of the above-noted heat transfer compositions and advantageously high levels of stability and anti-corrosion are achieved.

### Example 5b—Heat Transfer Compositions of the Invention Used in Low Temperature Commercial Refrigeration with and without Suction Line (SI)/Liquid Line (LL) Heat Exchanger (HX)

A commercial refrigeration system having zinc-containing surfaces in contact with the heat transfer composition is operated with each of Heat Transfer Compositions 1-46 based on the following average operating conditions:
Condensing temperature=45.0° C.
Condensing Temperature−Ambient Temperature=10.0° C.
Condenser sub-cooling=0.0° C. (system with receiver)
Evaporating temperature=−35.0° C.,
Evaporator Superheat=5.5° C.
Compressor Isentropic Efficiency=65.0%
Volumetric Efficiency=100%
Temperature Rise in Suction Line=10.0° C.
Suction Line/Liquid Line Heat Exchanger Effectiveness: 0%, 35%, 55%, 75%

The system is operated over an extended period of time with each of the above-noted heat transfer compositions and advantageously high levels of stability and anti-corrosion are achieved.

### Example 6—Heat Transfer Compositions of the Invention Used in Commercial Air Conditioning

A commercial air conditioning system having zinc-containing surfaces in contact with the heat transfer composition is operated with each of Heat Transfer Compositions 1-46 based on the following average operating conditions:
Condensing temperature=45.0° C.
Condensing Temperature−Ambient Temperature=10.0° C.
Condenser sub-cooling=5.0° C. (system without receiver)
Evaporating temperature=7.0° C.,
Evaporator Superheat=5.5° C.
Compressor Isentropic Efficiency=72.0%
Volumetric Efficiency=100%
Temperature Rise in Suction Line=5.0° C.

The system is operated over an extended period of time with each of the above-noted heat transfer compositions and advantageously high levels of stability and anti-corrosion are achieved.

### Example 7—Heat Transfer Compositions of the Invention Used in Residential Air Conditioning

A residential air conditioning system having zinc-containing surfaces in contact with the heat transfer composition is operated with each of Heat Transfer Compositions 1-46 based on the following average operating conditions:
Condensing temperature=45.0° C.
Condensing Temperature−Ambient Temperature=10.0° C.
Condenser sub-cooling=5.0° C. (system without receiver)
Evaporating temperature=7.0° C.,
Evaporator Superheat=5.5° C.
Compressor Isentropic Efficiency=72.0%
Volumetric Efficiency=100%
Temperature Rise in Suction Line=5.0° C.

The system is operated over an extended period of time with each of the above-noted heat transfer compositions and advantageously high levels of stability and anti-corrosion are achieved.

### Example 8—Heat Transfer Compositions of the Invention Used in a Chiller

A chiller system having zinc-containing surfaces in contact with the heat transfer composition is operated with each of Heat Transfer Compositions 1-46 based on the following average operating conditions:
Condensing temperature=45.0° C.
Condensing Temperature−Ambient Temperature=10.0° C.
Condenser sub-cooling=5.0° C. (system without receiver)
Evaporating temperature=4.0° C.,
Evaporator Superheat=5.5° C.
Compressor Isentropic Efficiency=70.0%
Volumetric Efficiency=100%
Temperature Rise in Suction Line=5.0° C.

The system is operated over an extended period of time with each of the above-noted heat transfer compositions and advantageously high levels of stability and anti-corrosion are achieved.

### Example 9—Heat Transfer Compositions of the Invention Used in a Stationary Heat Pump

A stationary heat pump having zinc-containing surfaces in contact with the heat transfer composition is operated with each of Heat Transfer Compositions 1-46 based on the following average operating conditions:
Condensing temperature=45.0° C.
Condensing Temperature−Ambient Temperature=10.0° C.
Condenser sub-cooling=5.0° C. (system without receiver)
Evaporating temperature=0° C.,
Evaporator Superheat=5.5° C.
Compressor Isentropic Efficiency=70.0%
Volumetric Efficiency=100%
Temperature Rise in Suction Line=5.0° C.

The system is operated over an extended period of time with each of the above-notes heat transfer compositions and advantageously high levels of stability and anti-corrosion are achieved.

### Example 10—Heat Transfer Compositions of the Invention Used in a Mobile Heat Pump

A mobile heat pump located in an electronic vehicle and having zinc-containing surfaces in contact with the heat transfer composition is operated with each of Heat Transfer Compositions 1-46 based on the following average operating conditions:
Condensing temperature=45.0° C.
Condensing Temperature−Ambient Temperature=10.0° C.
Condenser sub-cooling=5.0° C. (system without receiver)
Evaporating temperature=0.0° C.,
Evaporator Superheat=5.5° C.
Compressor Isentropic Efficiency=65%
Volumetric Efficiency=100%
Temperature Rise in Suction Line=5.0° C.

The system is operated over an extended period of time with each of the above-notes heat transfer compositions and advantageously high levels of stability and anti-corrosion are achieved.

### Example 11—Heat Transfer Compositions of the Invention Used in Mobile Air Conditioning

A mobile air conditioning system having zinc-containing surfaces in contact with the heat transfer composition is operated with each of Heat Transfer Compositions 1-46 based on the following average operating conditions:
Condensing temperature=45.0° C.
Condensing Temperature−Ambient Temperature=10.0° C.
Condenser sub-cooling=5.0° C. (system with receiver)
Evaporating temperature=4.0° C.
Evaporator Superheat=5.5° C.
Compressor Isentropic Efficiency=65.0%
Volumetric Efficiency=100%
Temperature Rise in Suction Line=0.0° C.

The system is operated over an extended period of time with each of the above-notes heat transfer compositions and advantageously high levels of stability and anti-corrosion are achieved.

### Example 12a—Heat Transfer Compositions of the Invention Used in a Medium Temperature Industrial Refrigeration System with and without Suction Line (SI)/Liquid Line (LL) Heat Exchanger (HX)

An industrial refrigeration system having zinc-containing surfaces in contact with the heat transfer composition is operated with each of Heat Transfer Compositions 1-46 based on the following average operating conditions:
Condensing temperature=45.0° C.
Condensing Temperature−Ambient Temperature=10.0° C.
Condenser sub-cooling=0.0° C. (system with receiver)
Evaporating temperature=−8.0° C.
Evaporator Superheat=5.5° C.
Compressor Isentropic Efficiency=65%
Volumetric Efficiency=100%
Temperature Rise in Suction Line=10° C.
Suction Line/Liquid Line Heat Exchanger Effectiveness: 0%, 35%, 55%, 75%

The system is operated over an extended period of time with each of the above-notes heat transfer compositions and advantageously high levels of stability and anti-corrosion are achieved.

### Example 12b—Heat Transfer Compositions of the Invention Used in a Low Temperature Industrial Refrigeration System with and without Suction Line (SI)/Liquid Line (LL) Heat Exchanger (HX)

An industrial refrigeration system having zinc-containing surfaces in contact with the heat transfer composition is operated with each of Heat Transfer Compositions 1-46 based on the following average operating conditions:
Condensing temperature=45.0° C.
Condensing Temperature−Ambient Temperature=10.0° C.
Condenser sub-cooling=0.0° C. (system with receiver)
Evaporating temperature=−35.0° C.,
Evaporator Superheat=5.5° C.
Compressor Isentropic Efficiency=65.0%
Volumetric Efficiency=100%
Temperature Rise in Suction Line=10° C.
Suction Line/Liquid Line Heat Exchanger Effectiveness: 0%, 35%, 55%, 75%

The system is operated over an extended period of time with each of the above-notes heat transfer compositions and advantageously high levels of stability and anti-corrosion are achieved.

### Example 13a—Heat Transfer Compositions of the Invention Used in a Medium Transport Refrigeration System with and without Suction Line (SI)/Liquid Line (LL) Heat Exchanger (HX)

A transport refrigeration system having zinc-containing surfaces in contact with the heat transfer composition is operated with each of Heat Transfer Compositions 1-46 based on the following average operating conditions:
Condensing temperature=45.0° C.
Condensing Temperature−Ambient Temperature=10.0° C.
Condenser sub-cooling=0.0° C. (system with receiver)
Evaporating temperature=−8.0° C.
Evaporator Superheat=5.5° C.
Compressor Isentropic Efficiency=65%
Volumetric Efficiency=100%
Temperature Rise in Suction Line=150C
Suction Line/Liquid Line Heat Exchanger Effectiveness: 0%, 35%, 55%, 75%

The system is operated over an extended period of time with each of the above-notes heat transfer compositions and advantageously high levels of stability and anti-corrosion are achieved.

### Example 13b—Heat Transfer Compositions of the Invention Used in a Low Transport Refrigeration System with and without Suction Line (SI)/Liquid Line (LL) Heat Exchanger (HX)

A transport refrigeration system having zinc-containing surfaces in contact with the heat transfer composition is operated with each of Heat Transfer Compositions 1-46 based on the following average operating conditions:
Condensing temperature=45.0° C.
Condensing Temperature−Ambient Temperature=10.0° C.
Condenser sub-cooling=0.0° C. (system with receiver)
Evaporating temperature=−35.0° C.,
Evaporator Superheat=5.5° C.
Compressor Isentropic Efficiency=65%
Volumetric Efficiency=100%
Temperature Rise in Suction Line=15° C.
Suction Line/Liquid Line Heat Exchanger Effectiveness: 0%, 35%, 55%, 75%

The system is operated over an extended period of time with each of the above-notes heat transfer compositions and advantageously high levels of stability and anti-corrosion are achieved.

1. An improved heat transfer systems of the type having at least a circulating working fluid and one or more equipment components which are exposed to said working fluid during operation, the improvement comprising:
(a) at least one of said one or more equipment components having surface which is exposed to said circulating working fluid and which comprises zinc;
(b) said working fluid comprising refrigerant and at least one protective agent comprising a compound according to Formula I: 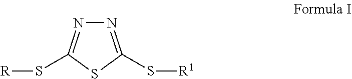
where R and R¹ are each independently selected from the group consisting of hydrogen, alkyl, hydroxyalkyl and alkylthio, provided that at least one of R and R¹ is alkylthio.

2. The improved system of claim 1 wherein at least one of said R and R1 is a C1-C20 alkylthio.

3. The improved system of claim 1 wherein each of said R and R1 is independently a C8 alkylthio.

4. The improved system of claim 1 wherein said compound of Formula 1 comprises 2,5-bis(n-octyldithio)-1,3,4-thiadiazole.

5. The improved system of claim 4 wherein said protective agent comprises said 2,5-bis(n-octyldithio)-1,3,4-thiadiazole and dioctyl disulfide.

6. A method of providing heat transfer comprising:
(a) providing a heat transfer system comprising one or more components having at least one surface formed from a metal which contains zinc;
(b) providing a working fluid in said system, wherein: (i) said working fluid is in contact with said at least one surface; and (ii) said working fluid comprises refrigerant and a protective agent comprising a compound according to Formula I: 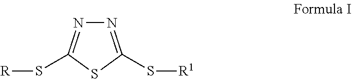
where R and R¹ are each independently selected from the group consisting of hydrogen, alkyl, hydroxyalkyl and alkylthio, provided that at least one of R and R¹ is alkylthio.

7. The method of claim 6 wherein at least one of said R and R1 is a C1-C20 alkylthio.

8. The method of claim 7 wherein each of said R and R1 is independently a C8 alkylthio.

9. The method of claim 7 wherein said compound of Formula 1 comprises 2,5-bis(n-octyldithio)-1,3,4-thiadiazole.

10. The method of claim 11 wherein said protective agent comprises said 2,5-bis(n-octyldithio)-1,3,4-thiadiazole and dioctyl disulfide.

11. A heat transfer composition comprising:
(a) at least one refrigerant selected from HFCs, HCFCs, HFOs, HCFOs, fluoroiodocarbons and combinations of two or more of these include HCs as part of blend;
(b) at least one lubricant selected from POEs and PVEs; and
(c) a protective agent comprising a compound according to Formula I: 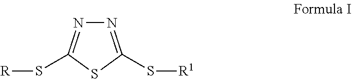
where R and R¹ are each independently selected from the group consisting of hydrogen, alkyl, hydroxyalkyl and alkylthio, provided that at least one of R and R¹ is alkylthio.

12. The composition of claim 11 wherein at least one of said R and R1 is a C1-C20 alkylthio.

13. The composition of claim 12 wherein each of said R and R1 is independently a C1-C20 alkylthio.

14. The composition of claim 13 wherein each of said R and R1 is independently a C8 alkylthio.

15. The composition of claim 13 wherein said compound of Formula 1 comprises 2,5-bis(n-octyldithio)-1,3,4-thiadiazole.

16. The composition of claim 17 wherein said protective agent comprises said 2,5-bis(n-octyldithio)-1,3,4-thiadiazole and dioctyl disulfide.

17. The composition of claim 13 further comprising alkylated naphthalene.

18. The composition of claim 13 further comprising an acid depleting moiety.

19. The composition of claim 13 further comprising alkylated naphthalene and an acid depleting moiety.

20. The composition of claim 13 further comprising phosphate.
